(19) United States
(12) Patent Application Publication
(10) Pub. No.: US 2026/0100503 A1
(43) Pub. Date: Apr. 9, 2026

(54) ELECTRONIC DEVICE INCLUDING ANTENNA

(71) Applicant: Samsung Electronics Co., Ltd., Suwon-si (KR)

(72) Inventors: Hosaeng KIM, Suwon-si (KR); Sangha LEE, Suwon-si (KR); Museok BANG, Suwon-si (KR)

(21) Appl. No.: 19/396,941

(22) Filed: Nov. 21, 2025

Related U.S. Application Data
(63) Continuation of application No. PCT/KR2025/015882, filed on Oct. 2, 2025.

(30) Foreign Application Priority Data
Oct. 8, 2024 (KR) 10-2024-0137185
Dec. 4, 2024 (KR) 10-2024-0179017

(51) Int. Cl. H01Q 3/24; H01Q 1/42; H01Q 3/02

(52) U.S. Cl. CPC H01Q 3/24; H01Q 1/42; H01Q 3/02

(57) ABSTRACT

An electronic device is provided. The electronic device includes a hinge assembly, a first housing part rotatably connected to the hinge assembly, the first housing part including a first conductive portion, a second conductive portion, and a first non-conductive portion disposed between the first conductive portion and the second conductive portion, a second housing part rotatably connected to the hinge assembly, the second housing part including a third conductive portion, a fourth conductive portion, and a second non-conductive portion disposed between the third conductive portion and the fourth conductive portion, wireless communication circuitry configured to transmit or receive signals through at least one of the first conductive portion, the second conductive portion, the third conductive portion, or the fourth conductive portion, a first switching circuit configured to connect a first capacitor between the second conductive portion and a first transmission path connected to the first conductive portion, and a second switching circuit configured to connect a second capacitor between the fourth conductive portion and a second transmission path connected to the third conductive portion.

### CROSS-REFERENCE TO RELATED APPLICATION(S)

This application is a continuation application, claiming priority under 35 U.S.C. § 365(c), of an International application No. PCT/KR2025/015882, filed on Oct. 2, 2025, which is based on and claims the benefit of a Korean patent application number 10-2024-0137185, filed on Oct. 8, 2024, in the Korean Intellectual Property Office, and of a Korean patent application number 10-2024-0179017, filed on Dec. 4, 2024, in the Korean Intellectual Property Office, the disclosure of each of which is incorporated by reference herein in its entirety.

### TECHNICAL FIELD

The disclosure relates to an electronic device including an antenna.

### BACKGROUND ART

An electronic device may transmit or receive signals through an antenna. The electronic device may include a conductive portion positioned at a portion of a periphery of a metal housing. The conductive portion may operate as an antenna radiator for transmitting and/or receiving signals.

The above information is presented as a background information only to assist with an understanding of the disclosure. No determination has been made, and no assertion is made, as to whether any of the above might be applicable as prior art with regard to the disclosure.

### DISCLOSURE

Aspects of the disclosure are to address at least the above-mentioned problems and/or disadvantages and to provide at least the advantages described below. Accordingly, an aspect of the disclosure is to provide an electronic device including an antenna.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes a hinge assembly, a first housing part rotatably connected to the hinge assembly, the first housing part including a first conductive portion, a second conductive portion, and a first non-conductive portion disposed between the first conductive portion and the second conductive portion, a second housing part rotatably connected to the hinge assembly, the second housing part including a third conductive portion, a fourth conductive portion, and a second non-conductive portion disposed between the third conductive portion and the fourth conductive portion, wireless communication circuitry configured to transmit or receive signals through at least one of the first conductive portion, the second conductive portion, the third conductive portion, or the fourth conductive portion, a first switching circuit configured to connect a first capacitor between the second conductive portion and a first transmission path connected to the first conductive portion, and a second switching circuit configured to connect a second capacitor between the fourth conductive portion and a second transmission path connected to the third conductive portion.

In accordance with an aspect of the disclosure, an electronic device is provided. The electronic device includes a first housing part, a second housing part rotatably connected to the first housing part, the second housing part including a first conductive portion, a second conductive portion, and a first non-conductive portion disposed between the first conductive portion and the second conductive portion, a third housing part rotatably connected to the second housing part, the third housing part including a third conductive portion, a fourth conductive portion, and a second non-conductive portion disposed between the third conductive portion and the fourth conductive portion, wireless communication circuitry configured to transmit or receive signals through at least one of the first conductive portion, the second conductive portion, the third conductive portion, or the fourth conductive portion, a first switching circuit configured to connect a first capacitor between the second conductive portion and a first transmission path connected to the first conductive portion disposed in the second housing part, and a second switching circuit configured to connect a second capacitor between the fourth conductive portion and a second transmission path connected to the third conductive portion disposed in the third housing part.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A, 2B, and 2C illustrate examples of a foldable-type electronic device according to various embodiments of the disclosure;

FIGS. 3A, 3B, 3C, and 3D are diagrams for describing an inverted-F antenna (IFA) and a dual IFA according to various embodiments of the disclosure;

FIGS. 4A and 4B illustrate examples of an electronic device including signal distribution circuitry according to various embodiments of the disclosure;

FIG. 5 illustrates an example of performance of a dual IFA using signal distribution circuitry according to an embodiment of the disclosure;

FIGS. 6A and 6B illustrate examples of an electronic device including a dual IFA according to various embodiments of the disclosure;

FIGS. 7A, 7B, 7C, and 7D illustrate examples of an electronic device including a switching circuit for a dual IFA according to various embodiments of the disclosure;

FIGS. 8A, 8B, and 8C illustrate examples of a foldable-type electronic device including a switching circuit for a dual IFA according to various embodiments of the disclosure;

FIGS. 9A, 9B, and 9C illustrate examples of a foldable-type electronic device including a switching circuit for a dual IFA according to various embodiments of the disclosure;

FIGS. 10A, 10B, and 10C illustrate examples of a foldable-type electronic device according to various embodiments of the disclosure;

FIG. 11 illustrates an example of a foldable-type electronic device including a switching circuit for a dual IFA according to an embodiment of the disclosure;

FIGS. 12A, 12B, 12C, 13A, and 13B illustrate examples of a foldable-type electronic device according to various embodiments of the disclosure;

FIG. 14 illustrates an example of a foldable-type electronic device including a switching circuit for a dual IFA according to an embodiment of the disclosure;

FIGS. 15A and 15B illustrate examples of a foldable-type electronic device according to various embodiments of the disclosure;

FIG. 16 illustrates an example of a foldable-type electronic device including a switching circuit for a dual IFA according to an embodiment of the disclosure;

FIGS. 17A, 17B, 17C, and 17D illustrate states of an electronic device including a movable housing according to various embodiments of the disclosure;

FIG. 18 illustrates another example of an electronic device including a movable housing according to an embodiment of the disclosure; and

FIG. 19 illustrates an example of a rollable-type electronic device including a switching circuit for a dual IFA according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

Terms referring to a component of an electronic device (e.g., substrate, printed circuit board (PCB), flexible PCB (FPCB), printed board assembly (PBA), module, antenna, antenna element, circuit, processor, chip, component, or equipment), terms referring to a component related to radio frequency (RF) (e.g., front end module (FEM), power amplifier module (PAM), FEM including duplexer (FEMid), power amplifier module including duplexer (PAMid), Low noise amplifier PAM including duplexer (LPAMid), radio frequency front end (RFFE), radio frequency integrated circuit (RFIC)), terms referring to an antenna (e.g., antenna radiator, radiator, conductive pattern, coil, conductive member, radiating member, radiating material, radiating part, antenna structure, antenna structure), terms referring to a shape of a component (e.g., structure, structural object, supporting portion, contacting portion, or protruding portion), terms referring to a connecting portion between structures (e.g., connecting portion, contacting portion, supporting portion, contact structure, conductive member, or assembly), terms referring to an open structure (e.g., slot, slit, or opening), and terms referring to a circuit (e.g., PCB, FPCB, signal line, ground line, feeding line, data line, RF signal line, antenna line, RF path, RF module, RF circuit, splitter, divider, coupler, or combiner), used in the following description are exemplified for convenience of explanation. Therefore, the disclosure is not limited to terms to be described below, and another term having an equivalent technical meaning may be used. In addition, a term such as ‘. . . unit’, ‘. . . device’, ‘. . . object’, and ‘. . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’or ‘D’, that is, {‘C’, ‘D’, and ‘C’and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

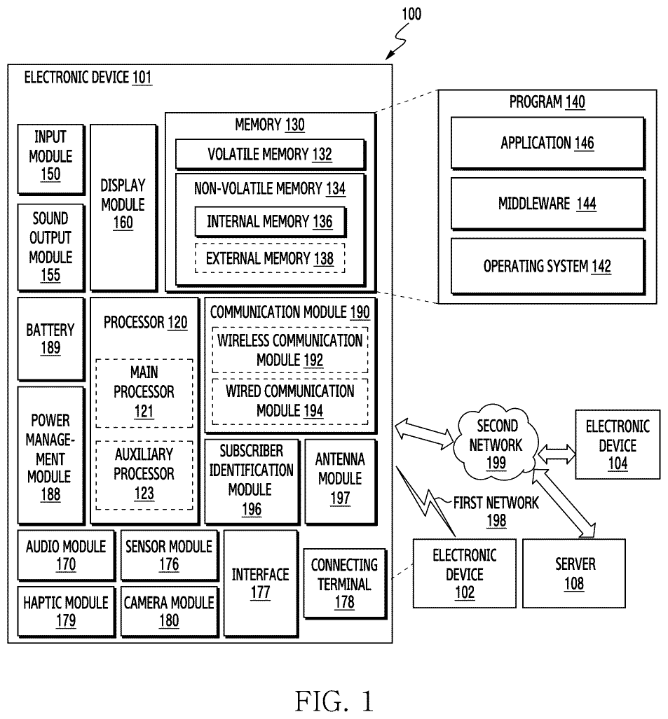

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104 or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

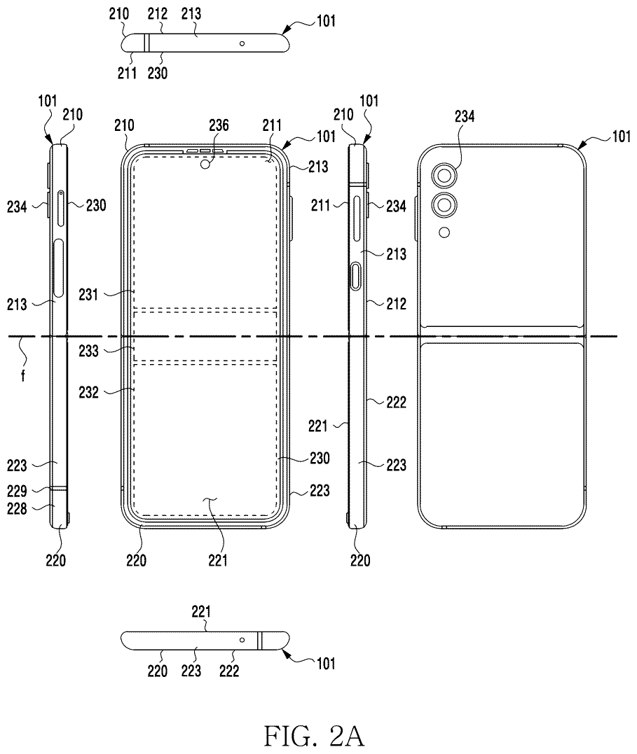

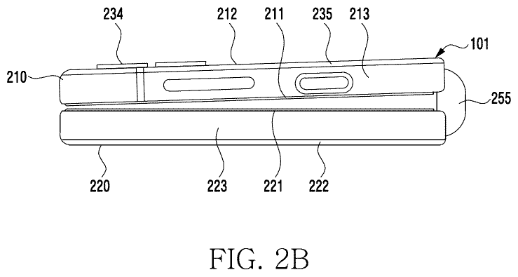

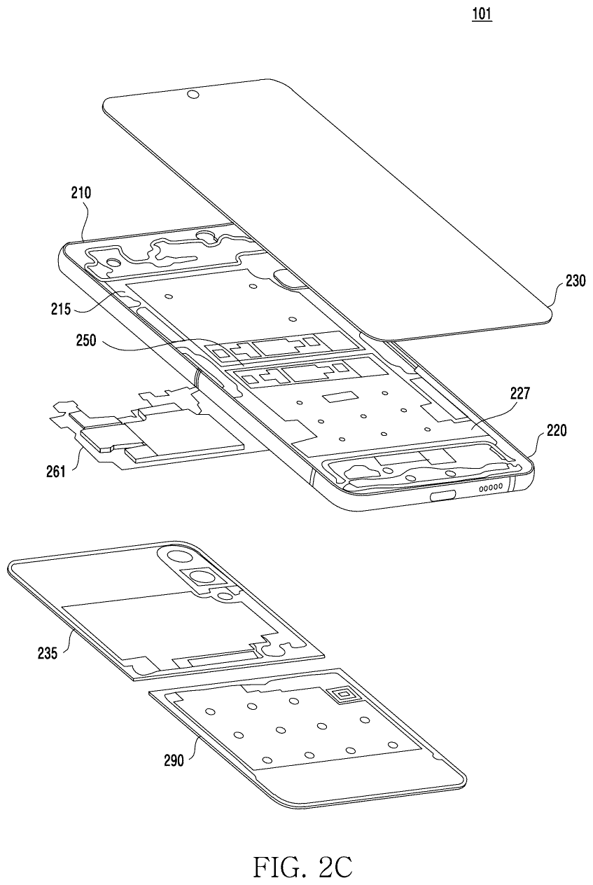

FIGS. 2A, 2B, and 2C illustrate an example of a foldable-type electronic device according to various embodiments of the disclosure.

FIG. 2A illustrates an unfolded state of an electronic device 101. FIG. 2B illustrates a folded state of the electronic device 101. FIG. 2C is an exploded view of the electronic device 101.

Referring to FIGS. 2A, 2B, and 2C, the electronic device 101 may include a first housing part 210, a second housing part 220, and a display 230.

The first housing part 210 may include a first surface 211, a second surface 212 faced away from the first surface 211, and a first side surface 213 surrounding at least a portion of the first surface 211 and the second surface 212. The first housing part 210 may further include at least one camera 234 and a display panel 235 exposed through a portion of the second surface 212. The first housing part 210 may provide a space formed by the first surface 211, the second surface 212, and the first side surface 213 as a space for positioning components of the electronic device 101. The second housing part 220 may include a third surface 221, a fourth surface 222 faced away from the third surface 221, and a second side surface 223 surrounding at least a portion of the third surface 221 and the fourth surface 222. The fourth surface 222 may further include a rear plate 290 disposed on the fourth surface 222. The first side surface 213 and the second side surface 223 may include a conductive material, a non-conductive material, or a combination thereof. For example, the first side surface 213 and the second side surface 223 may include a conductive portion 228 and a non-conductive portion 229. The conductive portion 228 may include a plurality of conductive members, and the plurality of conductive members may be spaced apart from each other. The non-conductive portion 229 may be disposed between the plurality of conductive members. An antenna structure may be formed by some or a combination of a plurality of conductive members and a plurality of non-conductive members.

The first housing part 210 may be rotatably (or pivotably) connected to the second housing part 220 through a hinge structure 250 disposed on a hinge cover 255. The hinge structure 250 may include a hinge plate. For example, the hinge plate may include a first hinge plate and a second hinge plate. The first hinge plate may be connected to the first housing part 210, and the second hinge plate may be connected to the second housing part 220. The second housing part 220 may provide a space formed by the third surface 221, the fourth surface 222 faced away from the third surface 221, and the second side surface 223 surrounding at least a portion of the third surface 221 and the fourth surface 222 as a space for positioning components of the electronic device 101. The display 230 may include a window exposed toward the outside. The window may protect a surface of the display 230 and may transmit visual information provided from the display 230 to the outside by being formed of a transparent member. The window may include a glass material such as ultra-thin glass (UTG) or a polymer material such as polyimide (PI). The display 230 may include a first display area 231 disposed on the first surface 211 of the first housing part 210, a second display area 232 disposed on the third surface 221 of the second housing part 220, and a third display area 233 between the first display area 231 and the second display area 232. At least a portion of the third display area 233 may be disposed on the hinge structure 250.

For example, an opening may be formed in a portion of a screen display area of the display 230, or a recess or an opening may be formed in a support portion (e.g., bracket) supporting the display 230. The electronic device 101 may include at least one camera aligned with the recess or the opening. For example, the first display area 231 may further include at least one camera 236 capable of obtaining an image from the outside through a portion of the first display area 231. For example, the at least one camera 236 may be included in a rear surface of the display 230 corresponding to the first display area 231 or the second display area 232 of the display 230. For example, the at least one camera 236 may be disposed under the display 230 and may be surrounded by the display 230. The at least one camera 236 may be covered by the display 230 and may not be exposed to the outside. However, it is not limited thereto, and the display 230 may include an opening exposing the at least one camera 236 to the outside. Although not shown in FIGS. 2A and 2B, the display 230 may further include a rear surface opposite to a front surface. The display 230 may be supported by a first support portion 215 of the first housing part 210 and a second support portion 227 of the second housing part 220.

The hinge structure 250 may be configured to rotatably connect the first support portion 215 to be fastened to the first hinge plate and the second support portion 227 to be fastened to the second hinge plate. The hinge cover 255 covering the hinge structure 250 may be exposed at least partially through the first housing part 210 and the second housing part 220 while the electronic device 101 is in a folded state. The hinge cover 255 may be covered by the first housing part 210 and the second housing part 220 while the electronic device 101 is in an unfolded state.

The electronic device 101 may be folded about a folding axis f passing through the hinge cover 255. For example, the hinge cover 255 may be disposed between the first housing part 210 and the second housing part 220 of the electronic device 101 to enable the electronic device 101 to be bent, curved, or folded. For example, the first housing part 210 may be connected to the second housing part 220 through the hinge structure 250 disposed on the hinge cover 255, and may be rotatable about the folding axis f.

The electronic device 101 may be folded so that the first housing part 210 and the second housing part 220 may face each other by rotating about the folding axis f. The electronic device 101 may be folded so that the first housing part 210 and the second housing part 220 may be stacked or overlapped with each other.

Referring to FIG. 2C, the electronic device 101 may include a first housing part 210, a second housing part 220, a hinge structure 250, a display 230, a printed circuit board 261, a display panel 235, and a rear plate 290. For example, the electronic device 101 may omit at least one of the components or may additionally include another component.

For example, the hinge structure 250 may include a hinge plate. For example, the hinge structure 250 may include a hinge gear by which the first housing part 210 and the second housing part 220 are made pivotable.

For example, the first support portion 215 may be partially surrounded by the first side surface 213. For example, the first support portion 215 may be integrally formed with the first side surface 213. For example, the second support portion 227 may be partially surrounded by the second side surface 223. For example, the second support portion 227 may be integrally formed with the second side surface 223. However, it is not limited thereto. For example, the first support portion 215 may be formed separately from the first side surface 213. For example, the second support portion 227 may be formed separately from the second side surface 223.

For example, a surface of the first support portion 215 may be coupled to the display 230, and another surface of the first support portion 215 may be coupled to the display panel 235. A surface of the second support portion 227 may be coupled to the display 230, and another surface of the second support portion 227 may be coupled to the rear plate 290.

For example, the printed circuit board 261 and a battery may be disposed between a surface formed by the first support portion 215 and the second support portion 227 and a surface formed by the display panel 235 and the rear plate 290. The printed circuit board 261 may be electrically connected to components for implementing various functions of the electronic device 101.

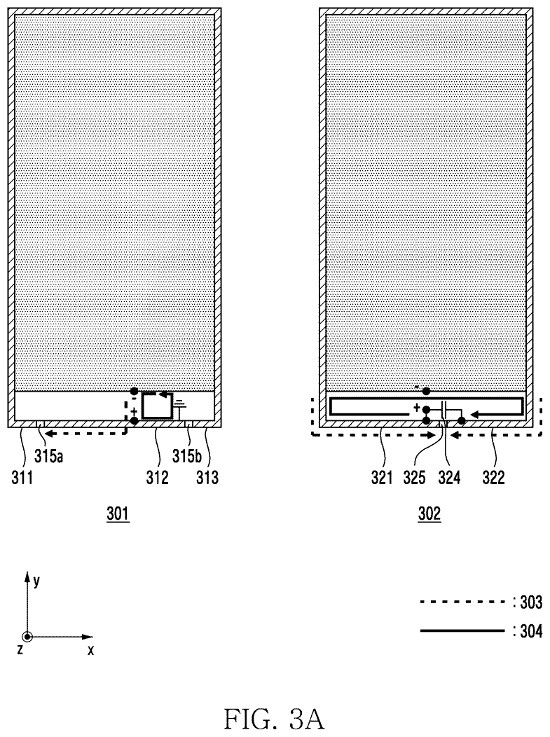

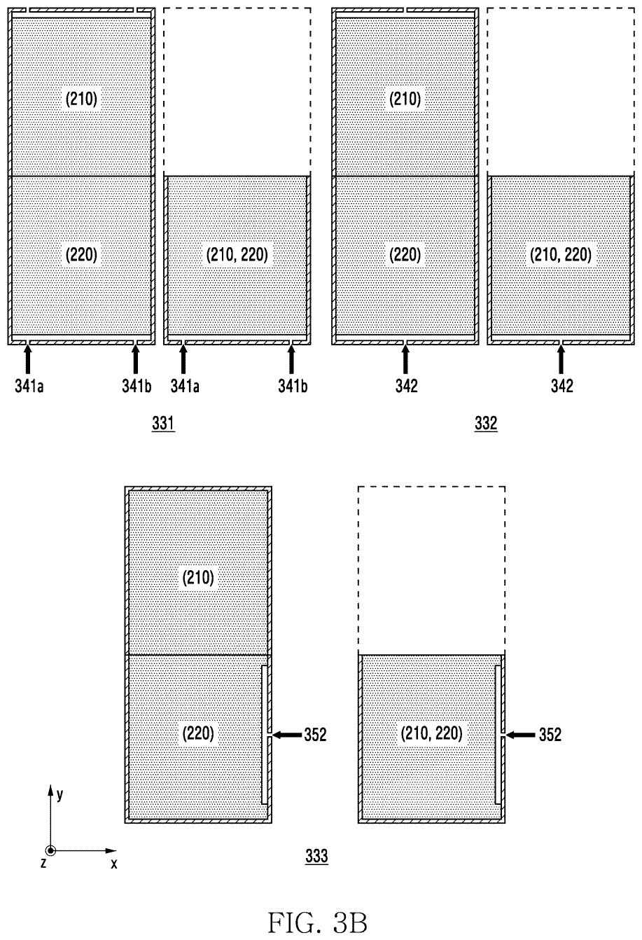

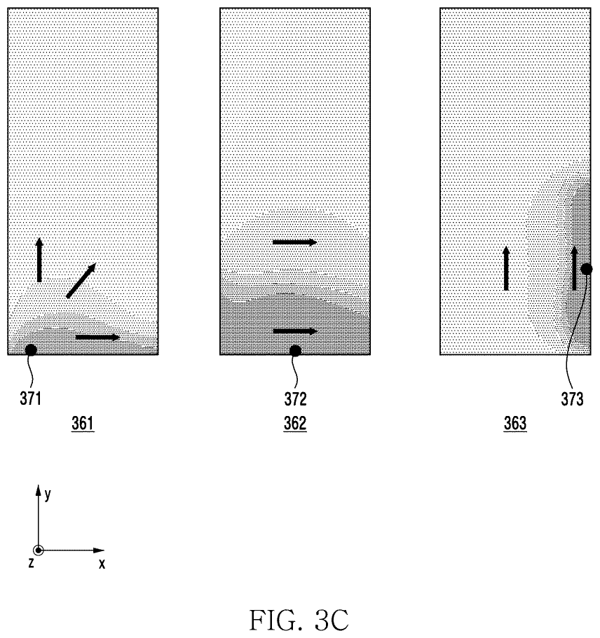

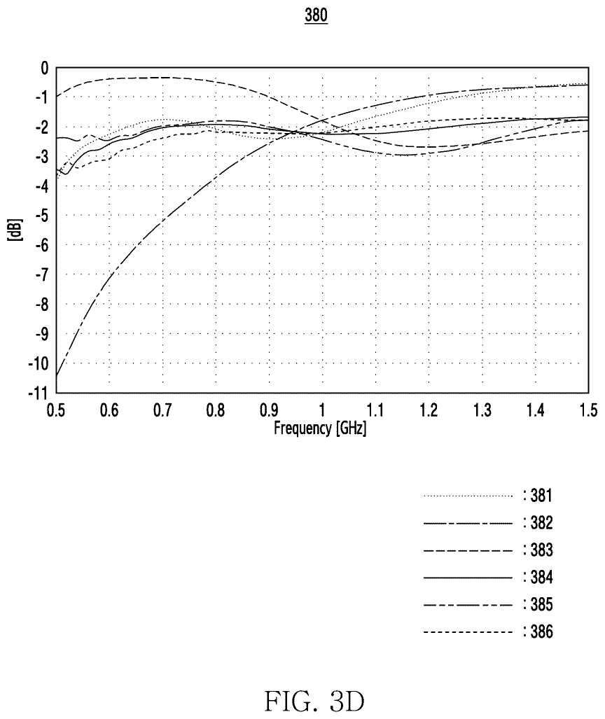

FIGS. 3A, 3B, 3C, and 3D are diagrams for describing an inverted-F antenna (IFA) and a dual IFA according to various embodiments of the disclosure.

The same reference number may be used for the same or similar descriptions.

Referring to FIG. 3A, an example 301 shows an IFA. An example 302 shows a dual IFA. A mark 303 indicates a path of a capacitive coupling current, and a mark 304 indicates a path of an inductive coupling current. Referring to the first example 301, the electronic device 101 may include an IFA. An antenna having a structure in which an antenna radiator, a power supply to the antenna radiator, and a connection between the antenna radiator and a ground are implemented as in the example 301 (IFA-type structure) may be referred to as an IFA. The electronic device 101 may include a first conductive portion 311, a second conductive portion 312, and a third conductive portion 313. A first non-conductive portion 315a may be disposed between the first conductive portion 311 and the second conductive portion 312. The first non-conductive portion 315a may be referred to as a first segmentation portion. A second non-conductive portion 315b may be disposed between the second conductive portion 312 and the third conductive portion 313. The second non-conductive portion 315b may be referred to as a second segmentation portion. The second conductive portion 312 may be used as a radiator of the IFA. Referring to the example 301, as the second conductive portion 312 separated by two segmentation portions (e.g., the first non-conductive portion 315a and the second non-conductive portion 315b) operates as a capacitive coupling element, a current mode of a ground may be excited.

Referring to the second example 302, the electronic device 101 may include a dual IFA. The dual IFA refers to a structure that radiates signals fed using a conductive portion (e.g., the first conductive portion 321) and another conductive portion (e.g., the second conductive portion 322) adjacent to the conductive portion. The two conductive portions (e.g., the first conductive portion 321 and the second conductive portion 322) may be connected to each other through a capacitor 324. An antenna having a structure in which antenna radiators (e.g., the first conductive portion 321, the second conductive portion 322), a connection between the antenna radiators, a power supply, and a connection between each antenna radiator and a ground are implemented as in the example 302 may be referred to as a dual IFA. Hereinafter, in the disclosure, the term “double IFA” may be used to refer to an antenna having the structure of the example 302 distinct from the structure of the IFA of the example 301. Unless otherwise defined, the term “IFA” may be used to refer to an antenna having a single IFA structure for distinction from “double IFA”. A non-conductive portion 325 may be disposed between the two conductive portions. The non-conductive portion 325 may be referred to as a segmentation portion. In the dual IFA, both conductive portions (e.g., the first conductive portion 321, the second conductive portion 322) may be grounded to the ground, and coupling may occur around the non-conductive portion 325. Thus, the two conductive portions may operate as a capacitive coupling element as well as an inductive coupling element.

Referring to FIG. 3B, the electronic device 101 may include the first housing part 210 and the second housing part 220. A support member (e.g., a metal structure) in the first housing part 210 and a support member (e.g., a metal structure) in the second housing part 220 may be used to provide a ground. The first housing part 210 and the second housing part 220 may be unfolded or folded. A state in which the first housing part 210 and the second housing part 220 are folded may be referred to as a folded state. A state in which the first housing part 210 and the second housing part 220 are not folded may be referred to as an unfolded state. For the folded state and the unfolded state, the descriptions of FIGS. 2A, 2B, and 2C may be referenced.

An example 331 shows a structure including an IFA. The electronic device 101 may include a first segmentation portion 341a (e.g., the first non-conductive portion 315a) and a second segmentation portion 341b (e.g., the second non-conductive portion 315b). The first segmentation portion 341a and the second segmentation portion 341b may be formed in the second housing part 220 and may be visible from the outside. A size of the ground of the first housing part 210 and the second housing part 220 in the folded state may be reduced compared to a size of the ground of the first housing part 210 and the second housing part 220 in the unfolded state. As an example, in a case that a ground direction is a major axis direction (e.g., y-axis direction) of the electronic device 101, the ground size in the folded state may be reduced to half the size of the ground in the unfolded state. An example 332 shows a structure in which a dual IFA is disposed at a lower end of the electronic device 101. The electronic device 101 may include a segmentation portion 342 (e.g., the non-conductive portion 325). The segmentation portion 342 may be formed in the second housing part 220 and may be visible from the outside. The size of the ground of the first housing part 210 and the second housing part 220 in the folded state may be reduced compared to the size of the ground of the first housing part 210 and the second housing part 220 in the unfolded state. As an example, in a case that the ground direction is the major axis direction (e.g., the y-axis direction) of the electronic device 101, the ground size in the folded state may be reduced to half the size of the ground in the unfolded state. An example 333 shows a structure in which a dual IFA is disposed on a side surface (e.g., a surface facing (+) x-axis direction) of the electronic device 101. The electronic device 101 may include a segmentation portion 352. The segmentation portion 352 may be formed in the second housing part 220 and may be visible from the outside. The size of the ground of the first housing part 210 and the second housing part 220 in the folded state may be reduced compared to the size of the ground of the first housing part 210 and the second housing part 220 in the unfolded state. As an example, in a case that the ground direction is the major axis direction (e.g., the y-axis direction) of the electronic device 101, the ground size in the folded state may be reduced to half the size of the ground in the unfolded state.

Referring to FIG. 3C, an example 361 shows a current distribution in a communication frequency band (e.g., about 600 megahertz (MHz)) according to a circuit structure of the example 331 of FIG. 3B. In the IFA, a current may be collected in an area 371 (e.g., an area adjacent to the first segmentation portion 341a) of an end portion (e.g., end portion facing the (−) x-axis) of a radiator (e.g., the second conductive portion 312). Based on the area 371, it may be identified that a current is induced in a minor axis direction (e.g., the x-axis direction) of the electronic device 101 around the radiator, but in other ground portions, a current is induced in the major axis direction (e.g., the y-axis direction) of the electronic device 101. An example 362 shows a current distribution in a communication frequency band (e.g., about 600 MHz) according to a circuit structure of the example 332 of FIG. 3B. In the IFA, a current may be collected in an area 372 (e.g., an area adjacent to the segmentation portion 342) between two conductive portions (e.g., the first conductive portion 321 and the second conductive portion 322). Based on the area 372, it may be identified that a current is induced in the minor axis direction (e.g., the x-axis direction) of the electronic device 101. An example 363 shows a current distribution in a communication frequency band (e.g., about 600 MHz) according to a circuit structure of the example 333 of FIG. 3B. In the IFA, a current may be collected in an area 373 (e.g., an area adjacent to the segmentation portion 352) between two conductive portions. Based on the area 373, it may be identified that a current is induced in the major axis direction (e.g., the y axis direction) of the electronic device 101.

Since the ground (e.g., a metal structure (which may be referred to as a support member or bracket) within the first housing part 210, a metal structure (which may be referred to as a support member or bracket) within the second housing part 220, or a metal structure (which may be referred to as a support member or bracket) within the electronic device 101) with in the electronic device 101 is not large compared to an actual operating frequency, the ground may be used for radiation. Therefore, a characteristic of current induced in the ground may affect the radiation performance of the antenna.

Referring to FIG. 3D, a graph 380 shows a radiation efficiency for each frequency. A horizontal axis of the graph 380 indicates a frequency (unit: gigahertz (GHz)), and a vertical axis of the graph 380 indicates a radiation efficiency (unit: decibel (dB)). A first line 381 indicates radiation performance in the unfolded state of the electronic device 101 including the IFA of the first example 331. A second line 382 indicates radiation performance in the folded state of the electronic device 101 including the IFA of the first example 331. A third line 383 indicates radiation performance in the unfolded state of the electronic device 101 including the dual IFA of the third example 333. A fourth line 384 indicates radiation performance in the folded state of the electronic device 101 including the dual IFA of the third example 333. A fifth line 385 indicates radiation performance in the unfolded state of the electronic device 101 including the dual IFA of the second example 332. A sixth line 386 indicates radiation performance in the folded state of the electronic device 101 including the dual IFA of the second example 332.

If the first line 381 and the second line 382 are compared, a performance degradation in the folded state of about 3.5 dB at about 700 MHz and about 4.9 dB at about 600 MHz may be identified. This is because a ground length in the major axis (e.g., y-axis) direction of the electronic device 101 is reduced in the IFA structure implemented at the lower end of the electronic device 101. For example, as the ground length is reduced from about 160 mm to about 80 mm, the radiation performance of the IFA may deteriorate. If the fifth line 385 and the sixth line 386 are compared, a performance degradation in the folded state of about 0.5 dB at a frequency of about 600 MHz may be identified. This is because, unlike the IFA, in the dual IFA, a current flowing in the minor axis (e.g., the x-axis) direction of the electronic device 101 mainly affects radiation performance, as illustrated in FIG. 3C. Therefore, even if the ground length in the major axis (e.g., y-axis) direction is reduced due to the folded state, the performance reduction amount of the dual IFA may be less than that of the IFA. In other words, since a main current component of the dual IFA at the ground has in the minor axis (e.g., x-axis) direction of the electronic device 101, a transition between the unfolded state and/or the folded state of the electronic device 101 including the dual IFA may have less effect on the antenna radiation characteristic than a transition of the electronic device including the IFA.

If the third line 383 and the fourth line 384 are compared, the performance degradation of about 1.6 dB at a frequency of about 700 MHz and about 2.1 dB at a frequency of about 600 MHz may be identified. In a certain frequency band (e.g., less than about 1 GHz), it may be identified that the radiation efficiency in the fourth line 384 is higher than that of the sixth line 386. The dual IFA implemented at the side surface may experience performance degradation when transitioning from the unfolded state to the folded state, in terms of utilizing the ground current of the major axis direction of the electronic device 101. However, in terms of utilizing the ground current of the major axis direction of the electronic device 101, the overall radiation efficiency of the dual IFA implemented at the side surface (e.g., the dual IFA of the example 333) may be higher than the overall radiation efficiency of the dual IFA implemented at the lower end (e.g., the dual IFA of the example 332). This is because the ground in the major axis direction is sufficiently utilized as the dual IFA is implemented at the side surface of the electronic device 101.

As described through FIGS. 3A to 3D, using the IFA in both the unfolded state and the folded state of the electronic device 101 may be difficult to secure sufficient radiation performance due to the shortened ground length. Accordingly, in embodiments of the disclosure, a technique for utilizing an antenna having a structure that provides high radiation performance according to a state (e.g., unfolded state or folded state) of the electronic device 101 is described. For example, the electronic device 101 may use a dual IFA using a ground current of a minor axis (e.g., x-axis) direction in the folded state of the first housing part 210 and the second housing part 220.

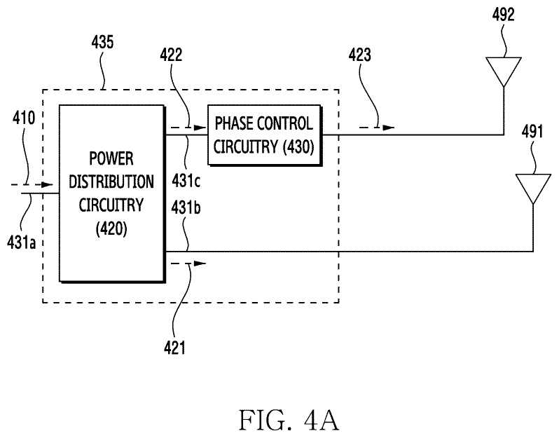

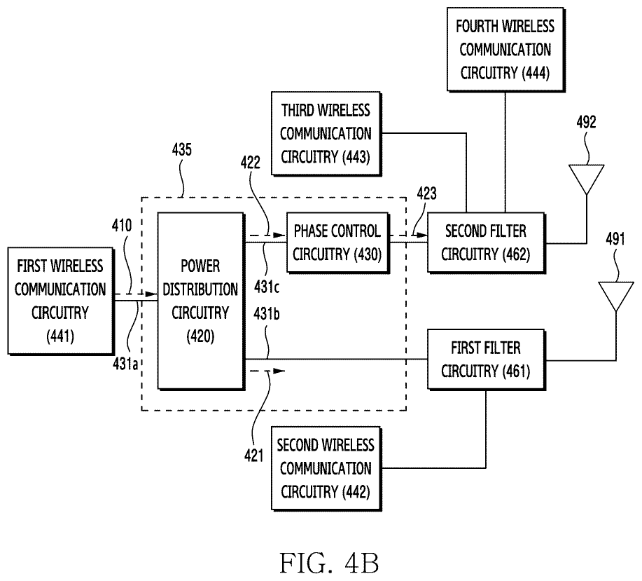

FIGS. 4A and 4B illustrate examples of an electronic device (e.g., the electronic device 101) including signal distribution circuitry according to various embodiments of the disclosure. As a technology for reducing coupling between antennas in a folded state of the electronic device 101, an equal phase antenna (EPA) may be used. Hereinafter, components for the EPA are described in FIGS. 4A and 4B. The same reference number may be used for the same or similar descriptions.

Referring to FIG. 4A, the electronic device 101 may include signal distribution circuitry 435. The signal distribution circuitry 435 may include power distribution circuitry 420 and phase control circuitry 430. According to an embodiment, the power distribution circuitry 420 may be configured to distribute an input signal 410. The power distribution circuitry 420 may be configured to output a first signal 421 and a second signal 422 through power distribution with respect to the input signal 410. The power distribution circuitry 420 may be connected to an input path 431a, a first output path 431b, and a second output path 431c. The power distribution circuitry 420 may obtain the input signal 410 through the input path 431a. As an example, the input path 431a may be connected to wireless communication circuitry (e.g., the wireless communication module 192 or the RFFE module). The power distribution circuitry 420 may obtain the input signal 410 from the wireless communication circuitry. The power distribution circuitry 420 may output the first signal 421 through the first output path 431b. For example, the first output path 431b may be connected to a first antenna 491. The first signal 421 may be provided to the first antenna 491 through the first output path 431b. The power distribution circuitry 420 may output the second signal 422 through the second output path 431c. For example, the second output path 431c may be connected to a second antenna 492 through the phase control circuitry 430. The second signal 422 may be provided to the phase control circuitry 430 through the second output path 431c. The phase control circuitry 430 may be configured to provide the second antenna 492 with a third signal 423 in which a phase of the second signal 422 is changed. According to an embodiment, the power distribution circuitry 420 may include a switching circuit. The power distribution circuitry 420 may not only divide the input signal 410 into two or more signals, but may also perform a function of providing the input signal 410 to a specific signal path selected from a plurality of signal paths. For example, the power distribution circuitry 420 may transmit the input signal 410 to the first antenna 491 or the input signal 410 to the second antenna 492.

The electronic device 101 may operate in an EPA mode. In the EPA mode, the power distribution circuitry 420 may distribute the input signal 410 obtained through the input path 431a. The distributed signals (e.g., the first signal 431 and the second signal 432) may be transferred to the first antenna 491 and the second antenna 492, respectively. According to the arrangement of the first antenna 491 and the second antenna 492 in the electronic device 101, a distance from the signal distribution circuitry 435 to the first antenna 491 and a distance from the signal distribution circuitry 435 to the second antenna 492 may be different. A distance to which a signal is transferred may affect a phase. In order to reduce a difference (hereinafter, a phase difference) between a phase of a signal emitted from the first antenna 491 and a phase of a signal emitted from the second antenna 492, the phase control circuitry 430 may be used.

In FIG. 4A, an example in which the phase control circuitry 430 is disposed only at a signal path (e.g., the second output path 431c) to the second antenna 492 has been described, but embodiments of the disclosure are not limited thereto. For example, in order to reduce a phase difference between two antennas (e.g., the first antenna 491 or the second antenna 492), phase control circuitry may also be disposed in a signal path (e.g., the first output path 431b) connected to the first antenna, in addition to the phase control circuitry 430. For another example, phase control circuitry may not be disposed in a signal path (e.g., the second output path 431c) connected to the second antenna 492, and may be disposed in a signal path (e.g., the first output path 431b) connected to the first antenna 491.

Referring to FIG. 4B, the electronic device 101 may include a plurality of wireless communication circuitry (e.g., RFFE modules). For example, the plurality of wireless communication circuitry may include first wireless communication circuitry 441, second wireless communication circuitry 442, third wireless communication circuitry 443, and/or fourth wireless communication circuitry 444. The first wireless communication circuitry 441 may be connected to the signal distribution circuitry 435 (e.g., the power distribution circuitry 420 or the phase control circuitry 430). The first wireless communication circuitry 441 may output the input signal 410. For example, the first wireless communication circuitry 441 may be a low noise amplifier power amplifier module (PAM) including duplexer (LPAMid) (e.g., a module including a power amplifier, a duplexer, transmission processing circuitry, and reception processing circuitry) that supports a low-band (LB) frequency band (e.g., a frequency band less than about 1 GHz).

The signal distribution circuitry 435 may be connected to at least one filter circuitry. For example, the at least one filter circuitry may include first filter circuitry 461 and second filter circuitry 462. The first filter circuitry 461 may be connected to the first antenna 491. For example, the first filter circuitry 461 may be connected to the first wireless communication circuitry 441 and the second wireless communication circuitry 442. As an example, the second wireless communication circuitry 442 may be a PAM including duplexer (PAMid) that supports signal processing in a frequency band of a mid-band (e.g., a frequency band greater than or equal to about 1 GHz and less than 2.3 GHz) and/or a frequency band of a high-band (HB) (e.g., a frequency band being greater than or equal to about 2.3 GHz and less than 3 GHz). The first filter circuitry 461 may include a diplexer for distinguishing signals in a frequency band of the first wireless communication circuitry 441 from signals in a frequency band of the second wireless communication circuitry 442. For example, the second filter circuitry 462 may be connected to the first wireless communication circuitry 441, the third wireless communication circuitry 443, and the fourth wireless communication circuitry 444. As an example, the third wireless communication circuitry 443 may be a front end module including duplexer (FEMid) that supports signal processing in a frequency band of the mid-band (MB) and/or a frequency band of the high-band (HB). For example, the fourth wireless communication circuitry 444 may be an FEMid that supports signal processing in a frequency band (e.g., a frequency band greater than or equal to 3 GHz) of an ultra-high band (UHB). The second filter circuitry 462 may include a triplexer for distinguishing signals in a frequency band of the first wireless communication circuitry 441, signals in a frequency band of the third wireless communication circuitry 443, and signals in a frequency band of the fourth wireless communication circuitry 444.

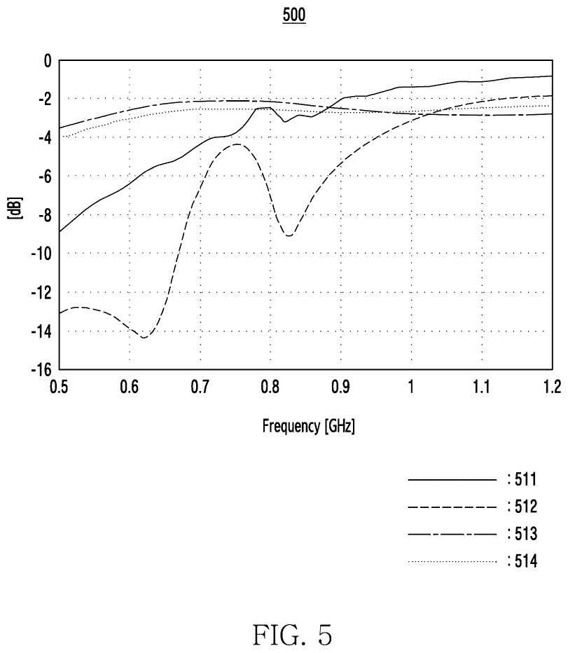

FIG. 5 illustrates an example of the performance of a dual IFA using signal distribution circuitry (e.g., the signal distribution circuitry 435) according to an embodiment of the disclosure. The same reference number may be used for the same or similar descriptions.

Referring to FIG. 5, a graph 500 shows a radiation efficiency for each frequency. A horizontal axis of the graph 500 indicates a frequency (unit: gigahertz (GHz)), and a vertical axis of the graph 500 indicates a radiation efficiency (unit: decibel (dB)). A first line 511 indicates a radiation efficiency of an IFA using EPA (e.g., the EPA described through FIGS. 4A and 4B) in a folded state. A second line 512 indicates a radiation efficiency of an IFA without using the EPA in the folded state. A third line 513 indicates a radiation efficiency of a dual IFA using EPA (e.g., the EPA described through FIGS. 4A and 4B) at a side surface of the electronic device 101 in the folded state. A fourth line 514 indicates a radiation efficiency of a dual IFA using EPA (e.g., the EPA described through FIGS. 4A and 4B) at each of an upper end and a lower end of the electronic device 101 in the folded state. When comparing the first line 511 with the second line 512, the third line 513, and/or the fourth line 514, it may be identified that the radiation performance is improved due to the EPA. When comparing the first line 511 with the third line 513 or the fourth line 514 in a frequency band of a low band (e.g., about 0.85 GHz or less), it may be identified that a dual IFA has an advantage in antenna radiation performance over the IFA in the folded state.

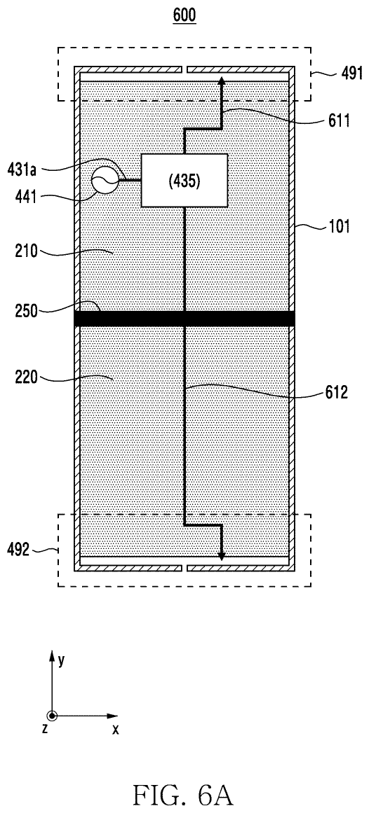

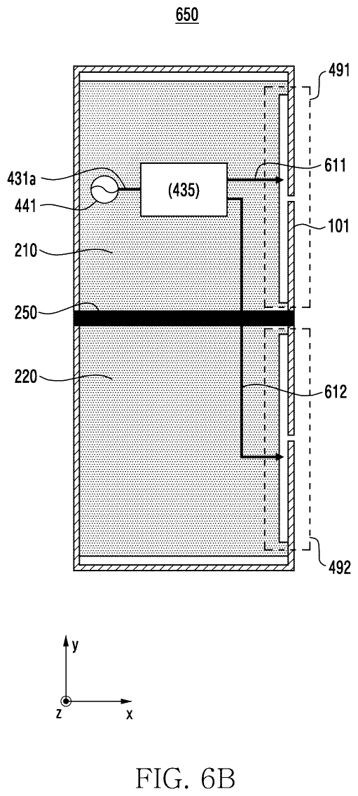

FIGS. 6A and 6B illustrate examples of an electronic device (e.g., the electronic device 101) including a dual IFA according to various embodiments of the disclosure. The same reference number may be used for the same or similar descriptions. In order to use the EPA technology of FIGS. 4A and 4B, antennas (e.g., the first antenna 491 or the second antenna 492) used to emit a signal are required to have similar antenna characteristics (e.g., directional efficiency, or performance) according to frequency.

Referring to FIG. 6A, a first housing part 210, a second housing part 220, and a hinge structure 250 of the electronic device 101 may be included. The electronic device 101 may include wireless communication circuitry (e.g., the first wireless communication circuitry 441 of FIG. 4B) as a signal source. The wireless communication circuitry 441 may provide an input signal 410. The input signal 410 may be applied to signal distribution circuitry 435 through an input path 431a. The input signal 410 may be distributed through the signal distribution circuitry 435. For example, the input signal 410 may be distributed into a first signal (e.g., the first signal 421) and a second signal (e.g., the second signal 422). A phase of at least a portion (e.g., the second signal 422) of distributed signals may be changed. The output signals of the signal distribution circuitry 435 may be provided to the first antenna 491 and the second antenna 492, respectively. For example, a signal (e.g., the first signal 421) distributed from the input signal 410 may be transmitted to the first antenna 491 through a first transmission path 611 (e.g., the first output path 431b of FIGS. 4A and 4B). Another signal (e.g., the third signal 423) distributed from the input signal 410 may be transmitted to the second antenna 492 through a second transmission path 612 (e.g., the second output path 431c of FIGS. 4A and 4B). For the EPA, antenna characteristics according to frequency should be similar between two antennas (e.g., the first antenna 491 and the second antenna 492), and therefore, the two antennas may be symmetrically disposed in an unfolded state. The two antennas may be arranged to be aligned in the folded state.

The electronic device 101 according to embodiments of the disclosure may include a dual IFA (e.g., the example 332 in FIG. 3B) disposed at a lower end (e.g., a frame area facing the (−) y-axis direction) and an antenna structure using EPA. As in an example 600, the electronic device 101 may include a dual IFA in each of an upper end (e.g., an area facing the (+) y-axis) and a lower end (e.g., an area facing the (+) y-axis). The electronic device 101 may include a dual IFA in the first housing part 210 as the first antenna 491. The electronic device 101 may include a dual IFA in the second housing part 220 as the second antenna 492.

Referring to FIG. 6B, a first housing part 210, a second housing part 220, and a hinge structure 250 of the electronic device 101 may be included. The electronic device 101 may include wireless communication circuitry (e.g., the first wireless communication circuitry 441 of FIG. 4B) as a signal source. The wireless communication circuitry 441 may provide an input signal 410. The input signal 410 may be applied to the signal distribution circuitry 435 through an input path 431a. The input signal 410 may be distributed through the signal distribution circuitry 435. For example, the input signal 410 may be distributed into a first signal (e.g., the first signal 421) and a second signal (e.g., the second signal 422). A phase of at least a portion (e.g., the second signal 422) of the distributed signals may be changed. The output signals of the signal distribution circuitry 435 may be provided to the first antenna 491 and the second antenna 492, respectively. A signal (e.g., the first signal 421) distributed from the input signal 410 may be transmitted to the first antenna 491 through a first transmission path 611 (e.g., the first output path 431b of FIGS. 4A and 4B). Another signal (e.g., the third signal 423) distributed from the input signal 410 may be transmitted to the second antenna 492 through a second transmission path 612 (e.g., the second output path 431c of FIGS. 4A and 4B). For the EPA, antenna characteristics according to frequency should be similar between two antennas (e.g., the first antenna 491 and the second antenna 492), and therefore, the two antennas may be symmetrically disposed in an unfolded state. The two antennas may be arranged to be aligned in the folded state.

The electronic device 101 according to embodiments of the disclosure may include a dual IFA (e.g., the example 333 in FIG. 3B) disposed on a side surface (e.g., a left side facing the (−) x-axis direction or a right side facing the (+) x-axis direction) and an antenna structure using EPA. The electronic device 101 may include a dual IFA. As in an example 650, the electronic device 101 may include a dual IFA disposed on each of a side (e.g., a surface facing the (+) x-axis direction) of the first housing part 210 and a side (e.g., a surface facing the (+) x-axis direction) of the second housing part 220. The electronic device 101 may include a dual IFA in the first housing part 210 as the first antenna 491. The electronic device 101 may include a dual IFA in the second housing part 220 as the second antenna 492.

The electronic device 101 may be a foldable-type electronic device. It has been described through FIGS. 1, 2A to 2C, 3A to 3D, 4A, 4B, 5, 6A, and 6B that the dual IFA provides higher radiation performance than the IFA in the folded state of the first housing part 210 and the second housing part 220. Meanwhile, when comparing the first line 381 and the third line 383 of the graph 350 of FIG. 3D, it may be identified that the IFA provides higher antenna radiation performance than the dual IFA disposed at the side of the electronic device 101 in a certain frequency range (e.g., less than about 800 MHz). Similarly, when comparing the first line 381 and the fifth line 385 of the graph 350 of FIG. 3D, it may be identified that the IFA provides higher antenna radiation performance than the dual IFA disposed at the lower end of the electronic device 101 in a certain frequency range (e.g., less than about 800 MHz). Accordingly, the electronic device 101 according to embodiments of the disclosure may adaptively change an antenna structure for transmitting or receiving a signal in a communication frequency band (e.g., a frequency band of LB, 600 MHz band, or 700 MHz band) according to whether it is in the unfolded or the folded state. According to an embodiment, the electronic device 101 may use the dual IFA in the folded state of the first housing part 210 and the second housing part 220. In the unfolded state of the first housing part 210 and the second housing part 220, the electronic device 101 may use another type of antenna instead of the dual IFA, based on at least one switching circuit.

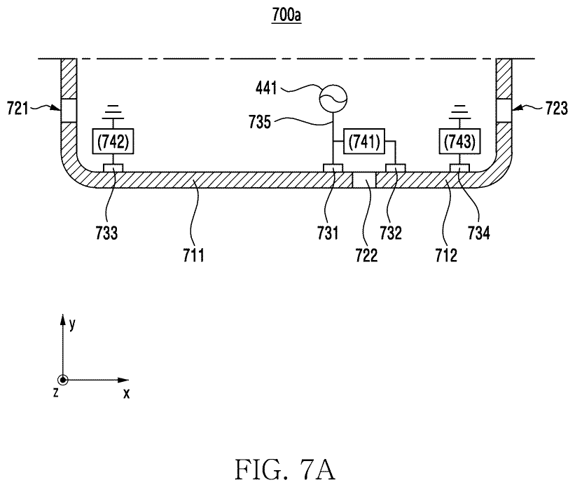

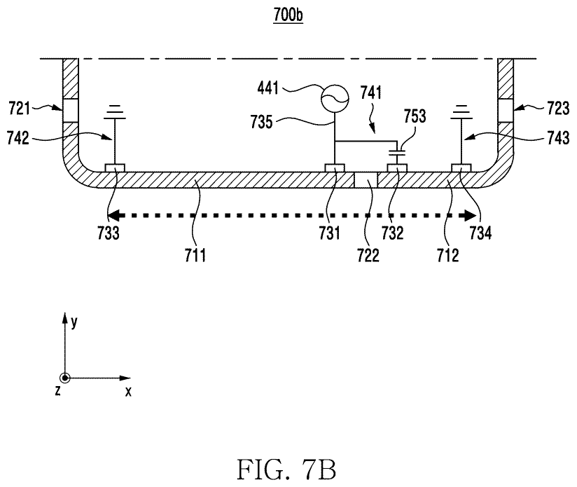

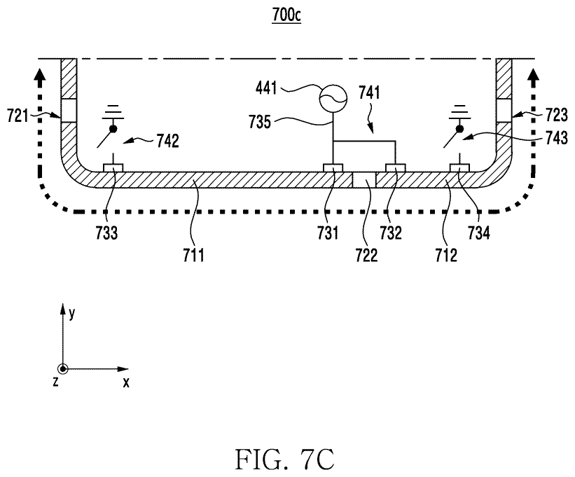

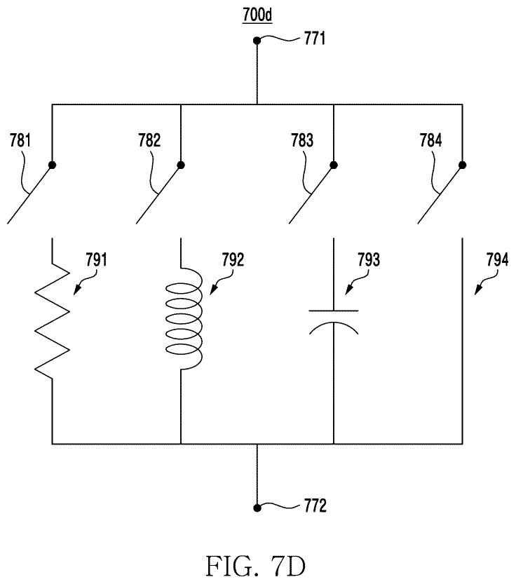

FIGS. 7A, 7B, 7C, and 7D illustrate examples of an electronic device (e.g., the electronic devices 101) including a switching circuit for a dual IFA according to various embodiments of the disclosure. The same reference number may be used for the same or similar descriptions.

Referring to FIG. 7A and example 700a, the electronic device 101 may include a plurality of conductive portions and a plurality of non-conductive portions. For example, the second housing part 220 of the electronic device 101 may include a plurality of conductive portions and a plurality of non-conductive portions. The plurality of conductive portions may be visible from the outside as a portion of a metal frame of the electronic device 101. The plurality of non-conductive portions, which is an injection-molded portion in the electronic device 101, may be visible from the outside. For example, the plurality of conductive portions may include a first conductive portion 711 and a second conductive portion 712. For example, the plurality of non-conductive portions may include a first non-conductive portion 721, a second non-conductive portion 722, and a third non-conductive portion 723. The first conductive portion 711 may be disposed between the first non-conductive portion 721 and the second non-conductive portion 722. The second conductive portion 712 may be disposed between the second non-conductive portion 722 and the third non-conductive portion 723.

The electronic device 101 may include wireless communication circuitry 441 (e.g., the RFFE module or the wireless communication module 192). The wireless communication circuitry 441 may indicate circuitry to which a signal is supplied from wireless communication circuitry (e.g., the communication module 190 or the wireless communication module 192) in the electronic device 101, as a signal source. For example, the wireless communication circuitry 441 may be connected to a portion where a signal is transmitted in a second transmission path 612 (or the second output path 431c) connected to the second antenna 492. A path 735 connecting the wireless communication circuitry 441 to the first conductive portion 711 may be understood as a portion of the second transmission path 612 (or the second output path 431c). The first conductive portion 711 and/or the second conductive portion 712 may be used as a radiator of the second antenna 492.

The electronic device 101 may include at least one switching circuit for changing an antenna structure. For example, the at least one switching circuit may include a first switching circuit 741, a second switching circuit 742, and/or a third switching circuit 743. The first switching circuit 741 may connect the path 735 connected to the first conductive portion 711 and the second conductive portion 712. For example, the first switching circuit 741 may connect a path 735 connected to the first conductive portion 711 and the second conductive portion 712 through a capacitor. For example, the first switching circuit 741 may connect the path 735 connected to the first conductive portion 711 and the second conductive portion 712 through a transmission line. Connecting two conductive portions through the transmission line may indicate shorting the two conductive portions. The path 735 connected to the first conductive portion 711 may be electrically connected to the second conductive portion 712 without a separate element. For example, the first switching circuit 741 may connect the path 735 connected to the first conductive portion 711 and the second conductive portion 712 through an element (e.g., inductor or resistor).

An area of the first conductive portion 711 connected to the path 735 may be referred to as a first feeding point 731. For example, the first conductive portion 711 may be electrically connected to the path 735 on a PCB (not shown) through a first connection member (e.g., C-clip) at the first feeding point 731. An area of the second conductive portion 712 connected to the first switching circuit 741 may be referred to as a second feeding point 732. For example, the second conductive portion 712 may be connected to a point on a PCB (not shown) through a second connection member (e.g., C-clip) at the second feeding point 732. The second switching circuit 742 may be configured to connect or disconnect (not connect) the first conductive portion 711 to a ground. An area of the first conductive portion 711 connected to the second switching circuit 742 may be referred to as a first grounding point 733. For example, the first conductive portion 711 may be electrically connected to a ground layer of the PCB or a metal structure (e.g., bracket) through a line of the second switching circuit 742 on a PCB (not shown) and a third connection member (e.g., C-clip) at the first grounding point 733. The third switching circuit 743 may be configured to connect or disconnect (not connect) the second conductive portion 712 to the ground. An area of the second conductive portion 712 connected to the second switching circuit 742 may be referred to as a second grounding point 734. For example, the second conductive portion 712 may be electrically connected to a ground layer of the PCB or a metal structure (e.g., bracket) through a line of the fourth switching circuit 744 on the PCB (not shown) and a fourth connection member (e.g., C-clip) at the second grounding point 734. According to an embodiment, the first conductive portion 711 may include a first end portion adjacent to the first non-conductive portion 721 and a second end portion adjacent to the second non-conductive portion 722. The first feeding point 731 may be disposed close to the second end portion from among the first end portion and the second end portion. The first grounding point 733 may be disposed close to the first end portion from among the first end portion and the second end portion. According to an embodiment, the second conductive portion 712 may include a first end portion adjacent to the second non-conductive portion 722 and a second end portion adjacent to the third non-conductive portion 723. The second feeding point 732 may be disposed close to the first end portion from among the first end portion and the second end portion. The second grounding point 734 may be disposed close to the second end portion from among the first end portion and the second end portion.

Referring to FIG. 7B and example 700b, the electronic device 101 may change an antenna structure, based on the first switching circuit 741, the second switching circuit 742, and/or the third switching circuit 743. The first switching circuit 741, the second switching circuit 742, and/or the third switching circuit 743 may be controlled to have a structure for a dual IFA. According to an embodiment, the first switching circuit 741 may be controlled to connect the second conductive portion 712 to a path 735 connected to the first conductive portion 711 through a capacitor 753. The second switching circuit 742 may be controlled to connect the first conductive portion 711 to the ground. The third switching circuit 743 may be controlled to connect the second conductive portion 712 to the ground. The first conductive portion 711 and the second conductive portion 712 may be used as a radiator for a dual IFA. For example, the dual IFA may correspond to the second antenna 492.

In FIG. 7B, a circuit structure in which each of the second switching circuit 742 and the third switching circuit 743 is directly connected to the ground for the dual IFA is illustrated, but the embodiments of the disclosure are not limited thereto. For example, the second switching circuit 742 and/or the third switching circuit 743 may be connected to the ground through a separate element (e.g., inductor, capacitor, or resistor) for requirements (physical constraints or required electrical length or circuit design) of the electronic device 101.

Referring to FIG. 7C and example 700c, the electronic device 101 according to embodiments of the disclosure may change an antenna structure, based on the first switching circuit 741, the second switching circuit 742, and/or the third switching circuit 743. As described above, in the folded state of the electronic device 101, it is advantageous to use a ground current of the minor axis direction (e.g., x-axis direction), so a structure of the dual IFA was used. However, in the unfolded state of the electronic device 101, it may be advantageous to use a ground of the major axis direction (e.g., y-axis direction). According to an embodiment, the electronic device 101 may include a dual radiating antenna (DRA) structure using the first conductive portion 711 and the second conductive portion 712 as independent antenna radiators, respectively. According to an embodiment, the first switching circuit 741 may short the second conductive portion 712 to the path 735 connected to the first conductive portion 711. The second switching circuit 742 may be controlled to disconnect the first conductive portion 711 to the ground. As an example, the second switching circuit 742 may be opened. The third switching circuit 743 may be controlled to disconnect the second conductive portion 712 to the ground. For example, the third switching circuit 743 may be opened. The first conductive portion 711 and the second conductive portion 712 may be used as radiators for the DRA. For example, the DRA may correspond to the second antenna 492.

FIG. 7C illustrates a circuit structure in which each of the second switching circuit 742 and the third switching circuit 743 is opened for the DRA, but the embodiments of the disclosure are not limited thereto. For example, for the requirements (physical constraints or required electrical length or circuit design) of the electronic device 101, the second switching circuit 742 and/or the third switching circuit 743 may be directly connected to the ground (without a separate element) or may be connected to the ground through a separate element (e.g., inductor, capacitor, or resistor).

The electronic device 101 may change an antenna structure, based on the first switching circuit 741, the second switching circuit 742, and/or the third switching circuit 743, as described through FIGS. 7A, 7B, and/or 7C. According to an embodiment, in the folded state, the electronic device 101 may control the first switching circuit 741, the second switching circuit 742, and/or the third switching circuit 743 for a circuit structure for a dual IFA as shown in FIG. 7B. In the folded state, the electronic device 101 may control the first switching circuit 741, the second switching circuit 742, and/or the third switching circuit 743 for a circuit structure for the DRA as shown in FIG. 7C. For the first switching circuit 741, the second switching circuit 742, and/or the third switching circuit 743, FIG. 7D may be referenced.

Referring to FIG. 7D, a switching circuit 700d according to an embodiment may be configured to connect or disconnect (not connect) a first port 771 and a second port 772. For example, the switching circuit 700d may include a plurality of switches. For example, the plurality of switches may include a first switch 781, a second switch 782, a third switch 783, and/or a fourth switch 784. The first switch 781 may be configured to connect or disconnect (not connect) the first port 771 and the second port 772 through a resistor 791. The second switch 782 may be configured to connect or disconnect (not connect) the first port 771 and the second port 772 through an inductor 792. The third switch 783 may be configured to connect or disconnect (not connect) the first port 771 and the second port 772 through a capacitor 793. The fourth switch 784 may be configured to connect or not connect the first port 771 and the second port 772 through a transmission line 794. Connecting two ports through the transmission line 794 may indicate shorting the two ports. As the two ports are directly connected without an external device, a current may flow between the first port 771 and the second port 772.

Although FIG. 7D describes a circuit structure in which each switch is connected to one element, the embodiments of the disclosure are not limited thereto. According to the impedance required between the two ports or a required electrical length, a combination of two or more elements may be connected to an individual switch.

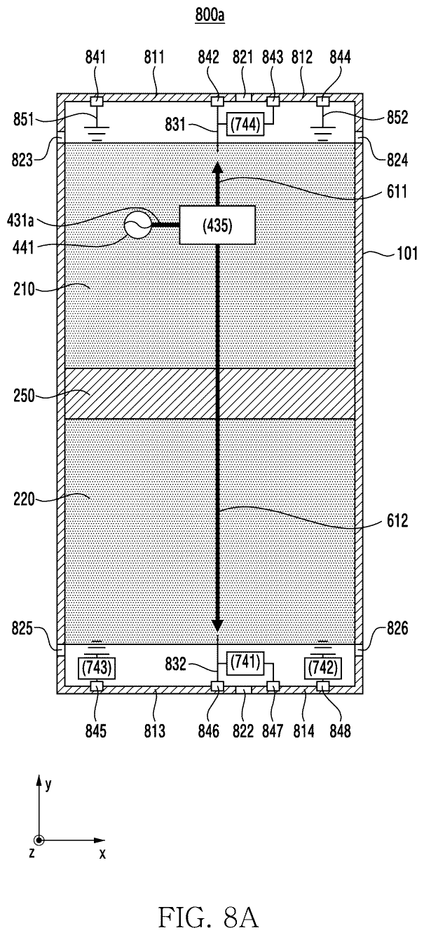

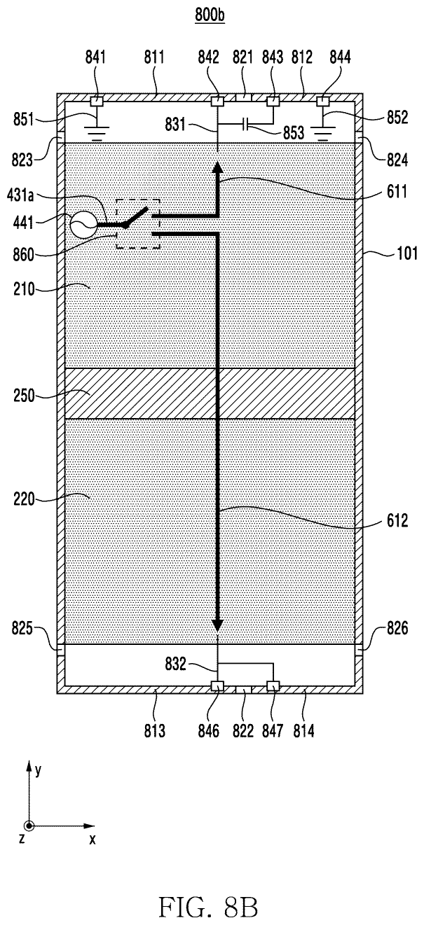

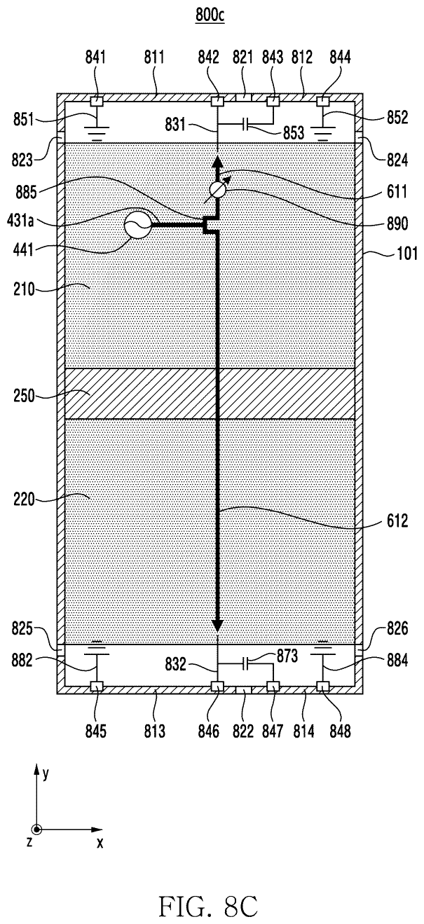

FIGS. 8A to 8C illustrate an example of a foldable-type electronic device (e.g., the electronic device 101) including a switching circuit for a dual IFA according to various embodiments of the disclosure. The same reference number may be used for the same or similar descriptions.

Referring to FIG. 8A, an example 800a illustrates components of the electronic device 101. A first housing part 210, a second housing part 220, and a hinge structure 250 of the electronic device 101 may be included. The electronic device 101 may include a plurality of conductive portions and a plurality of non-conductive portions. The plurality of conductive portions may be visible from the outside as a portion of a metal frame of the electronic device 101. For example, the plurality of conductive portions may include a first conductive portion 811, a second conductive portion 812, a third conductive portion 813, and a fourth conductive portion 814. The first housing part 210 may include the first conductive portion 811 and the second conductive portion 812. The second housing part 220 may include the third conductive portion 813 and the fourth conductive portion 814. The plurality of non-conductive portions, which is an injection-molded portion within the electronic device 101, may be visible from the outside. For example, the plurality of non-conductive portions may include a first non-conductive portion 821, a second non-conductive portion 822, a third non-conductive portion 823, a fourth non-conductive portion 824, a fifth non-conductive portion 825, and a sixth non-conductive portion 826. The first housing part 210 may include the first non-conductive portion 821, the third non-conductive portion 823, and the fourth non-conductive portion 824. The second housing part 220 may include the second non-conductive portion 822, the fifth non-conductive portion 825, and the sixth non-conductive portion 826. The first conductive portion 811 may be disposed between the first non-conductive portion 821 and the third non-conductive portion 823. The second conductive portion 812 may be disposed between the first non-conductive portion 821 and the fourth non-conductive portion 824. The third conductive portion 813 may be disposed between the second non-conductive portion 822 and the fifth non-conductive portion 825. The fourth conductive portion 814 may be disposed between the second non-conductive portion 822 and the sixth non-conductive portion 826.

The electronic device 101 may include wireless communication circuitry 441 (e.g., the communication module 190, the first wireless communication circuitry 441, the second wireless communication circuitry 442, the third wireless communication circuitry 443, or the fourth wireless communication circuitry 444). The wireless communication circuitry 441 may be connected to signal distribution circuitry 435 (e.g., including the power distribution circuitry 420 and/or the phase control circuitry 430 of FIGS. 4A and 4B) through an input path 431a. A signal (e.g., the input signal 410) applied to the signal distribution circuitry 435 through the input path 431a may be distributed through the signal distribution circuitry 435. A phase of at least a portion (e.g., the second signal 422) of the distributed signals may be changed through phase control circuitry (e.g., the phase control circuitry 430 of FIGS. 4A and 4B). The input signal 410 may be transmitted to at least one of a first antenna 491 and a second antenna 492. For example, at least a portion (e.g., the first signal 421) of the input signal 410 may be transmitted to the first antenna 491 through a first transmission path 611. For example, at least a portion (e.g., the third signal 423) of the input signal 410 may be transmitted to the second antenna 492 through a second transmission path 612.

The electronic device 101 may include a connection structure for a dual IFA disposed on an upper end of the first housing part 210. The first conductive portion 811 and the second conductive portion 812 may be used as radiators for the dual IFA. The first conductive portion 811 may be connected to the signal distribution circuitry 435 through the first transmission path 611. As a portion of the first transmission path 611, a path 831 connected to the first conductive portion 811 may be connected to a fourth switching circuit 744. A point 842 of the first conductive portion 811 may be connected to the path 831 on a PCB (not shown) through a connection member (e.g., C-clip, conductive pattern, or electrical material). According to an embodiment, the fourth switching circuit 744 may be controlled to connect the path 831 connected to the first conductive portion 811 and the second conductive portion 812 with a capacitor. A point 843 of the second conductive portion 812 may be connected to the fourth switching circuit 744 on a PCB (not shown) through a connection member (e.g., C-clip, conductive pattern, or electrical material). The path 831 connecting the first conductive portion 811 may be understood as a portion of the first transmission path 611. A point 841 of the first conductive portion 811 may be connected to the ground through a connection member 851 (e.g., C-clip, conductive pattern, or electrical material). A point 844 of the second conductive portion 812 may be connected to the ground through a connection member 852 (e.g., C-clip, conductive pattern, or electrical material).

The electronic device 101 may include a connection structure for a dual IFA and DRA disposed at the lower end of the second housing part 220. The third conductive portion 813 may be connected to the signal distribution circuitry 435 through a second transmission path 612. As a portion of the second transmission path 612, a path 832 connected to the third conductive portion 813 may be connected to the first switching circuit 741. A point 846 of the third conductive portion 813 may be connected to the path 832 on a PCB (not shown) through a connection member (e.g., C-clip, conductive pattern, or electrical material). According to an embodiment, the first switching circuit 741 may be controlled to connect the fourth conductive portion 814 and the path 832 connected to the third conductive portion 813 with a capacitor. According to an embodiment, the first switching circuit 741 may be controlled to short the fourth conductive portion 814 and the path 832 connected to the third conductive portion 813. A point 847 of the fourth conductive portion 814 may be connected to the first switching circuit 741 on a PCB (not shown) through a connection member (e.g., C-clip, conductive pattern, or electrical material). For example, the first switching circuit 741 may be controlled to connect the path 832 and the fourth conductive portion 814 to a line (e.g., the transmission line 794) without an element. Signals fed through the path 832 may be transmitted to the third conductive portion 813 and the fourth conductive portion 814, respectively. The third conductive portion 813 and the fourth conductive portion 814 may be used as radiators of the DRA. For the operation of the first switching circuit 741, the description of FIGS. 7A to 7D may be referenced.

The second switching circuit 742 may connect or disconnect (not connect) a point 845 of the third conductive portion 813 to a ground (e.g., ground layer of PCB, support member, or bracket). For the operation of the second switching circuit 742, the description of FIGS. 7A to 7D may be referenced. The third conductive portion 813 may be referred to as the first conductive portion 711. The fourth conductive portion 814 may be referred to as the second conductive portion 712. The third switching circuit 743 may connect or disconnect (not connect) a point 848 of the fourth conductive portion 814 to a ground (e.g., ground layer of PCB, support member, or bracket). For the operation of the third switching circuit 743, the description of FIGS. 7A to 7D may be referenced. The third conductive portion 813 may be referred to as the first conductive portion 711. The fourth conductive portion 814 may be referred to as the second conductive portion 712.

Referring to FIG. 8B, an example 800b illustrates an antenna connection structure of a first mode (e.g., selection mode). According to an embodiment, the electronic device 101 may operate in the selection mode. The electronic device 101 may operate in the selection mode in the unfolded state. In an embodiment, since it may be difficult for the dual IFA to always provide high antenna performance in the unfolded state, the electronic device 101 may control at least one switching circuit (e.g., the first switching circuit 741, the second switching circuit 742, the third switching circuit 743, and/or the fourth switching circuit 744) so as to have a structure for the dual IFA at the upper end and a structure for the DRA at the lower end. For example, the first switching circuit 741 may connect the fourth conductive portion 814 to a path 832 connected to the third conductive portion 813. As the fourth conductive portion 814 is shorted to the path 832, signals fed through the second transmission path 612 may be transmitted to both the third conductive portion 813 and the fourth conductive portion 814. The second switching circuit 742 may be opened. The third switching circuit 743 may be opened. For example, the fourth switching circuit 744 may connect the capacitor 853 between the second conductive portion 812 and the path 831 connected to the first conductive portion 811. The capacitor 853 may be a portion of components of the fourth switching circuit 744.

According to an embodiment, the electronic device 101 may use the dual IFA (e.g., the first conductive portion 811 or the second conductive portion 812) equipped at the upper end, or the DRA (e.g., the third conductive portion 813 or the fourth conductive portion 814) equipped at the lower end. For example, in the selection mode, a basic operation may be to use the DRA equipped at the lower end, and a preliminary operation may be to use the dual IFA equipped at the upper end. As an example, in the unfolded state of the electronic device 101, the electronic device 101 may transmit and/or receive signals through the DRA (e.g., the third conductive portion 813 or the fourth conductive portion 814) equipped at the lower end. In the unfolded state of the electronic device 101, if a user of the electronic device 101 grips a portion of the second housing part 220, a radiation gain of the DRA may be reduced. The electronic device 101 may perform antenna switching. For example, a switch 860 within the signal distribution circuitry 435 may be controlled to connect wireless communication circuitry (e.g., the communication module 190, the first wireless communication circuitry 441, the second wireless communication circuitry 442, the third wireless communication circuitry 443, or the fourth wireless communication circuitry 444) to the first transmission path 611 from among the first transmission path 611 and the second transmission path 612. In the unfolded state of the electronic device 101, the electronic device 101 may transmit and/or receive signals through the dual IFA (e.g., the first conductive portion 811 or the second conductive portion 812) equipped at the upper end.

Referring to FIG. 8C, an example 800c illustrates an antenna connection structure of a second mode (e.g., an EPA mode). According to an embodiment, the electronic device 101 may operate in the EPA mode. Although FIG. 8C illustrates the electronic device 101 in the unfolded state, this is only for convenience of explanation, and a state of the electronic device 101 operating in the second mode may be understood as the folded state. According to an embodiment, the electronic device 101 may operate in the EPA mode in the folded state. In the folded state, the dual IFA may be used to use a ground current in a minor axis direction. In addition, the electronic device 101 may use the dual IFA according to EPA in order to obtain a high radiation efficiency. The electronic device 101 may have a structure for the dual IFA at each of the upper end and the lower end. The electronic device 101 may control at least one switching circuit (e.g., the first switching circuit 741, the second switching circuit 742, the third switching circuit 743, and/or the fourth switching circuit 744) so as to have a structure for the dual IFA at each of the upper end and the lower end.

For example, the first switching circuit 741 may connect a capacitor 873 between the fourth conductive portion 814 and the path 832 connected to the third conductive portion 813. The second switching circuit 742 may be connected to a ground (e.g., ground layer of the PCB, support member, or bracket). The second switching circuit 742 may connect a point 845 (e.g., grounding point) of the third conductive portion 813 and the ground through a line 882. The third switching circuit 743 may be connected to a ground (e.g., ground layer of the PCB, support member, or bracket). The third switching circuit 743 may connect a point 848 (e.g., a grounding point) of the fourth conductive portion 814 and the ground through a line 884. For example, the fourth switching circuit 744 may connect the capacitor 853 between the second conductive portion 812 and the path 831 connected to the first conductive portion 811. The capacitor 853 may be a portion of components of the fourth switching circuit 744.

According to an embodiment, conductive portions and non-conductive portions of the electronic device 101 may be aligned for the EPA mode. For example, the first non-conductive portion 821 and the second non-conductive portion 822 may be aligned in the folded state. The electronic device 101 may distribute the input signal 410 through a divider 885 (e.g., the power distribution circuitry 420). The electronic device 101 may include phase control circuitry 890 (e.g., the phase control circuitry 430) to compensate for a phase difference according to a distance difference between two antennas (e.g., the dual IFA at the upper end and the dual IFA at the lower end). FIG. 8C illustrates an example in which the phase control circuitry 890 is disposed only on a signal path to the dual IFA at the upper end, but the embodiments of the disclosure are not limited thereto. For example, in order to reduce a phase difference between two antennas, phase control circuitry may be disposed in the second transmission path 612, in addition to the phase control circuitry 890. For another example, phase control circuitry may not be disposed in the first transmission path 611, and may be disposed in the second transmission path 612. According to an embodiment, in the folded state of the electronic device 101, the coupling between two antennas may be reduced by adjusting phases of signals connected to the dual IFA at the upper end and the dual IFA at the lower end. For example, in a case that radiation characteristics of the dual IFA disposed at the upper end and the dual IFA disposed at the lower end are the same, the phase may be set so that a signal of the same phase may be transmitted to the upper/lower antennas. In a case that radiation efficiency characteristics of the dual IFA positioned at the upper end and the dual IFA located at the lower end are different due to the adjacent antenna, the phase may be adjusted to compensate for a difference in the characteristics.

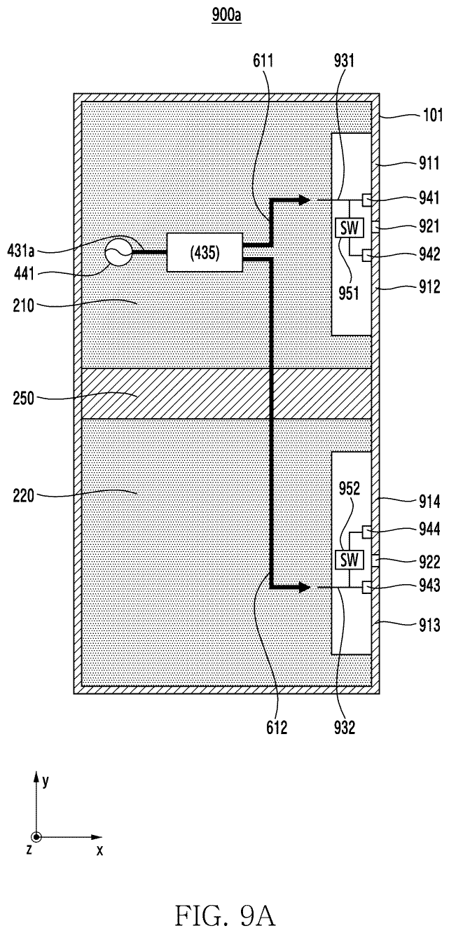

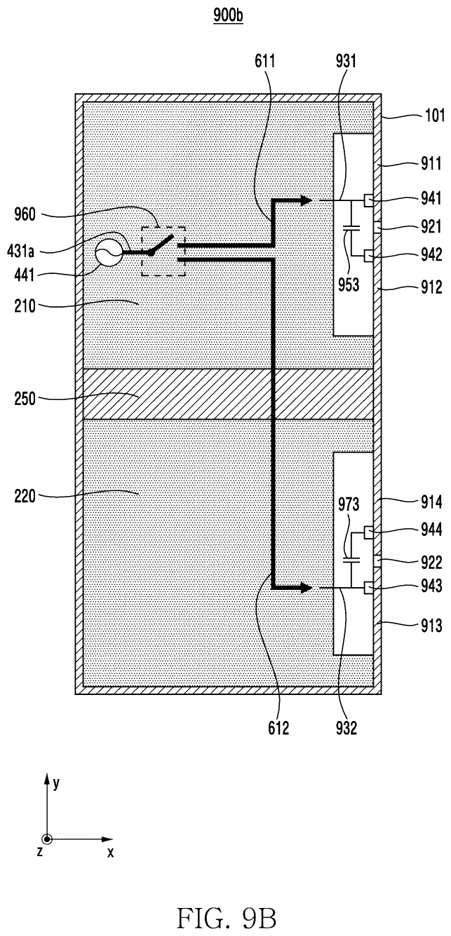

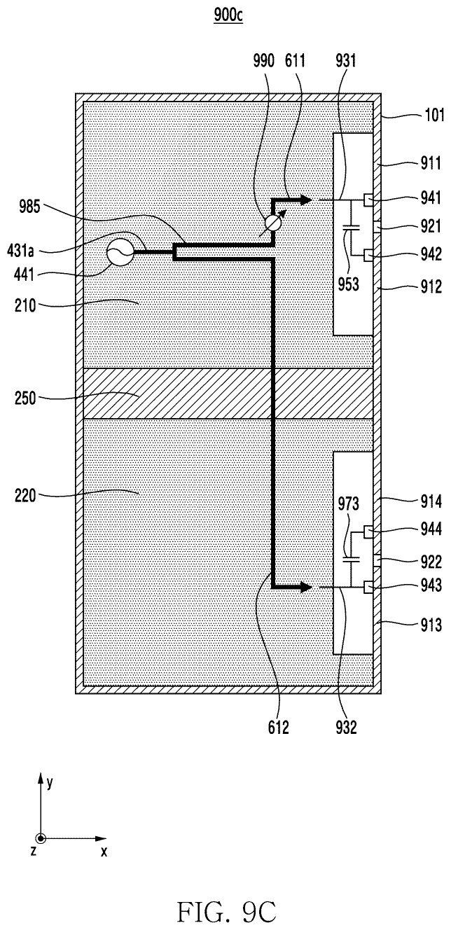

FIGS. 9A to 9C illustrate an example of a foldable-type electronic device (e.g., the electronic device 101) including a switching circuit for a dual IFA according to various embodiments of the disclosure. The same reference number may be used for the same or similar descriptions.

Referring to FIG. 9A, an example 900a illustrates components of the electronic device 101. The electronic device 101 may include a first housing part 210, a second housing part 220, and a hinge structure 250. The electronic device 101 may include a plurality of conductive portions and a plurality of non-conductive portions. The plurality of conductive portions may be visible from the outside as a portion of a metal frame of the electronic device 101. For example, the plurality of conductive portions may include a first conductive portion 911, a second conductive portion 912, a third conductive portion 913, and a fourth conductive portion 914. The first housing part 210 may include the first conductive portion 911 and the second conductive portion 912. The second housing part 220 may include the third conductive portion 913 and the fourth conductive portion 914. The plurality of non-conductive portions may be visible from the outside as an injection-molded portion in the electronic device 101. For example, the plurality of non-conductive portions may include a first non-conductive portion 921 and a second non-conductive portion 922. The first housing part 210 may include the first non-conductive portion 921. The second housing part 220 may include the second non-conductive portion 922. The first conductive portion 911 may extend from an area of a metal frame of the first housing part 210. The second conductive portion 912 may extend from another area of the metal frame of the first housing part 210. The first non-conductive portion 921 may be disposed between the first conductive portion 911 and the second conductive portion 912. The third conductive portion 913 may extend from an area of a metal frame of the second housing part 220. The fourth conductive portion 914 may extend from another area of the metal frame of the second housing part 220. The second non-conductive portion 922 may be disposed between the third conductive portion 913 and the fourth conductive portion 914.

The electronic device 101 may include wireless communication circuitry 441 (e.g., the communication module 190, the first wireless communication circuitry 441, the second wireless communication circuitry 442, the third wireless communication circuitry 443, or the fourth wireless communication circuitry 444). The input signal 410 from the wireless communication circuitry may be distributed through the signal distribution circuitry 435. The input signal 410 may be transmitted to at least one of a first antenna 491 or a second antenna 492. For example, the input signal 410 may be transmitted to the first antenna 491 through a first transmission path 611. For example, the input signal 410 may be transmitted to the second antenna 492 through a second transmission path 612. The first antenna 491 may be a dual IFA disposed on a side (e.g., a surface facing the (+) x-axis) of the first housing part 210. The second antenna 492 may be a dual IFA disposed on a side (e.g., a surface facing the (+) x-axis) of the second housing part 220.

According to an embodiment, the electronic device 101 may include a connection structure for a dual IFA disposed on a side surface of the first housing part 210. The first conductive portion 911 and the second conductive portion 912 may be used as radiators for the dual IFA. The first conductive portion 911 may be connected to the signal distribution circuitry 435 through the first transmission path 611. As a portion of the first transmission path 611, a path 931 connected to the first conductive portion 911 may be connected to the first switching circuit 951. A point 941 of the first conductive portion 911 may be connected to the path 931 on a PCB (not shown) through a connection member (e.g., C-clip, conductive pattern, or electrical material). According to an embodiment, the first switching circuit 951 may be controlled to connect the path 931 connected to the first conductive portion 911 and the second conductive portion 912 with a capacitor. A point 942 of the second conductive portion 912 may be connected to the first switching circuit 951 on a PCB (not shown) through a connection member (e.g., C-clip, conductive pattern, or electrical material). The path 931 connecting the first conductive portion 911 may be understood as a portion of the first transmission path 611.

According to an embodiment, the electronic device 101 may include a connection structure for a dual IFA disposed on a side surface of the second housing part 220. The third conductive portion 913 may be connected to the signal distribution circuitry 435 through the second transmission path 612. As a portion of the second transmission path 612, a path 932 connected to the third conductive portion 913 may be connected to second switching circuit 952. A point 943 of the third conductive portion 913 may be connected to the path 932 on a PCB (not shown) through a connection member (e.g., C-clip, conductive pattern, or electrical material). According to an embodiment, the second switching circuit 952 may be controlled to connect the fourth conductive portion 914 and the path 932 connected to the third conductive portion 913 with a capacitor. According to an embodiment, the second switching circuit 952 may be controlled to short the fourth conductive portion 914 and the path 932 connected to the third conductive portion 913. A point 944 of the fourth conductive portion 914 may be connected to the second switching circuit 952 on a PCB (not shown) through a connection member (e.g., C-clip, conductive pattern, or electrical material). For example, the second switching circuit 952 may be controlled to connect the path 932 and the fourth conductive portion 914 to a line (e.g., the transmission line 794) without an element. In this case, signals fed through the path 932 may be transmitted to the third conductive portion 913 and the fourth conductive portion 914, respectively. The third conductive portion 913 and the fourth conductive portion 914 may be used as radiators of the dual IFA.

Referring to FIG. 9B, an example 900b illustrates an antenna connection structure of a first mode (e.g., selection mode). According to an embodiment, the electronic device 101 may operate in the selection mode. The electronic device 101 may operate in the selection mode in the unfolded state.

The electronic device 101 may use a dual IFA (e.g., the first conductive portion 911 or the second conductive portion 912) equipped at a side of the first housing part 210, or a dual IFA (e.g., the third conductive portion 913 or the fourth conductive portion 914) equipped at a side of the second housing part 220.

In an embodiment, when a user of the electronic device 101 grips a portion of the second housing part 220 in the unfolded state of the electronic device 101, a radiation gain of the dual IFA of the second housing part 220 may be reduced. The electronic device 101 may perform antenna switching. For example, a switch 960 in the signal distribution circuitry 435 may be controlled to connect wireless communication circuitry (e.g., the communication module 190, the first wireless communication circuitry 441, the second wireless communication circuitry 442, the third wireless communication circuitry 443, or the fourth wireless communication circuitry 444) to the first transmission path 611 from among the first transmission path 611 and the second transmission path 612. In an embodiment, in the unfolded state of the electronic device 101, the electronic device 101 may transmit signals through the dual IFA (e.g., the first conductive portion 911 or the second conductive portion 912) equipped at the upper end.

Referring to FIG. 9C, an example 900c illustrates an antenna connection structure of a second mode (e.g., EPA mode). According to an embodiment, the electronic device 101 may operate in the EPA mode. Although FIG. 9C illustrates the electronic device 101 in the unfolded state, this is only for convenience of explanation, and a state of the electronic device 101 operating in the second mode may be understood as the folded state. According to an embodiment, the electronic device 101 may operate in the EPA mode in the folded state. In the folded state, a dual IFA may be used to use a ground current in a minor axis direction. In addition, the electronic device 101 may use the dual IFA according to EPA in order to obtain a high radiation efficiency. The electronic device 101 may have a structure for the dual IFA at each of a side (e.g., a surface facing the (+) x-axis direction) of the first housing part 210 and a side (e.g., a surface facing the (+) x-axis direction) of the second housing part 220. The electronic device 101 may control at least one switching circuit (e.g., the first switching circuit 951 and/or the second switching circuit 952) so as to have a structure for the dual IFA at each of a side (e.g., a surface facing the (+) x-axis direction) of the first housing part 210 and a side (e.g., a surface facing the (+) x-axis direction) of the second housing part 220. For example, the first switching circuit 951 may connect a capacitor 953 between the path 931 connected to the first conductive portion 911 and the second conductive portion 912. The second switching circuit 952 may connect a capacitor 973 between the path 932 connected to the third conductive portion 913 and the fourth conductive portion 914.

According to an embodiment, conductive portions and non-conductive portions of the electronic device 101 may be aligned for the EPA mode. For example, the first non-conductive portion 921 and the second non-conductive portion 922 may be aligned in the folded state. The electronic device 101 may distribute the input signal 410 through a divider 985 (e.g., the power distribution circuitry 420). The electronic device 101 may include phase control circuitry 990 (e.g., the phase control circuitry 430) to compensate for a phase difference according to a distance difference between two antennas (e.g., the dual IFA of the upper end and the dual IFA of the lower end). FIG. 9C illustrates an example in which the phase control circuitry 990 is disposed only on a signal path to the dual IFA of the upper end, but embodiments of the disclosure are not limited thereto. For example, in order to reduce the phase difference between two antennas, phase control circuitry may be disposed in the second transmission path 612, in addition to the phase control circuitry 990. For another example, phase control circuitry may not be disposed at the first transmission path 611, and may be disposed at the second transmission path 612. According to an embodiment, the coupling between two antennas may be reduced by adjusting phases of signals connected to the dual IFA of the first housing part 210 and the dual IFA of the second housing part 220 in the folded state of the electronic device 101. As an example, if radiation characteristics of the dual IFA disposed in the first housing part 210 and the dual IFA disposed in the second housing part 220 are the same, the phase may be set so that a signal of the same phase may be transmitted to the upper/lower antenna.

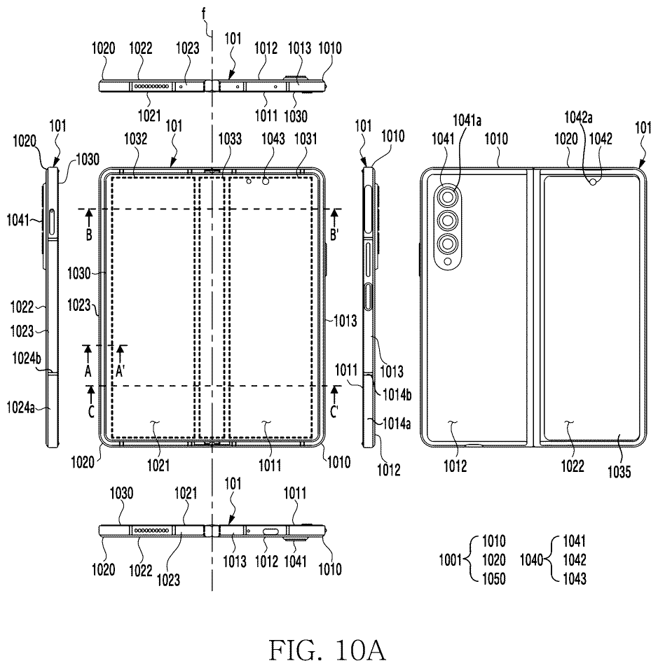

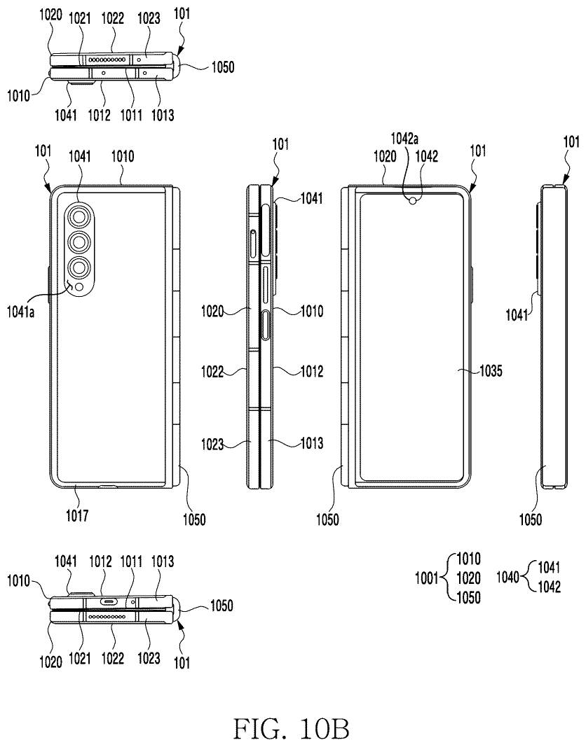

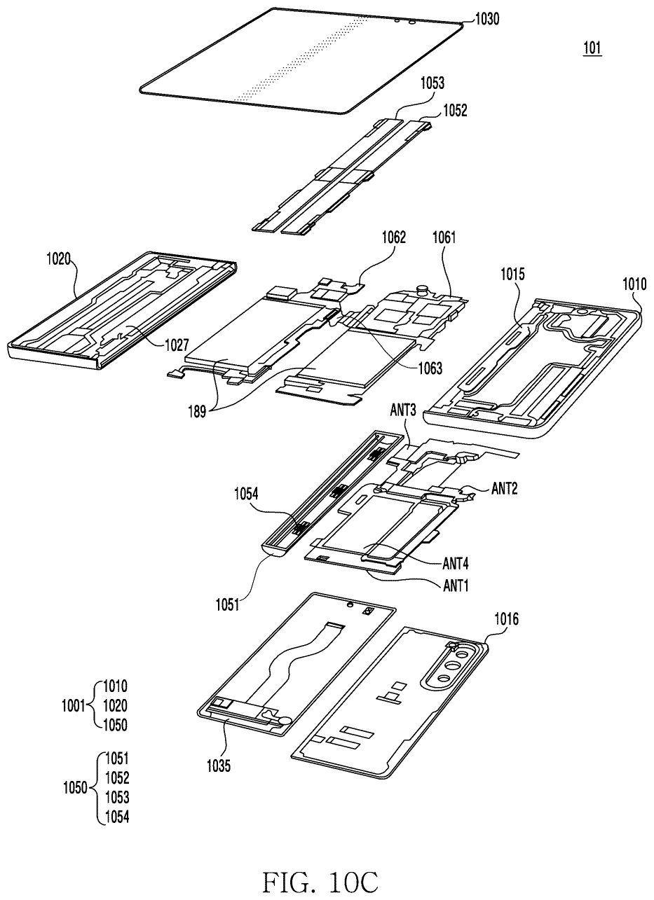

FIGS. 10A, 10B, and 10C illustrate examples of a foldable-type electronic device according to various embodiments of the disclosure. FIG. 10A illustrates an example of an unfolded state of an exemplary foldable electronic device. FIG. 10B illustrates an example of a folded state of an exemplary foldable electronic device. FIG. 10C is an exploded view of an exemplary foldable electronic device.

Referring to FIGS. 10A, 10B, and 10C, a foldable electronic device (e.g., the electronic device 101 of FIG. 1) may include a housing 1001, a flexible display 1030, (e.g., the display module 160 of FIG. 1), and at least one camera 1040.

For example, the housing 1001 may form an exterior of the foldable electronic device 101. For example, the housing 1001, which is a physical exterior of the foldable electronic device 101 to be exposed to the outside, may surround components that are disposed inside the foldable electronic device 101 and are not exposed to the outside. For example, the housing 1001 may include a first housing part 1010, a second housing part 1020, and a hinge structure 1050.

For example, the first housing part 1010 may include a first surface 1011, a second surface 1012 opposite the first surface 1011, and a first side surface 1013 surrounding at least a portion of the first surface 1011 and the second surface 1012. For example, the first surface 1011 may be referred to as a front surface of the first housing part 1010, and the second surface 1012 may be referred to as a rear surface of the first housing part 1010. The first side surface 1013 may be connected to a periphery of the first surface 1011 and a periphery of the second surface 1012. The first surface 1011, the second surface 1012, and the first side surface 1013 may form an inner space of the first housing part 1010. For example, at least one component may be disposed in a space surrounded by the first surface 1011, the second surface 1012, and the first side surface 1013.

For example, the second housing part 1020 may include a third surface 1021, a fourth surface 1022 opposite the third surface 1021, and a second side surface 1023 surrounding at least a portion of the third surface 1021 and the fourth surface 1022. For example, the third surface 1021 may be referred to as a front surface of the second housing part 1020, and the fourth surface 1022 may be referred to as a rear surface of the second housing part 1020. The second side surface 1023 may be connected to a periphery of the third surface 1021 and a periphery of the fourth surface 1022. The third surface 1021, the fourth surface 1022, and the second side surface 1023 may form an inner space of the second housing part 1020. For example, at least one component may be disposed in a space surrounded by the third surface 1021, the fourth surface 1022, and the second side surface 1023. As a non-limiting example, the first housing part 1010 and/or the second housing part 1020 may include a bezel area (e.g., area 1017).

For example, the flexible display 1030 may be configured to display visual information. For example, the flexible display 1030 may include a display area including a plurality of pixels. For example, an active area may be referred to as an active area displaying visual information. For example, the flexible display 1030 may form at least a portion of the front surface of the housing 1001. For example, the flexible display 1030 may at least partially form the first surface 1011 and the third surface 1021.

For example, the flexible display 1030 may include a first display area 1031 forming at least a portion of the first surface 1011 of the first housing part 1010, a second display area 1032 forming at least a portion of the third surface 1021 of the second housing part 1020, and a third display area 1033 disposed between the first display area 1031 and the second display area 1032. For example, the first display area 1031, the second display area 1032, and the third display area 1033 may at least partially form a front surface of the housing 1001. For example, the foldable electronic device 101 may further include a sub-display 1035 distinguished from the flexible display 1030. The sub-display 1035 may be disposed on the fourth surface 1022 of the second housing part 1020. The sub-display 1035 may be referred to as a cover display.

For example, the at least one camera 1040 may be configured to obtain an image based on receiving light from an external subject of the foldable electronic device 101. For example, the at least one camera 1040 may include a first cameras 1041, a second cameras 1042, or a third cameras 1043. For example, the first cameras 1041 may be disposed within the first housing part 1010. For example, the first housing part 1010 may include at least one opening 1041a overlapped to the first cameras 1041 when the foldable-type electronic device 101 is viewed from above. The first cameras 1041 may obtain an image based on receiving light from the outside of the foldable electronic device 101 through the at least one opening 1041a.

For example, the second camera 1042 may be disposed within the second housing part 1020. The second housing part 1020 may include at least one opening 1042a overlapped to the second camera 1042 when the foldable electronic device 101 is viewed from above. The second camera 1042 may obtain an image based on receiving light from the outside of the foldable electronic device 101 through the at least one opening 1042a.

For example, the third camera 1043 may be disposed within the first housing part 1010. For example, the first display area 1031 of the flexible display 1030 may include at least one opening overlapped to the third camera 1043 when the flexible display 1030 is viewed from above. The third camera 1043 may obtain an image based on receiving light from the outside of the flexible display 1030 through the at least one opening.

For example, the second camera 1042 and the third camera 1043 may be disposed below the flexible display 1030 (e.g., the (+) z-axis direction). For example, the second camera 1042 and/or the third camera 1043 may include an under display camera (UDC) and/or a punch hole camera.

For example, the first housing part 1010 and the second housing part 1020 may be rotatably coupled. For example, the second housing part 1020 may be rotatably coupled to the first housing part 1010 through the hinge structure 1050.

For example, the hinge structure 1050 may rotatably connect the first housing part 1010 and the second housing part 1020. The hinge structure 1050 may be disposed between the first housing part 1010 and the second housing part 1020 of the foldable electronic device 101 so that the foldable electronic device 101 may be foldable. The hinge structure 1050 may enable the foldable electronic device 101 to be changed from an unfolded state to a folded state. The hinge structure 1050 may enable the foldable electronic device 101 to be changed from the folded state to the unfolded state. The hinge structure 1050 may maintain the foldable electronic device 101 in an intermediate state between the unfolded state and the folded state.

For example, the unfolded state may be referred to as a state in which a first direction in which the first display area 1030a faces and a second direction in which the second display area 1030b faces are the same. For example, the folded state may be referred to as a state in which the first direction is opposite to the second direction. When the foldable electronic device 101 is in the folded state, the first housing part 1010 and the second housing part 1020 may be stacked or overlapped.

For example, when the foldable electronic device 101 is in the folded state and the intermediate state, the first direction and the second direction may be different. For example, when the foldable electronic device 101 is in the folded state, the first direction and the second direction may be opposite to each other. For example, when the foldable electronic device 101 is in the intermediate state, the first direction may have an inclination (e.g., an angle between 0 and 180 degrees) with respect to the second direction.

For example, the foldable electronic device 101 may be rotatable based on a folding axis f. The folding axis f may be referred to as a virtual line extending along a direction parallel to a longitudinal direction of the foldable electronic device 101 (e.g., y-axis) or a direction parallel to a width direction of the foldable electronic device 101 (e.g., x-axis).

For example, the foldable electronic device 101 may include at least one conductive portion 1014a and 224a, and at least one non-conductive portion 1014b and 2024b included in a first side surface 1013 and/or a second side surface 1023. For example, at least one conductive portion 1014a and 2024a may be separated from other conductive portions within the first side surface 1013 and/or the second side surface 1023, by contacting the at least one non-conductive portion 1014b and 2024b. The at least one conductive portion 1014a and 2204a may operate as an antenna radiator to be used for communication with an external electronic device.

Referring to FIG. 10C, the hinge structure 1050 may include a hinge cover 1051, a first hinge plate 1052, a second hinge plate 1053, and a hinge module 1054. The hinge cover 1051 may surround internal components of the hinge structure 1050 and form an outer surface of the hinge structure 1050. For example, when the foldable electronic device 101 is in the folded state, at least a portion of the hinge cover 1051 may be exposed to the outside of the foldable electronic device 101 through a space between the first housing part 1010 and the second housing part 1020. According to another embodiment, when the foldable electronic device 101 is in the unfolded state, the hinge cover 1051 may be covered by the first housing part 1010 and the second housing part 1020 and may not be exposed to the outside of the foldable electronic device 101.

For example, the first hinge plate 1052 and the second hinge plate 1053 may rotatably connect the first housing part 1010 and the second housing part 1020, by being operably coupled to the first housing part 1010 and the second housing part 1020, respectively. For example, the first hinge plate 1052 may be operably coupled to a first frame 1015 of the first housing part 1010, and the second hinge plate 1053 may be operably coupled to a second frame 1027 of the second housing part 1020. As the first hinge plate 1052 and the second hinge plate 1053 are operably coupled to the first frame 1015 and the second frame 1027, respectively, the first housing part 1010 and the second housing part 1020 may be rotatable according to a rotation of the first hinge plate 1052 and the second hinge plate 1053.

The hinge module 1054 may rotate the first hinge plate 1052 and the second hinge plate 1053. For example, the hinge module 1054 may rotate the first hinge plate 1052 and the second hinge plate 1053 with respect to a folding axis f, by including rotatable gears engaged with each other.

For example, the first housing part 1010 may include the first frame 1015 and a rear cover 1016. The first frame 1015 may be disposed inside the first housing part 1010 and may support at least one component disposed within the first housing part 1010. The rear cover 1016 may at least partially form the second surface 1012 of the first housing part 1010. For example, the second housing part 1020 may include the second frame 1027. The second frame 1027 may be disposed inside the second housing part 1020 and may support at least one component disposed in the second housing part 1020. For example, the sub-display 1035 may be disposed below the second frame 1027 (e.g., the (+) z-axis direction).

In addition to the at least one camera 1040 described above, the exemplary foldable electronic device 101 may include a plurality of electronic components for implementing various functions. For example, the foldable electronic device 101 may include a first printed circuit board 1061, a second printed circuit board 1062, a connection structure 1063 (e.g., the flexible printed circuit board), and/or a battery 189. The above-described electronic components are merely exemplary and are not limited thereto.

For example, the first printed circuit board 1061 and the second printed circuit board 1062 may provide an electrical connection of components in the foldable electronic device 101, respectively. For example, the first printed circuit board 1061 may be disposed within the first housing part 1010, and the second printed circuit board 1062 may be disposed within the second housing part 1020. The first printed circuit board 1061 may provide an electrical connection between electronic components disposed in the first housing part 1010. The second printed circuit board 1062 may provide an electrical connection between electronic components disposed in the second housing part 1020. The connection structure 1063 may electrically connect the first printed circuit board 1061 and the second printed circuit board 1062. For example, the connection structure 1063 may extend from the first printed circuit board 1061 to the second printed circuit board 1062 across the hinge structure 1050. For example, the connection structure 1063 may at least partially overlap the hinge structure 1050.

For example, the battery 189, which is a device for supplying power to at least one component of the foldable electronic device 101, may include, for example, a non-rechargeable primary battery and/or a rechargeable secondary battery.

For example, the foldable electronic device 101 may include a plurality of antennas ANT1, ANT2, ANT3, and ANT4 to be used for communication with an external electronic device. For example, the foldable electronic device 101 may include a main antenna (ANT1), a sub-antenna (ANT2), an ultra-wide band (UWB) antenna (ANT3), and/or an antenna for short-range wireless communication (ANT4). However, it is not limited thereto.

Hereinafter, one or more components to be described later with reference to the drawings may be implemented together with the components of the foldable electronic device 101 described with reference to FIGS. 10A, 10B, and 10C. The same reference numerals are assigned to the same components as the above-described components, and overlapping descriptions may be omitted.

In the disclosure, relative terms such as “above” and “under” may be used to describe a relative position between components. For example, when the foldable electronic device 101 illustrated in the drawings is flipped over, “above” and “under” may be interchanged.

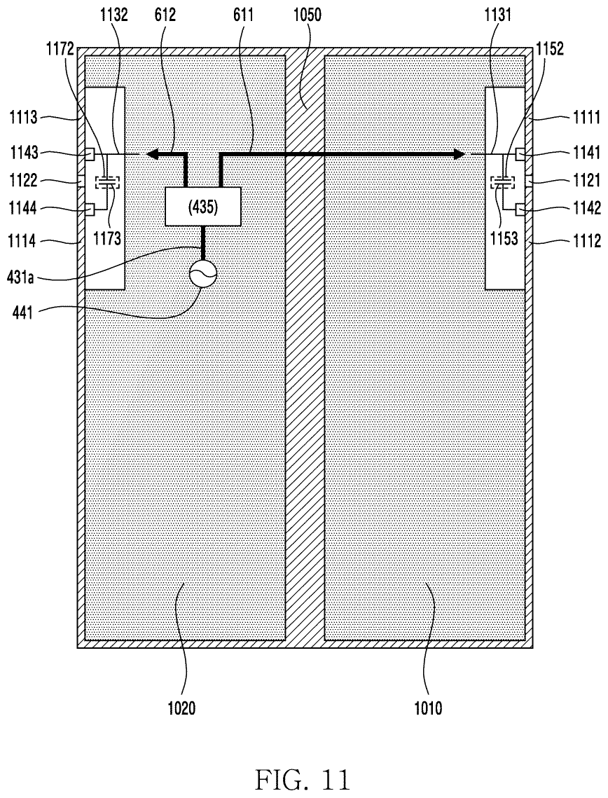

FIG. 11 illustrates an example of a foldable-type electronic device (e.g., the electronic device 101) including a switching circuit for a dual IFA according to an embodiment of the disclosure. The same reference number may be used for the same or similar descriptions.

Referring to FIG. 11, the electronic device 101 may include a first housing part 1010, a second housing part 1020, and a hinge structure 1050. The first housing part 1010 may include a first conductive portion 1111, a second conductive portion 1112, and a first non-conductive portion 1121 disposed between the first conductive portion 1111 and the second conductive portion 1112. The first conductive portion 1111 and the second conductive portion 1112 may be used as a radiator for the dual IFA. A path 1131 of the first conductive portion 1111 may be connected to the second conductive portion 1112 through a first switching circuit 1152 (e.g., a circuit including a capacitor 1153). A point 1141 of the first conductive portion 1111 may be connected to the path 1131 on a PCB (not shown) through a connection member (e.g., C-clip, conductive pattern, or electrical material). A point 1142 of the second conductive portion 1112 may be connected to the first switching circuit 1152 on the PCB (not shown) through a connection member (e.g., C-clip, conductive pattern, or electrical material). For the first switching circuit 1152, the descriptions of FIG. 7D may be referenced. In order to use the first conductive portion 1111 and the second conductive portion 1112 as a radiator for the dual IFA, the first switching circuit 1152 may connect the path 1131 and the second conductive portion 1112 through the capacitor 1153. The second housing part 1020 may include a third conductive portion 1113, a fourth conductive portion 1114, and a second non-conductive portion 1122 disposed between the third conductive portion 1113 and the fourth conductive portion 1114. The third conductive portion 1113 and the fourth conductive portion 1114 may be used as a radiator for the dual IFA. A path 1132 of the third conductive portion 1113 may be connected to the fourth conductive portion 1114 through a second switching circuit 1172 (e.g., a circuit including a capacitor 1173). A point 1143 of the third conductive portion 1113 may be connected to the path 1132 on a PCB (not shown) through a connection member (e.g., C-clip, conductive pattern, or electrical material). A point 1144 of the fourth conductive portion 1114 may be connected to the second switching circuit 1172 on the PCB (not shown) through a connection member (e.g., C-clip, conductive pattern, or electrical material). For the second switching circuit 1172, the descriptions of FIG. 7D may be referenced. In order to use the third conductive portion 1113 and the fourth conductive portion 1114 as a radiator for the dual IFA, the second switching circuit 1172 may connect the path 1132 and the fourth conductive portion 1114 through the capacitor 1173.

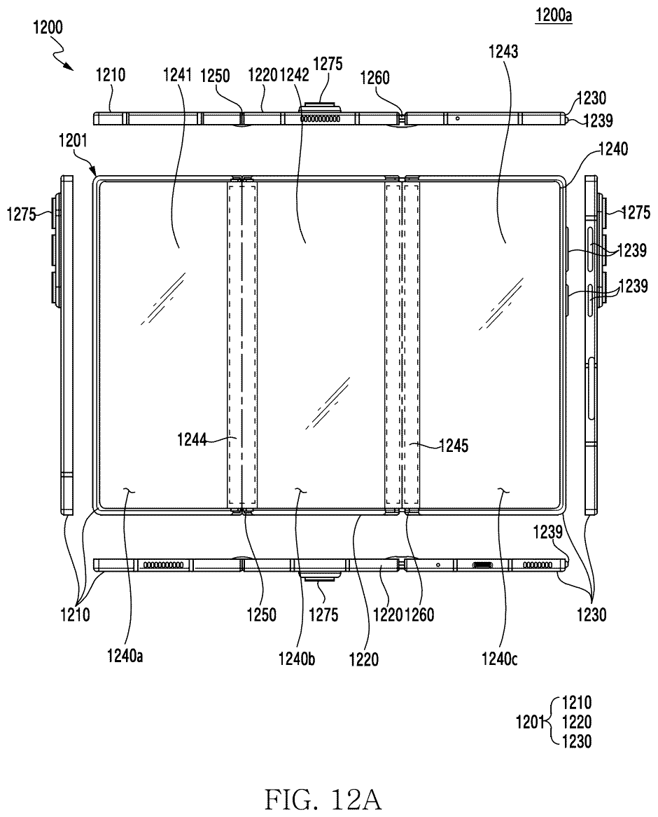

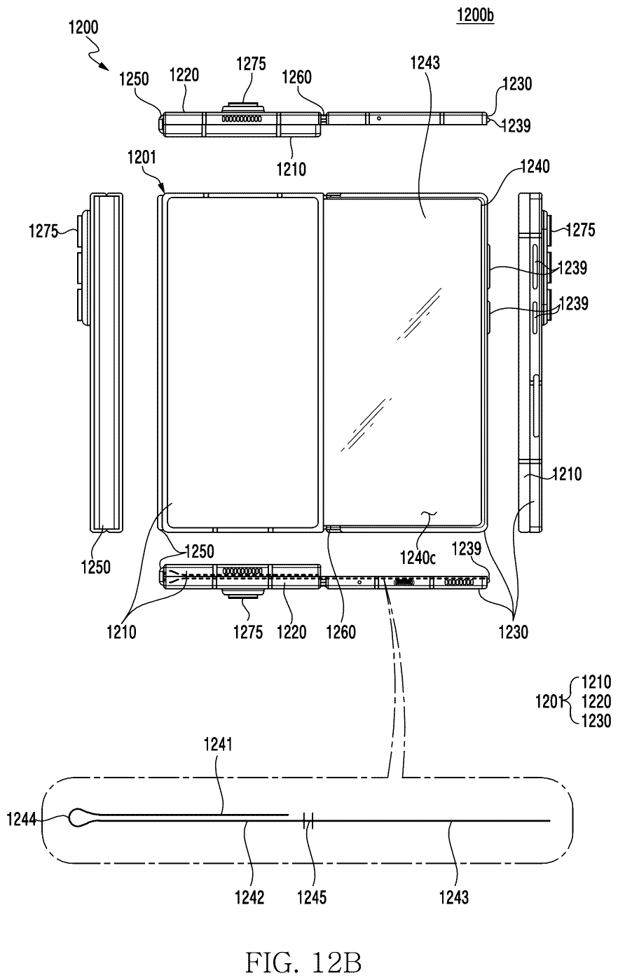

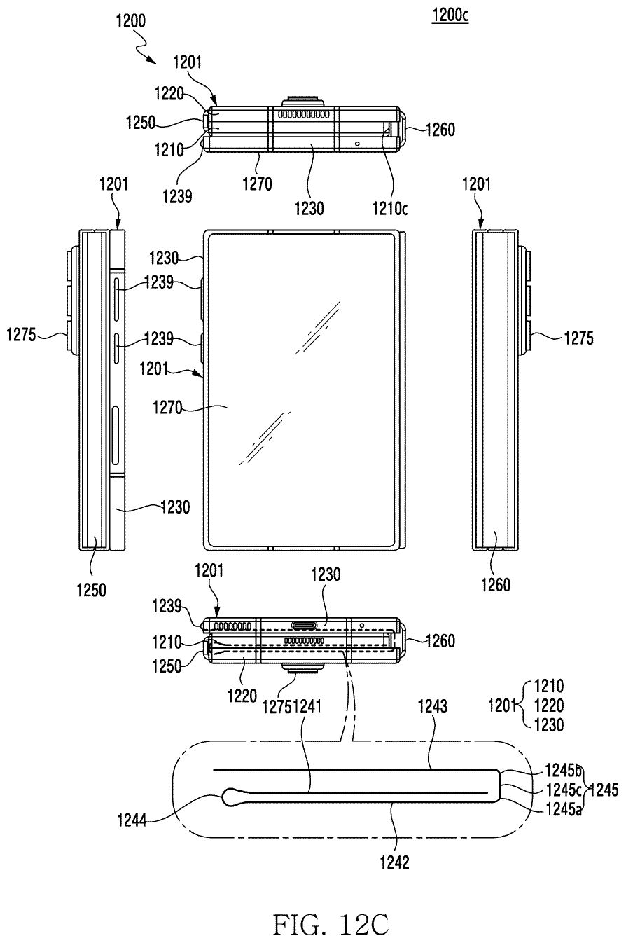

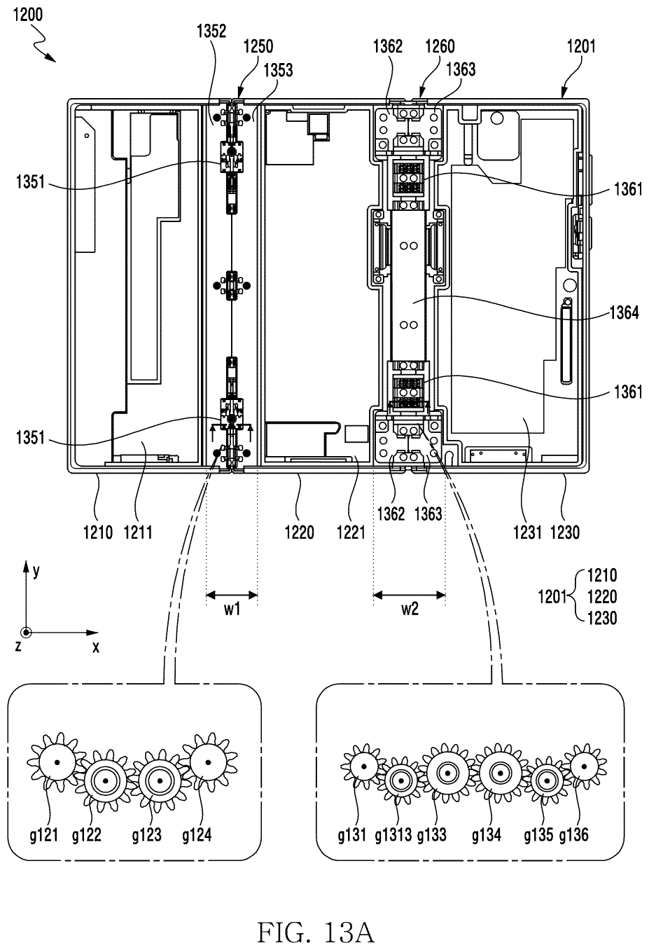

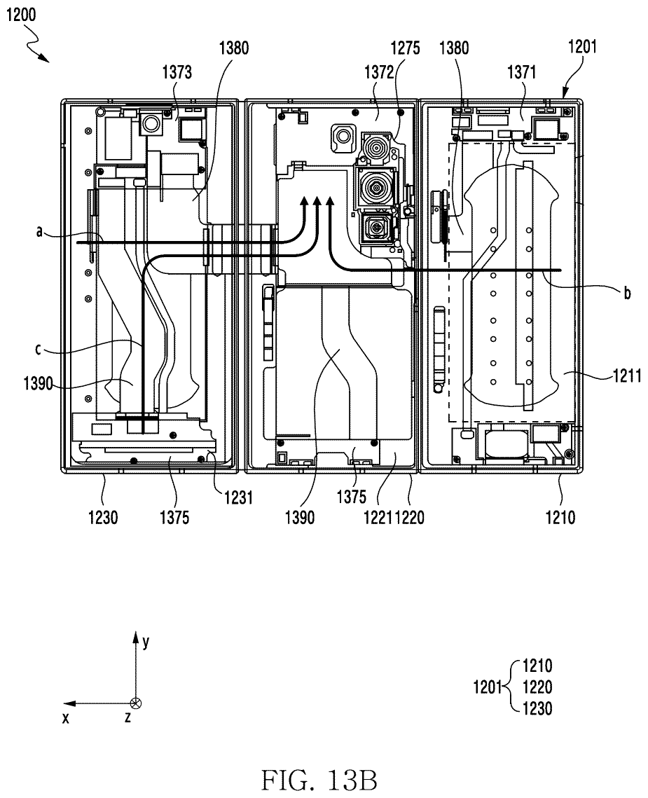

FIGS. 12A, 12B, 12C, 13A, and 13B illustrate an example of a foldable-type electronic device (e.g., the electronic device 101) according to various embodiments of the disclosure. FIG. 12A illustrates an example of a first state of an electronic device. FIG. 12B illustrates an example of a second state of an electronic device. FIG. 12C illustrates an example of a third state of an electronic device. An electronic device 1200 may be referred to as the electronic device 101.

Referring to FIGS. 12A, 12B, and 12C, the electronic device 1200 may include a housing structure 1201, a flexible display 1240, a first hinge structure 1250, a second hinge structure 1260, and a display 1270. The first housing structure 1201 may include a first housing part 1210, a second housing part 1220, and a third housing part 1230.

The first housing part 1210 may be rotatably coupled to the second housing part 1220 by the first hinge structure 1250. The second housing part 1220 and the first housing part 1210 may be rotated with respect to the first hinge structure 1250. While the first housing part 1210 rotates with respect to the first hinge structure 1250, the second housing part 1220 may rotate with respect to the first hinge structure 1250. For example, when the second housing part 1220 and the first housing part 1210 are rotated with respect to the first hinge structure 1250, an angular displacement of the second housing part 1220 may be substantially equal to an angular displacement of the first housing part 1210.

The third housing part 1230 may be rotatably coupled to the second housing part 1220 by the second hinge structure 1260. The second housing part 1220 and the third housing part 1230 may be rotated with respect to the second hinge structure 1260. While the second housing part 1220 is rotated with respect to the second hinge structure 1260, the third housing part 1230 may be rotated with respect to the second hinge structure 1260. For example, when the second housing part 1220 and the third housing part 1230 are rotated with respect to the second hinge structure 1260, the angular displacement (or angular change) of the second housing part 1220 may be substantially equal to the angular displacement of the third housing part 1230.

The first hinge structure 1250 and the second hinge structure 1260 may change a state of the electronic device. The first hinge structure 1250 and the second hinge structure 1260 may provide (or enable) a first state 1200a of the electronic device 1200 (or a first state 1200a of the housing structure 1201). The first state 1200a of the electronic device 1200 (or the first state 1200a of the housing structure 1201) may be described as an unfolded state (or unfolding state) of the electronic device 1200 (or the housing structure 1201). In the first state 1200a, a front surface of the first housing part 1210, a front surface of the second housing part 1220, and a front surface of the third housing part 1230 may define a front surface of the electronic device 1200. In the first state 1200a, the front surface of the first housing part 1210, the front surface of the second housing part 1220, and the front surface of the third housing part 1230 may face the same direction. In the first state 1200a, the electronic device 1200 may provide a large display region of the flexible display 1240 to the user.

The first hinge structure 1250 and the second hinge structure 1260 may provide a second state 1200b of the electronic device 1200. The second state 1200b of the electronic device 1200 may be described as a state in which the electronic device 1200 is partially folded and partially unfolded (or a single folding state or a half folding state). For example, in the second state 1200b, the front surface of the second housing part 1220 and the front surface of the third housing part 1230 may face the same direction, and the front surface of the first housing part 1210 and the front surface of the second housing part 1220 may face opposite directions. For example, in the second state 1200b, the first housing part 1210 and the second housing part 1220 may be folded, and the second housing part 1220 and the third housing part 1230 may be unfolded. In the second state 1200b, the electronic device 1200 may transfer visual information through a portion (e.g., a third display region 1240c) of the flexible display 1240.

The electronic device 1200 may be changed from the first state 1200a to the third state 1200c through the second state 1200b. The electronic device 1200 may be changed from the first state 1200a, which is an unfolded state, to the second state 1200b, which is a partially unfolded state. For example, the electronic device 1200 may be changed from the first state 1200a in which the first housing part 1210, the second housing part 1220, and the third housing part 1230 face the same direction, to the second state 1200b in which the front surface of the first housing part 1210 faces the front surface of the second housing part 1220. The electronic device 1200 may be changed from the second state 1200b, which is partially unfolded, to the third state 1200c, which is folded. For example, when changing from the second state 1200b to the third state 1200c, the folded first housing part 1210 and the second housing part 1220 may be disposed on the third housing part 1230.

The first hinge structure 1250 and the second hinge structure 1260 may provide a third state 1200c of the electronic device 1200 (or a third state 1200c of the housing structure 1201). The third state 1200c of the electronic device 1200 (or the third state 1200c of the housing structure 1201) may be described as a state in which the electronic device 1200 (or the housing structure 1201) is folded (or a folding state or a multi-folding state). In the third state 1200c, the front surface of the first housing part 1210 and the front surface of the second housing part 1220 may face opposite directions, and the front surface of the second housing part 1220 and the front surface of the third housing part 1230 may face opposite directions. In the third state 1200c, the front surface of the first housing part 1210 and the front surface of the third housing part 1230 may face the same direction. For example, in the third state 1200c, the front surface of the second housing part 1220 may face the front surface of the first housing part 1210, and the front surface of the third housing part 1230 may face a rear surface of the first housing part 1210. In the third state 1200c, a rear surface of the second housing part 1220 may be exposed to the outside. The camera 1275 may be disposed on the rear surface of the second housing part 1220. In the third state 1200c, a rear surface of the third housing part 1230 may be exposed to the outside. The display 1270 may be disposed on the rear surface of the third housing part 1230. In the third state 1200c, the electronic device 1200 may provide visual information through the display 1270 that is folded to enhance portability and is disposed on the third housing part 1230 of the electronic device 1200 in the third state 1200c.

The electronic device 1200 may further include a key button 1239. The key button 1239 may be exposed from a structure (e.g., opening) formed on a side surface of the third housing part 1230 and may partially protrude to the outside of the electronic device 1200. The key button 1239 may provide a physical input to processing circuitry inside the electronic device 1200 by a pressure transmitted from the outside. The key button 1239 may not be included in the electronic device 1200 and may be implemented in another form, such as a soft key displayed on the flexible display 1240 or the display 1270.

The key button may be disposed on the side surface of the third housing part 1230 so as to be exposed to the outside in the third state 1200c. As the state of the electronic device 1200 is changed from the third state 1200c to the first state 1200a by a user looking at the display, the key button 1239 disposed in the third housing part 1230 may be moved from the left to the right. For example, referring to FIG. 12A, in the first state 1200a, when the flexible display 1240 is viewed from above, the key button 1239 may be disposed on the right. Referring to FIG. 12B, in the third state 1200c, when the display 1270 is viewed from above, the key button 1239 may be disposed on the left.

The flexible display 1240 may at least partially define a surface of the electronic device 1200. The flexible display 1240 may be partially disposed within the housing structure 1201. The flexible display 1240 may define a front surface of the electronic device 1200. The flexible display 1240 may include a first unbendable portion 1241, a second unbendable portion 1242, a third unbendable portion 1243, a first bendable portion 1244, and a second bendable portion 1245. The first unbendable portion 1241 of the flexible display 1240 may be disposed on the front surface of the first housing part 1210. The second unbendable portion 1242 of the flexible display 1240 may be disposed on the front surface of the second housing part 1220. The third unbendable portion 1243 of the flexible display 1240 may be disposed on the front surface of the third housing part 1230. The first bendable portion 1244 of the flexible display 1240 may be disposed between the first unbendable portion 1241 and the second unbendable portion 1242 of the flexible display 1240. For example, the first bendable portion 1244 of the flexible display 1240 may be disposed on the first hinge structure 1250 connecting the first housing part 1210 and the second housing part 1220. The second bendable portion 1245 of the flexible display 1240 may be disposed between the second unbendable portion 1242 and the third unbendable portion 1243 of the flexible display 1240. For example, the second bendable portion 1245 of the flexible display 1240 may be disposed on the second hinge structure 1260 connecting the second housing part 1220 and the third housing part 1230.

The first hinge structure 1250 and the second hinge structure 1260 may face substantially the same direction as the first unbendable portion 1241 of the flexible display 1240, the second unbendable portion 1242 of the flexible display 1240, and the third unbendable portion 1243 of the flexible display 1240. In the first state 1200a, the first bendable portion 1244 and the second bendable portion 1245 may be disposed in substantially the same horizontal plane as the first unbendable portion 1241, the second unbendable portion 1242, and the third unbendable portion 1243.

The first hinge structure 1250 and the second hinge structure 1260 may provide a second state 1200b of the electronic device 1200. In the second state 1200b, the first unbendable portion 1241 of the flexible display 1240 may face the second unbendable portion 1242 of the flexible display 1240, and the third unbendable portion 1243 of the flexible display 1240 may face the same direction as the second unbendable portion 1242 of the flexible display 1240. For example, the second unbendable portion 1242 and the third unbendable portion 1243 may be disposed in substantially the same horizontal plane.

In the second state 1200b, as the first bendable portion 1244 of the flexible display 1240 is bent by the first hinge structure 1250, the first bendable portion 1244 of the flexible display 1240 may be folded, so that the first unbendable portion 1241 of the flexible display 1240 and the second unbendable portion 1242 of the flexible display 1240 face different directions.

In the second state 1200b, as the second bendable portion 1245 of the flexible display 1240 is maintained in the unfolded state by the second hinge structure 1260, the second bendable portion 1245 of the flexible display 1240 may be unfolded so that the second unbendable portion 1242 of the flexible display 1240 and the third unbendable portion 1243 of the flexible display 1240 face the same direction.

The first hinge structure 1250 and the second hinge structure 1260 may provide a third state 1200c of the electronic device 1200. In the third state 1200c, the second unbendable portion 1242 of the flexible display 1240 may face the first unbendable portion 1241 of the flexible display 1240, and the third unbendable portion 1243 of the flexible display 1240 may face the rear surface of the first housing part 1210.

In the third state 1200c, as the first bendable portion 1244 of the flexible display 1240 is bent by the first hinge structure 1250, the first bendable portion 1244 of the flexible display 1240 may be folded so that the first unbendable portion 1241 of the flexible display 1240 and the second unbendable portion 1242 of the flexible display 1240 face different directions.

In the third state 1200c, the second bendable portion 1245 of the flexible display 1240 is bent by the second hinge structure 1260, the second bendable portion 1245 of the flexible display 1240 may be folded so that the second unbendable portion 1242 of the flexible display 1240 and the third unbendable portion 1243 of the flexible display 1240 face different directions. The second bendable portion 1245 may further include a first deformation portion 1245a, a second deformation portion 1245b, and a planar portion 1245c. The first deformation portion 1245a may be disposed between the planar portion 1245c and the second unbendable portion 1242, and the second deformation portion 1245b may be disposed between the planar portion 1245c and the third unbendable portion 1243. The planar portion 1245c may be disposed between the first deformation portion 1245a and the second deformation portion 1245b. The planar portion 1245c may be supported by a support plate (e.g., the support plate 1364 of FIG. 13A) that is distinct from the hinge plates (e.g., the third hinge plate 1362 and the fourth hinge plate 1363 of FIG. 13A) of the second hinge structure 1260. Regardless of the state of the electronic device 1200, the planar portion 1245c may maintain a planar surface. The first deformation portion 1245a and the second deformation portion 1245b may be unfolded in the first state 1200a and the second state 1200b, and in the third state 1200c, the first deformation portion 1245a and the second deformation portion 1245b may be folded so that the second unbendable portion 1242 and the third unbendable portion 1243 face different directions.

In the third state 1200c, the first housing part 1210 may be disposed between the second housing part 1220 and the third housing part 1230. In the third state 1200c, the second bendable portion 1245 of the flexible display 1240 disposed on the second hinge structure 1260 may partially face the side surface 1210c of the first housing part 1210.

A display region of the flexible display 1240 may include a first display region 1240a, a second display region 1240b, and a third display region 1240c. The display region indicates a region capable of providing visual information from the flexible display 1240. In the first state 1200a, the entire display region of the flexible display 1240 may be viewed from the front surface of the housing structure 1201. For example, in the first state 1200a, the first display region 1240a, the second display region 1240b, and the third display region 1240c of the flexible display 1240 may be visually exposed. The electronic device 1200 may provide, to the user, a large display region including the first display region 1240a, the second display region 1240b, and the third display region 1240c.

In the second state 1200b, the display region of the flexible display 1240 may be partially visible from the front surface of the third housing part 1230. For example, the third unbendable portion 1243 may be visually exposed, and the first display region 1240a and the second display region 1240b may not be visually exposed.

In the third state 1200c, the display region of the flexible display 1240 may not be visible. For example, in the third state 1200c, the first display region 1240a, the second display region 1240b, and the third display region 1240c of the flexible display 1240 may not be visually exposed.

As a non-limiting example, when the flexible display 1240 is used to display a screen in the first state 1200a of the electronic device 1200, the first display region 1240a, the second display region 1240b, and the third display region 1240c of the flexible display 1240 may be activated. As a non-limiting example, in the second state 1200b of the electronic device 1200, when the flexible display 1240 is used to display a screen, the third display region 1240c may be activated, and the first display region 1240a and the second display region 1240b of the flexible display 1240 may be deactivated. As a non-limiting example, in the third state 1200c of the electronic device 1200, the first display region 1240a, the second display region 1240b, and the third display region 1240c of the flexible display 1240 may be deactivated.

As a non-limiting example, when the flexible display 1240 is used to display a screen in the first state 1200a of the electronic device 1200, the first display region 1240a, the second display region 1240b, and the third display region 1240c of the flexible display 1240 may display visual information. As a non-limiting example, in the second state 1200b of the electronic device 1200, when the flexible display 1240 is used to display a screen, the third display region 1240c may provide visual information, and the first display region 1240a and the second display region 1240b of the flexible display 1240 may provide a black image. As a non-limiting example, in the third state 1200c, the first display region 1240a, the second display region 1240b, and the third display region 1240c of the flexible display 1240 may provide a black image.

FIG. 13A is a plan view of an electronic device from which a flexible display is removed. FIG. 13B is a rear view of an electronic device from which a rear cover and a display are removed.

Referring to FIGS. 13A and 13B, the electronic device 1200 may include a first hinge structure 1250 and a second hinge structure 1260. A first width w1 of the first hinge structure 1250 may be narrower than a second width w2 of the second hinge structure 1260. A difference between the first width w1 of the first hinge structure 1250 and the second width w2 of the second hinge structure 1260 may be greater than or equal to a thickness of the first housing part 1210. For example, the second hinge structure 1260 may have the second width w2 wider than the first width w1 so that the first housing part 1210 is disposed between the second housing part 1220 and the third housing part 1230 according to the third state 1200c. The first hinge structure 1250 may be referred to as a narrow hinge structure in terms of having a narrower width than the second hinge structure 1260. The second hinge structure 1260 may be referred to as a wide hinge structure in terms of having a wider width than the first hinge structure 1250.

The first hinge structure 1250 may include a first set of gears 1351, a first hinge plate 1352, and a second hinge plate 1353. The first hinge plate 1352 may be coupled to a first support portion 1211 of the first housing part 1210. The second hinge plate 1353 may be coupled to a second support portion 1221 of the second housing part 1220. Gears g11, g12, g13, and g14 included in the first set of gears 1351 may be configured to rotate the first hinge plate 1352 and the second hinge plate 1353. For example, the gears g11, g12, g13, and g14 included in the first set of gears 1351 may rotate the second hinge plate 1353 (or the second housing part 1220) by linking with a rotation of the first hinge plate 1352 (or the first housing part 1210). After the first hinge plate 1352 (or the first housing part 1210) rotates, the gears g11, g12, g13, and g14 included in the first set of gears 1351 may rotate in accordance with a rotation of the first hinge plate 1352 (or the first housing part 1210). The second hinge plate 1353 (or the second housing part 1220) may rotate by linking with the rotation of the first hinge plate 1352 in accordance with the rotation of the gears g11, g12, g13, and g14 included in the first set of gears 1351. The gears g11, g12, g13, and g14 included in the first set of gears 1351 may include a first gear g11, a second gear g12, a third gear g13, and a fourth gear g14. The first gear g11 may be disposed adjacent to the first hinge plate 1352, and the fourth gear g14 may be disposed adjacent to the second hinge plate 1353. The second gear g12 and the third gear g13 may be disposed between the first gear g11 and the fourth gear g14. The first gear g11, the second gear g12, the third gear g13, and the fourth gear g14 may be sequentially engaged. According to a rotation of the first gear g11 in a first rotation direction (e.g., clockwise), the second gear g12 engaged with the first gear g11 may be rotated in a second rotation direction (e.g., counterclockwise) opposite to the first rotation direction. According to the rotation of the second gear g12 in the second rotation direction, the third gear g13 engaged with the second gear g12 may be rotated in the first rotation direction. The fourth gear g14 may be rotated in the second rotation direction according to the rotation of the third gear g13 in the first rotation direction. As the first gear g11 and the fourth gear g14 rotate in different directions, the first housing part 1210 connected to the first hinge plate 1352 and the second housing part 1220 connected to the second hinge plate 1353 may be folded or unfolded.

The second hinge structure 1260 may include a second set of gears 1361, a third hinge plate 1362, a fourth hinge plate 1363, and a support plate 1364. The third hinge plate 1362 may be coupled to the second support portion 1221 of the second housing part 1220. The fourth hinge plate 1363 may be coupled to a third support portion 1231 of the third housing part 1230. Gears g21, g22, g23, g24, g25, and g26 included in the second set of gears 1361 may be configured to rotate the third hinge plate 1362 and the fourth hinge plate 1363. For example, the gears g21, g22, g23, g24, g25, and g26 included in the second set of gears 1361 may rotate the fourth hinge plate 1363 (or the third housing part 1230) by linking with a rotation of the third hinge plate 1362 (or the second housing part 1220). After the third hinge plate 1362 (or the second housing part 1220) is rotated, the gears g21, g22, g23, g24, g25, and g26 included in the second set of gears 1361 may rotate according to the rotation of the third hinge plate 1362 (or the second housing part 1220). The fourth hinge plate 1363 (or the third housing part 1230) may be rotated by linking with the rotation of the third hinge plate 1362 according to the rotation of the gears g21, g22, g23, g24, g25, and g26 included in the second set of gears 1361.

The gears g21, g22, g23, g24, g25, and g26 included in the second set of gears 1361 may include a first gear g21, a second gear g22, a third gear g23, a fourth gear g24, a fifth gear g25, and a sixth gear g26. The first gear g21 may be disposed adjacent to the third hinge plate 1362, and the sixth gear g26 may be disposed adjacent to the fourth hinge plate 1363. The second gear g22, the third gear g23, the fourth gear g24, and the fifth gear g25 may be disposed between the first gear g21 and the sixth gear g26. The first gear g21, the second gear g22, the third gear g23, the fourth gear g24, the fifth gear g25, and the sixth gear g26 may be sequentially engaged. According to a rotation of a first rotation direction (e.g., clockwise) of the first gear g21, the second gear g22 engaged with the first gear g21 may be rotated in a second rotation direction (e.g., counterclockwise) opposite to the first rotation direction. According to the rotation of the second gear g22 in the second rotation direction, the third gear g23 engaged with the second gear g22 may be rotated in the first rotation direction. According to the rotation of the third gear g23 in the first rotation direction, the fourth gear g24 may be rotated in the second rotation direction. According to the rotation of the fourth gear g24 in the second rotation direction, the fifth gear g25 engaged with the fourth gear g24 may be rotated in the first rotation direction. According to the rotation of the fifth gear g25 in the first rotation direction, the sixth gear g26 engaged with the fifth gear g25 may be rotated in the second rotation direction. As the first gear g21 and the sixth gear g26 rotate in different directions, the second housing part 1220 connected to the third hinge plate 1362 and the third housing part 1230 connected to the fourth hinge plate 1363 may be folded or unfolded.

The first hinge structure 1250 and the second hinge structure 1260 may further include a spiral structure. The spiral structure may include a helical spiral groove formed in each hinge plate or a rotation member connected to the hinge plate and a moving member sliding along the spiral groove. The hinge plates connected to the hinge structure may be configured to rotate at substantially the same angular displacement through the spiral structure.

The electronic device 1200 may include a first printed circuit board 1371, a second printed circuit board 1372, and a third printed circuit board 1373.

The first printed circuit board 1371 may be disposed on the first support portion 1211 of the first housing part 1210. Hardware components within the first housing part 1210 may be mounted in the first printed circuit board 1371.

The second printed circuit board 1372 may be disposed on the second support portion 1221 of the second housing part 1220. Hardware component in the second housing part 1220 may include at least one processor (e.g., an application processor (AP) or a communication processor (CP)) mounted in the second printed circuit board 1372 and including processing circuitry, memory including one or more storage mediums, communication circuitry, and the rear camera 1275. The rear camera 1275 may be exposed through a structure (e.g., opening) of the rear surface of the second housing part 1220.

The third printed circuit board 1373 may be disposed in the third support portion 1231 of the third housing part 1230. Hardware components within the third housing part 1230 may be mounted in the third printed circuit board 1373. Hardware components disposed on the third printed circuit board 1373 may support hardware components disposed on the second printed circuit board 1372, or operate independently. The hardware components disposed on the third printed circuit board 1373 may include a speaker, a front camera, and/or display driving circuitry.

Hardware components disposed on the first printed circuit board 1371 may support hardware components disposed on the second printed circuit board 1372 and/or hardware components disposed on the third printed circuit board 1373, or operate independently.

The electronic device 1200 may further include a sub-printed circuit board 1375, flexible printed circuit boards 1380 and 1390. The sub-printed circuit board 1375 may be disposed on at least a portion of the first housing part 1210, the second housing part 1220, and the third housing part 1230. The flexible printed circuit boards 1380 and 1390 may include a first flexible printed circuit board 1380 and a second flexible printed circuit board 1390. The first flexible printed circuit board 1380 may electrically connect printed circuit boards disposed on each of the housing parts 1210, 1220, and 1230. The second flexible printed circuit board 1390 may connect a printed circuit board within a housing part in which the sub-printed circuit board 1375 is disposed and the sub-printed circuit board 1375, by the second flexible printed circuit board 1390.

Electronic components within the electronic device 1200 may be connected to at least one processor within the second printed circuit board 1372 through the flexible printed circuit boards 1380 and 1390. For example, a signal received from an antenna disposed in the third housing part 1230 may be transmitted to the second printed circuit board 1372 on which at least one processor (e.g., AP or CP) is disposed through a signal path (a) provided by the first flexible printed circuit board 1380. A driving circuit for the flexible display 1240 disposed within the first housing part 1210 may be connected to the second printed circuit board 1372 on which at least one processor (e.g., AP) is disposed, through a signal path (b) provided by the first flexible printed circuit board 1380. A driving circuit for the display 1270 connected to the sub-printed circuit board 1375 disposed on the first housing part 1210 may be electrically connected to the second printed circuit board 1372 on which at least one processor (e.g., AP) is disposed through a signal path (c) provided by the sub-printed circuit board 1375 and the first flexible printed circuit board 1380 and the second flexible printed circuit board 1390. The electronic device 1200 may further include batteries. Each of the batteries may be attached to support portions 1211, 1221, and 1231 included in the housing parts 1210, 1220, and 1230. The support portions 1211, 1221, and 1231 may support rechargeable batteries.

The arrangement of hardware components is exemplary, unlike the above description, the rear camera 1275 and the second printed circuit board 1372 may be disposed in the third housing part 1230, and the third printed circuit board 1373 may be disposed in the second housing part 1220.

It is illustrated that the first housing part 1210 and the third housing part 1230 rotate in opposite directions with respect to the second housing part 1220, but are not limited thereto. For example, while changing from the first state 1200a to the third state 1200c, the first housing part 1210 may rotate counterclockwise with respect to the second housing part 1220, and the third housing part 1230 may rotate counterclockwise with respect to the second housing part 1220. As the first housing part 1210 and the third housing part 1230 rotate in the same direction, a portion of the display region of the flexible display 1240 within the second state may be visually exposed.

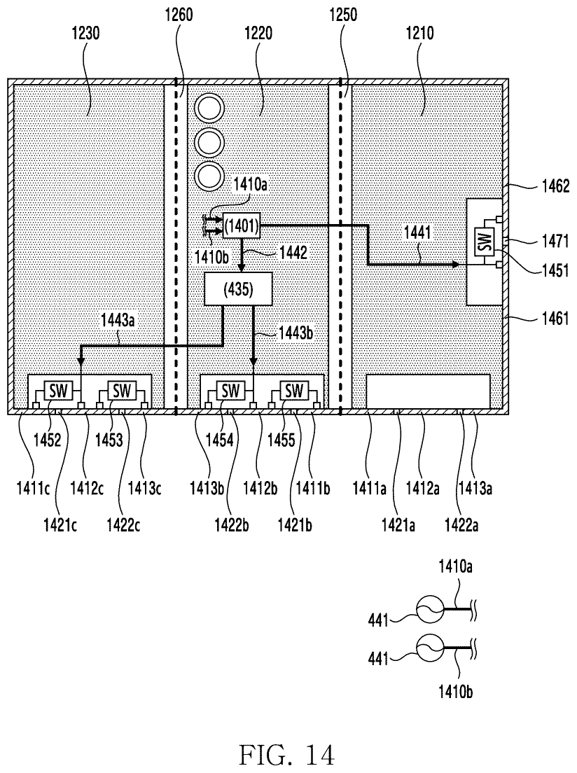

FIG. 14 illustrates an example of a foldable-type electronic device (e.g., the electronic device 101) including a switching circuit for a dual IFA according to an embodiment of the disclosure. The same reference number may be used for the same or similar descriptions.

Referring to FIG. 14, the electronic device 101 may include a first housing part 1210, a second housing part 1220, a third housing part 1230, a first hinge structure 1250, and a second hinge structure 1260. For example, the first housing part 1210 may include a first conductive portion 1411a, a second conductive portion 1412a, a third conductive portion 1413a, a first non-conductive portion 1421a disposed between the first conductive portion 1411a and the second conductive portion 1412a, and a second non-conductive portion 1422a disposed between the second conductive portion 1412a and the third conductive portion 1413a. The second housing part 1220 may include a dual IFA disposed at a lower end. For example, the second housing part 1220 may include a first conductive portion 1411b, a second conductive portion 1412b, a third conductive portion 1413b, a first non-conductive portion 1421b disposed between the first conductive portion 1411b and the second conductive portion 1412b, and a second non-conductive portion 1422b disposed between the second conductive portion 1412b and the third conductive portion 1413b. The third housing part 1230 may include a dual IFA disposed at a lower end. For example, the third housing part 1230 may include a first conductive portion 1411c, a second conductive portion 1412c, a third conductive portion 1413c, a first non-conductive portion 1421c disposed between the first conductive portion 1411c and the second conductive portion 1412c, and a second non-conductive portion 1422c disposed between the second conductive portion 1412c and the third conductive portion 1413c. For example, the first housing part 1210 may include a dual IFA disposed at a side. The first housing part 1210 may include a fourth conductive portion 1461, a fifth conductive portion 1462, and a third non-conductive portion 1471 disposed between the fourth conductive portion 1461 and the fifth conductive portion 1462. According to a control of a switching circuit 1451, the fourth conductive portion 1461 and the fifth conductive portion 1462 may be used as a radiator for the dual IFA. The second housing part 1220 may include a dual IFA disposed at a lower end. According to a control of a switching circuit 1454 and/or a switching circuit 1455, the first conductive portion 1411b, the second conductive portion 1412b, and/or the third conductive portion 1413b may be used as a radiator for the dual IFA. The third housing part 1230 may include a dual IFA disposed at a lower end. According to a control of a switching circuit 1452 and/or a switching circuit 1453, the first conductive portion 1411c, the second conductive portion 1412c, and/or the third conductive portion 1413c may be used as a radiator for the dual IFA. As a non-limiting example, in a case that the first housing part 1210 and the second housing part 1220 are folded through the first hinge structure 1250, non-conductive portions may be aligned. As an example, in a state that the first housing part 1210 and the second housing part 1220 are folded, the first non-conductive portion 1421a of the first housing part 1210 and the first non-conductive portion 1421b of the second housing part 1220 may be aligned. For example, in a state that the first housing part 1210 and the second housing part 1220 are folded, the second non-conductive portion 1422a of the first housing part 1210 and the second non-conductive portion 1422b of the second housing part 1220 may be aligned. As a non-limiting example, in a case that the second housing part 1220 and the third housing part 1230 are folded through the second hinge structure 1260, the non-conductive portions may be aligned for the EPA mode. As an example, in a state that the second housing part 1220 and the third housing part 1230 are folded, the first non-conductive portion 1421b of the second housing part 1220 and the first non-conductive portion 1421c of the third housing part 1230 may be aligned. As an example, in a state that the second housing part 1220 and the third housing part 1230 are folded, the second non-conductive portion 1422b of the second housing part 1220 and the second non-conductive portion 1422c of the third housing part 1230 may be aligned.

According to an embodiment, the wireless communication circuitry 441 corresponding to a signal source may transmit signals to a switching circuit 1401 through a main path 1410a and a sub path 1410b. The main path 1410a may be referred to as a path for a primary reception (PRX) capable of both transmission and reception. The sub-path 1410b may be referred to as a path for a diversity reception (DRX) capable of reception only. According to an embodiment, in the unfolded state, the switching circuit 1401 may be controlled to select a first path 1441 as the main path 1410a and a second path (e.g., path 1443a or path 1443b) as the sub path 1410b. According to an embodiment, in an open state, the switching circuit 1401 may be controlled to select a first path 1441 as the sub path 1410b and a second path (e.g., path 1443a or path 1443b) as the main path 1410a. A signal 1442 of the switching circuit 1401 may be input to the signal distribution circuitry 435. The signal distribution circuitry 435 may provide signals to at least one of the dual IFA of the second housing part 1220 and the dual IFA of the third housing part 1230. For example, the electronic device 101 may operate in a first mode (e.g., the selection mode of FIGS. 8A to 8C and 9A to 9C) or a second mode (e.g., the EPA mode of FIGS. 8A to 8C and 9A to 9C) based on the dual IFA of the second housing part 1220 and the dual IFA of the third housing part 1230.

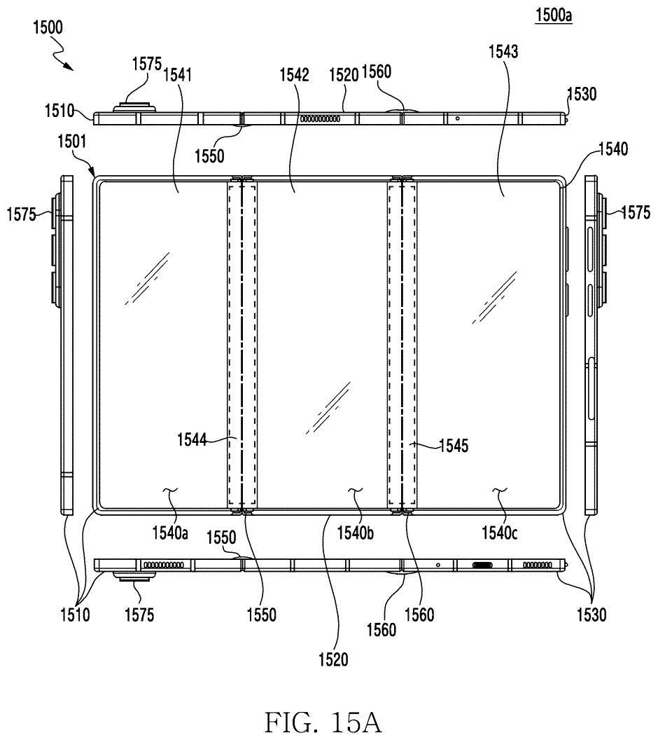

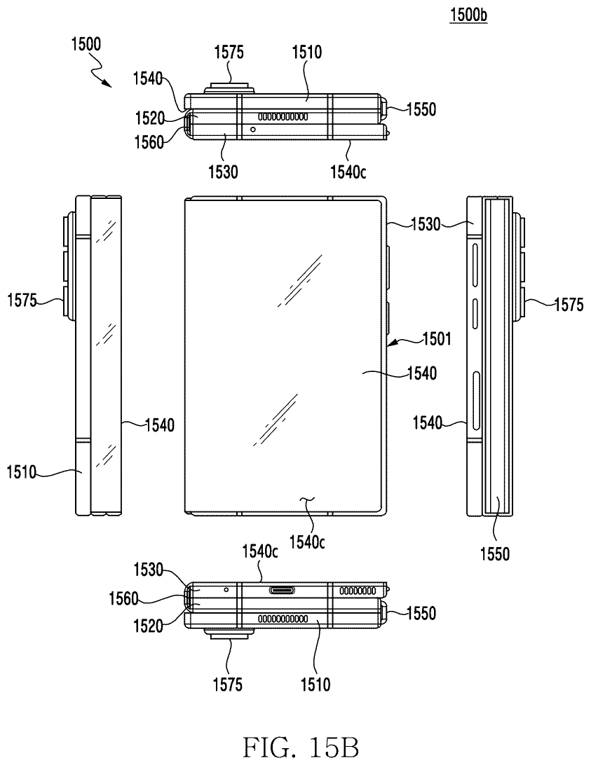

FIGS. 15A and 15B illustrate examples of a foldable-type electronic device according to various embodiments of the disclosure.

FIG. 15A illustrates an example of a first state of an electronic device. FIG. 15B illustrates an example of a second state of an electronic device.

Referring to FIGS. 15A and 15B, the electronic device 1500 may include a housing structure 1501, a flexible display 1540, a first hinge structure 1550, and a second hinge structure 1560. The first housing structure 1501 may include a first housing part 1510, a second housing part 1520, and a third housing part 1530. The electronic device 1500 may include at least one camera 1575.

The first housing part 1510 may be rotatably coupled to the second housing part 1520 by the first hinge structure 1550. The first housing part 1510 and the second housing part 1520 may be rotated with respect to the first hinge structure 1550. The first hinge structure 1550 may cause the first housing part 1510 to rotate in conjunction with a rotation of the second housing part 1520. While the first housing part 1510 is rotated with respect to the first hinge structure 1550, the second housing part 1520 may be rotated with respect to the first hinge structure 1550. For example, when the first housing part 1510 and the second housing part 1520 rotate with respect to the first hinge structure 1550, angular displacement (or angular change) of the first housing part 1510 may be substantially equal to angular displacement of the second housing part 1520.

The third housing part 1530 may be rotatably coupled to the second housing part 1520 by the second hinge structure 1560. The second housing part 1520 and the third housing part 1530 may be rotated with respect to the second hinge structure 1560. The second hinge structure 1560 may cause the second housing part 1520 to rotate in conjunction with a rotation of the third housing part 1530. While the third housing part 1530 is rotated with respect to the second hinge structure 1560, the second housing part 1520 may be rotated with respect to the second hinge structure 1560. For example, when the second housing part 1520 and the third housing part 1530 rotate with respect to the second hinge structure 1560, angular displacement of the second housing part 1520 may be substantially equal to angular displacement of the third housing part 1530.

The first hinge structure 1550 and the second hinge structure 1560 may change a state of the electronic device 1500. The first hinge structure 1550 and the second hinge structure 1560 may provide a first state 1500a of the electronic device 1500 (or a first state 1500a of the housing structure 1501) (or enable it). The first state 1500a of the electronic device 1500 (or the first state 1500a of the housing structure 1501) may be described as an unfolded state (or an unfolding state) of the electronic device 1500 (or the housing structure 1501). In the first state 1500a, a front surface of the first housing part 1510, a front surface of the second housing part 1520, and a front surface of the third housing part 1530 may define a front surface of the electronic device 1500. In the first state 1500a, the front surface of the first housing part 1510, the front surface of the second housing part 1520, and the front surface of the third housing part 1530 may face the same direction. In the first state 1500a, the electronic device 1500 may provide a user with a large display area of the flexible display 1540.

The first hinge structure 1550 and the second hinge structure 1560 may provide a second state 1500b of the electronic device 1500 (or a second state 1500b of the housing structure 1501). The second state 1500b of the electronic device 1500 (or the second state 1500b of the housing structure 1501) may be described as a folded state (or a multi-folding state or a folding state) of the electronic device 1500 (or the housing structure 1501). While the state of the electronic device 1500 is changed from the first state 1500a to the second state 1500b, a rotation direction of the first housing part 1510 with respect to the second housing part 1520 may be the same as a rotation direction of the third housing part 1530 with respect to the second housing part 1520.

In the second state 1500b, the front surface of the first housing part 1510 and the front surface of the second housing part 1520 may face opposite directions to each other, and the front surface of the second housing part 1520 and the front surface of the third housing part 1530 may face opposite directions to each other. For example, in the second state 1500b, the front surface of the first housing part 1510 may face the front surface of the second housing part 1520, and a rear surface of the second housing part 1520 may face the front surface of the third housing part 1530. In the second state 1500b, the electronic device 1500 may be folded to improve portability. In the folded state, visual information may be provided through a portion (e.g., the third display area 1540c) of a display area of the display 1540 disposed outside the electronic device 1500.

The first hinge structure 1550 and the second hinge structure 1560 may provide a third state of the electronic device 1500. The third state of the electronic device 1500 may be described as a state in which the electronic device 1500 is partially folded and partially unfolded (or a single folding state or a half folding state). For example, in the third state, the front surface of the second housing part 1520 and the front surface of the third housing part 1530 may face each other in the same direction, and the front surface of the first housing part 1510 may face the front surface of the second housing part 1520. For example, in the third state, the first housing part 1510 and the second housing part 1520 may be folded, and the second housing part 1520 and the third housing part 1530 may be unfolded.

However, it is not limited thereto, and in the third state, the front surface of the first housing part 1510 and the front surface of the second housing part 1520 may face the same direction, and the rear surface of the second housing part 1520 may face the rear surface of the third housing part 1530. For example, in the third state, the second housing part 1520 and the third housing part 1530 may be folded, and the first housing part 1510 and the second housing part 1520 may be unfolded. The electronic device 1500 may be changed from the first state 1500a to the second state 1500b through the third state. The electronic device 1500 may be changed from the first state 1500a that is an unfolded state to the third state that is a partially unfolded state. For example, the electronic device 1500 may be changed from the first state 1500a in which the first housing part 1510, the second housing part 1520, and the third housing part 1530 face the same direction to the third state in which the front surface of the first housing part 1510 faces the front surface of the second housing part 1520. The electronic device 1500 may be changed from the third state 1500c that is a partially unfolded state to the second state 1500b that is a folded state. For example, when the third state 1500c changes to the second state 1500b, the folded first housing part 1510 and second housing part 1520 may be disposed on the third housing part 1530. As the state of the electronic device 1500 changes to the second state 1500b, the rear surface of the second housing part 1520 folded with respect to the first housing part 1510 may face the rear surface of the third housing part 1530.

The flexible display 1540 may at least partially define an exterior of the electronic device 1500. The flexible display 1540 may be partially disposed within the housing structure 1501. The flexible display 1540 may define a front surface of the electronic device 1500. The flexible display 1540 may include a first unbendable portion 1541, a second unbendable portion 1542, a third unbendable portion 1543, a first bendable portion 1544, and a second bendable portion 1545. The first unbendable portion 1541 of the flexible display 1540 may be disposed on the front surface of the first housing part 1510. The second unbendable portion 1542 of the flexible display 1540 may be disposed on the front surface of the second housing part 1520. The third unbendable portion 1543 of the flexible display 1540 may be disposed on the front surface of the third housing part 1530. The first bendable portion 1544 of the flexible display 1540 may be disposed between the first unbendable portion 1541 and the second unbendable portion 1542 of the flexible display 1540. For example, the first bendable portion 1544 of the flexible display 1540 may be disposed on the first hinge structure 1550 connecting the first housing part 1510 and the second housing part 1520. The second bendable portion 1545 of the flexible display 1540 may be disposed between the second unbendable portion 1542 and the third unbendable portion 1543 of the flexible display 1540. For example, the second bendable portion 1545 of the flexible display 1540 may be disposed on the second hinge structure 1560 connecting the first housing part 1510 and the second housing part 1520.

The first hinge structure 1550 and the second hinge structure 1560 may face substantially the same direction as the first unbendable portion 1541, the second unbendable portion 1542, and the third unbendable portion 1543 of the flexible display 1540. In the first state 1500a, the first bendable portion 1544 and the second bendable portion 1545 may be disposed in substantially the same horizontal plane as the first unbendable portion 1541, the second unbendable portion 1542, and the third unbendable portion 1543.

The first hinge structure 1550 and the second hinge structure 1560 may provide the second state 1500b of the electronic device 1500. In the second state 1500b, the first unbendable portion 1541 of the flexible display 1540 may face the third unbendable portion 1543 of the flexible display 1540, and the second unbendable portion 1542 of the flexible display 1540 may be visible through the front surface of the second housing part 1520. In the second state 1500b, the first bendable portion 1544 of the flexible display 1540 may be folded so that the first unbendable portion 1541 of the flexible display 1540 and the second unbendable portion 1542 of the flexible display 1540 face different directions. In the second state 1500b, the second bendable portion 1545 of the flexible display 1540 may be folded so that the first unbendable portion 1541 of the flexible display 1540 and the third unbendable portion 1543 of the flexible display 1540 face different directions.

In the first state 1500a, the entire display area of the flexible display 1540 may be visible from the front surface of the housing structure 1501. For example, a first display area 1540a, a second display area 1540b, and a third display area 1540c of the flexible display 1540 may be visually exposed. The electronic device 1500 may provide a user with a large display area including the first display area 1540a, the second display area 1540b, and the third display area 1540c within the first state 1500a. In the second state 1500b, the display area of the flexible display 1540 may be partially visible. For example, the first display area 1540a and the second display area 1540b of the flexible display 1540 may not be visually exposed, and the third display area 1540c may be visually exposed.

As a non-limiting example, when the flexible display 1540 is used to display a screen in the first state 1500a of the electronic device 1500, the first display area 1540a, the second display area 1540b, and the third display area 1540c of the flexible display 1540 may be activated. As a non-limiting example, when the flexible display 1540 is used to display a screen in the second state of the electronic device 1500, the third display area 1540c may be activated, and the first display area 1540a and the second display area 1540b of the flexible display 1540 may be deactivated.

As a non-limiting example, when the flexible display 1540 is used to display a screen in the first state 1500a of the electronic device 1500, the first display area 1540a, the second display area 1540b, and the third display area 1540c of the flexible display 1540 may display visual information. As a non-limiting example, when the flexible display 1540 of the electronic device 1500 is used to display a screen in the second state 1500b or the third state, the third display area 1540c may provide visual information, and the first display area 1540a and the second display area 1540b of the flexible display 1540 may provide a black image.

It is illustrated that the second housing part 1520 and the third housing part 1530 rotate in the same direction with respect to the first housing part 1510, but it is not limited thereto. For example, while changing from the first state 1500a to the second state 1500b, the first housing part 1510 may rotate clockwise with respect to the second housing part 1520, and the third housing part 1530 may rotate counterclockwise with respect to the second housing part 1520. As the first housing part 1510 and the third housing part 1530 rotate in different directions, the display area of the flexible display 1540 may be deactivated without being visually exposed in the second state.

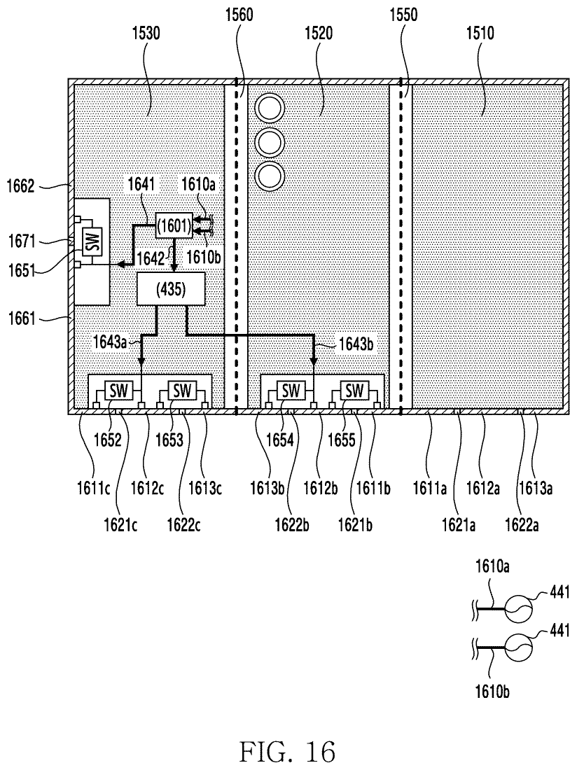

FIG. 16 illustrates an example of a foldable-type electronic device (e.g., the electronic device 101) including a switching circuit for a dual IFA according to an embodiment of the disclosure. The same reference number may be used for the same or similar descriptions.

Referring to FIG. 16, the electronic device 101 may include a third housing part 1530, a second housing part 1520, a third housing part 1530, a first hinge structure 1550, and a second hinge structure 1560. For example, the first housing part 1510 may include a first conductive portion 1611a, a second conductive portion 1612a, a third conductive portion 1613a, a first non-conductive portion 1621a between the first conductive portion 1611a and the second conductive portion 1612a, and a second non-conductive portion 1622a between the second conductive portion 1612a and the third conductive portion 1613a. The second housing part 1520 may include a dual IFA disposed at a lower end. For example, the second housing part 1520 may include a first conductive portion 1611b, a second conductive portion 1612b, a third conductive portion 1613b, a first non-conductive portion 1621b disposed between the first conductive portion 1611b and the second conductive portion 1612b, and a second non-conductive portion 1622b disposed between the second conductive portion 1612b and the third conductive portion 1613b. The third housing part 1530 may include a dual IFA disposed at a lower end. For example, the third housing part 1530 may include a first conductive portion 1611c, a second conductive portion 1612c, a third conductive portion 1613c, a first non-conductive portion 1621c disposed between the first conductive portion 1611c and the second conductive portion 1612c, and a second non-conductive portion 1622c disposed between the second conductive portion 1612c and the third conductive portion 1613c.

According to an embodiment, the third housing part 1530 may include a dual IFA disposed on a side surface. The third housing part 1530 may include a first conductive portion 1661, a second conductive portion 1662, and a first non-conductive portion 1671 disposed between the first conductive portion 1661 and the second conductive portion 1662. According to a control of a switching circuit 1651, the first conductive portion 1661 and the second conductive portion 1662 may be used as a radiator for the dual IFA. The second housing part 1520 may include a dual IFA disposed on a lower end. According to a control of a switching circuit 1654 and/or a switching circuit 1655, the first conductive portion 1611b, the second conductive portion 1612b, and/or the third conductive portion 1613b may be used as a radiator for the dual IFA. The third housing part 1530 may include a dual IFA disposed on a lower end. According to a control of a switching circuit 1652 and/or a switching circuit 1653, the first conductive portion 1611c, the second conductive portion 1612c, and/or the third conductive portion 1613c may be used as a radiator for the dual IFA. As a non-limiting example, in a case that the first housing part 1510 and the second housing part 1520 are folded through the first hinge structure 1550, the non-conductive portions may be aligned. As an example, in a state that the first housing part 1510 and the second housing part 1520 are folded, the first non-conductive portion 1621a of the first housing part 1510 and the first non-conductive portion 1621b of the second housing part 1520 may be aligned. As an example, in a state that the first housing part 1510 and the second housing part 1520 are folded, the second non-conductive portion 1622a of the first housing part 1510 and the second non-conductive portion 1622b of the second housing part 1520 may be aligned. As a non-limiting example, in a case that the second housing part 1520 and the third housing part 1530 are folded through the second hinge structure 1560, the non-conductive portions may be aligned for the EPA mode. As an example, in a state that the second housing part 1520 and the third housing part 1530 are folded, the first non-conductive portion 1621b of the second housing part 1520 and the first non-conductive portion 1621c of the third housing part 1530 may be aligned. As an example, in a state that the second housing part 1520 and the third housing part 1530 are folded, the second non-conductive portion 1622b of the second housing part 1520 and the second non-conductive portion 1622c of the third housing part 1530 may be aligned.

According to an embodiment, the wireless communication circuitry 441 corresponding to a signal source may transmit signals to the switching circuit 1601 through a main path 1610a and a sub-path 1610b. The main path 1610a may be referred to as a path for a primary reception (PRX) capable of both transmission and reception. The sub-path 1610b may be referred to as a path for a diversity reception (DRX) capable of reception only. According to an embodiment, in the unfolded state, the switching circuit 1601 may be controlled to select a first path 1641 as the main path 1610a and a second path (e.g., a path 1643a or a path 1643b) as the sub path 1610b. According to an embodiment, in an open state, the switching circuit 1601 may be controlled to select the first path 1641 as the sub-path 1610b and a second path (e.g., the path 1643a or the path 1643b) as the main path 1610a. A signal 1642 of the switching circuit 1601 may be input to the signal distribution circuitry 435. The signal distribution circuitry 435 may provide signals to at least one of the dual IFA of the second housing part 1520 and the dual IFA of the third housing part 1530. For example, the electronic device 101 may operate in a first mode (e.g., the selection mode of FIGS. 8A to 8C and 9A to 9C) or a second mode (e.g., the EPA mode of FIGS. 8A to 8C and 9A to 9C) based on the dual IFA of the second housing part 1520 and the dual IFA of the third housing part 1530.

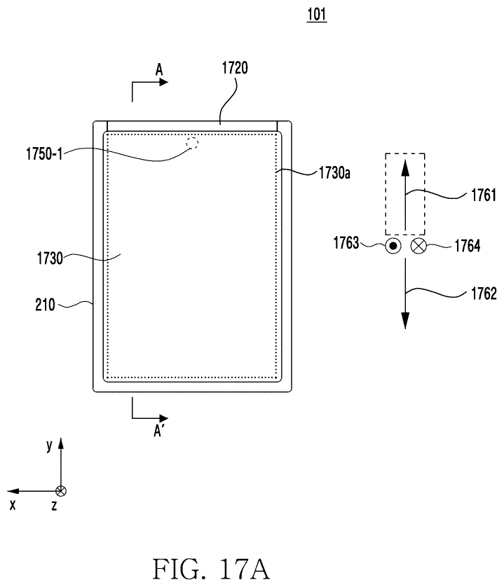

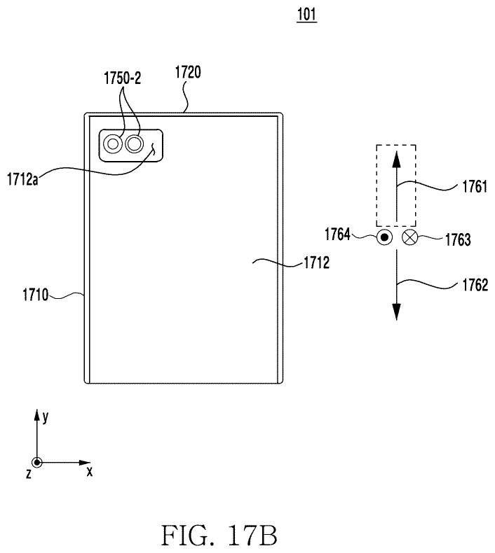

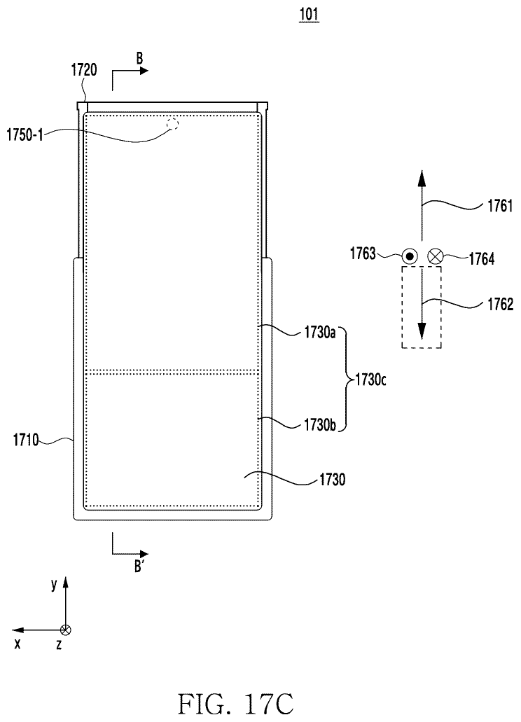

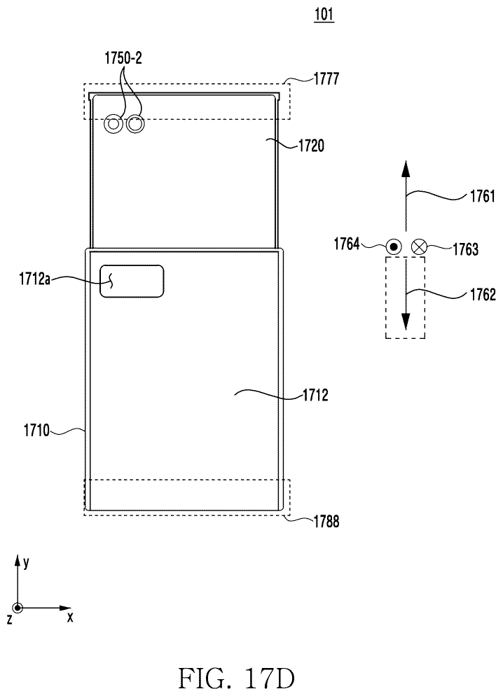

FIGS. 17A to 17D illustrate states of an electronic device 101 including a movable housing according to various embodiments of the disclosure. The same reference number may be referred to for the same description between the drawings. States of the electronic device 101 may include a first state. The electronic device may include a second state. The states of the electronic device 101 may include states different from the first state and the second state.

FIG. 17A is a top plan view of the electronic device 101 in the first state.

Referring to FIG. 17A, the electronic device 101 may include a first housing part 1710, a second housing part 1720 that is movable with respect to the first housing part 1710 in a first direction 1761 parallel to the y-axis or a second direction 1762 parallel to the y-axis and opposite to the first direction 1761, and a display 1730 (e.g., it may be referred to as a flexible display in terms of partially being curved according to movement of housing).

For example, the electronic device 101 may be in the first state. In the first state, the second housing part 1720 may be movable with respect to the first housing part 1710 in the first direction 1761 from among the first direction 1761 and the second direction 1762. For example, in the first state, the second housing part 1720 may be restricted from moving in the second direction 1762 with respect to the first housing part 1710. As an example, it may be difficult for the second housing part 1720 to move further in the second direction 1762 with respect to the first housing part 1710. As another example, the second housing part 1720 may not be easily moved in the second direction 1762 with respect to the first housing part 1710 due to catching.

For example, in the first state, the display 1730 may provide a display area having the smallest size to the front surface of the electronic device 101. For example, in the first state, the display area may correspond to a first area 1730a. For example, although not shown in FIG. 17A, in the first state, an area (e.g., a second area 1730b of FIG. 17C) of the display 1730 different from the first area 1730a that is the display area may be included in the first housing part 1710. For example, in the first state, the area may be covered by the first housing part 1710. For example, in the first state, the area may be rolled into the first housing part 1710. For example, in the first state, the first area 1730a may include a planar portion, unlike the area including a curved portion. However, it is not limited thereto. For example, in the first state, the first area 1730a may include a curved portion extending from the planar portion and located within an edge portion.

For example, the first state may be referred to as a slide-in state or a closed state in terms of at least a portion of the second housing part 1720 being located within the first housing part 1710. For example, the first state may be referred to as a reduced state in terms of providing the display area having the smallest size. However, it is not limited thereto.

For example, the first housing part 1710 may include a first image sensor 1750-1 in the camera module 180 that is visually exposed through a portion of the first area 1730a and faces a third direction 1763 parallel to the z-axis. For example, the camera module 180 may be disposed to perform its function without being visually exposed through a portion of the first area 1730a in an internal space of the electronic device. For example, although not illustrated in FIG. 17A, the second housing part 1720 may include one or more second image sensors in the camera module 180 that are exposed through a portion of the second housing part 1720 and face in a fourth direction 1764 parallel to the z-axis and opposite to the third direction 1763. For example, the one or more second image sensors may be exemplified through the description of FIG. 17B.

FIG. 17B is a rear view of an exemplary electronic device in a first state.

Referring to FIG. 17B, in the first state, one or more second image sensors 1750-2 may be disposed at a position overlapping with an opening formed in the first housing part 1710. For example, in the first state, light from the outside of the electronic device 101 may be received by the one or more second image sensors 1750-2 through the opening. For example, the one or more second image sensors 1750-2 may be exposed through the opening in the first state because they are located within the opening in the first state. For example, the opening may be an opening 1712a in a first plate 1712 of the first housing part 1710 surrounding at least a portion of the second housing part 1720. However, it is not limited thereto. For example, in the first state, the one or more second image sensors 1750-2 included in the second housing part 1720 may be covered by the first plate 1712 of the first housing part 1710.

Referring back to FIG. 17A, the first state may be changed to the second state.

For example, the first state (or the second state) may be changed to the second state (or the first state) through one or more intermediate states between the first state and the second state.

For example, the first state (or the second state) may be changed to the second state (or the first state) based on a set user input. For example, the first state (or the second state) may be changed to the second state (or the first state) in response to a user input for a physical button exposed through a portion of the first housing part 1710 or a portion of the second housing part 1720. For example, the first state (or the second state) may be changed to the second state (or the first state) in response to a touch input for an executable object displayed within the display area. For example, the first state (or the second state) may be changed to the second state (or the first state) in response to a touch input having a contact point on the display area and a pressing strength greater than or equal to a reference strength. For example, the first state (or the second state) may be changed to the second state (or the first state) in response to a voice input received through a microphone of the electronic device 101. For example, the first state (or the second state) may be changed to the second state (or the first state) in response to an external force applied to the first housing part 1710 and/or the second housing part 1720 to move the second housing part 1720 with respect to the first housing part 1710. For example, the first state (or the second state) may be changed to the second state (or the first state) in response to a user input identified on an external electronic device (e.g., earbuds or smart watch) connected to the electronic device 101. However, it is not limited thereto.

The second state may be exemplified through the description of FIGS. 17C and 17D.

FIG. 17C is a top plan view of an exemplary electronic device in a second state.

Referring to FIG. 17C, the electronic device 101 may be in the second state. For example, in the second state, the second housing part 1720 may be movable with respect to the first housing part 1710 in the second direction 1762 from among the first direction 1761 and the second direction 1762. For example, in the second state, the second housing part 1720 may not be movable in the first direction 1761 with respect to the first housing part 1710.

For example, in the second state, the display 1730 may provide the display area having the largest size. For example, in the second state, the display area may correspond to an area 1730c including the first area 1730a and the second area 1730b. For example, the second area 1730b that was included in the first housing part 1710 in the first state may be exposed in the second state. For example, in the second state, the first area 1730a may include a planar portion. However, it is not limited thereto. For example, the first area 1730a may include a curved portion extending from the planar portion and located within an edge portion. For example, unlike the first area 1730a in the first state, the second area 1730b in the second state may include the planar portion from among the planar portion and the curved portion. However, it is not limited thereto. For example, the second area 1730b may include a curved portion extending from the planar portion of the second area 1730b and located within an edge portion.

For example, the second state may be referred to as a slide-out state or an open state in terms of at least a portion of the second housing part 1720 being located outside the first housing part 1710. For example, the second state may be referred to as an extended state in terms of providing the display area having the largest size. However, it is not limited thereto.

For example, when the state of the electronic device 101 is changed from the first state to the second state, the first image sensor 1750-1 facing the third direction 1763 may be moved together with the first area 1730a according to the movement of the second housing part 1720 in the first direction 1761. For example, although not shown in FIG. 17C, when the state of electronic device 101 is changed from the first state to the second state, the one or more second image sensors 1750-2 facing the fourth direction 1764 may be moved according to the movement of the second housing part 1720 in the first direction 1761. For example, a relative positional relationship between one or more second image sensors 1750-2 and the opening may be changed according to the movement of the one or more second image sensors 1750-2. For example, the change in the relative positional relationship may be exemplified through FIG. 17D.

FIG. 17D is a rear view of the electronic device 101 in the second state.

Referring to FIG. 17D, in the second state, the one or more second image sensors 1750-2 may be located outside the opening. For example, in the second state, the one or more second image sensors 1750-2 may be located outside the opening 1712a in the first plate 1712. For example, since the one or more second image sensors 1750-2 are located outside the opening 1712a in the second state, the one or more second image sensors 1750-2 may be exposed in the second state. For example, since the one or more second image sensors 1750-2 are located outside the structure in the second state, the relative positional relationship in the second state may be different from the relative positional relationship in the first state.

For example, in a case that the electronic device 101 does not include the opening, such as the opening 1712a, the one or more second image sensors 1750-2 in the second state may be exposed, unlike the one or more second image sensors 1750-2 in the first state.

Although not illustrated in FIGS. 17A, 17B, 17C, and 17D, the electronic device 101 may be in an intermediate state between the first state and the second state. For example, a size of the display area in the intermediate state may be greater than a size of the display area in the first state and smaller than a size of the display area in the second state. For example, the display area in the intermediate state may correspond to an area including a portion of the first area 1730a and the second area 1730b. For example, in the intermediate state, a portion of the second area 1730b may be exposed, and another portion (or remaining portion) of the second area 1730b may be covered by the first housing part 1710 or rolled into the first housing part 1710. However, it is not limited thereto.

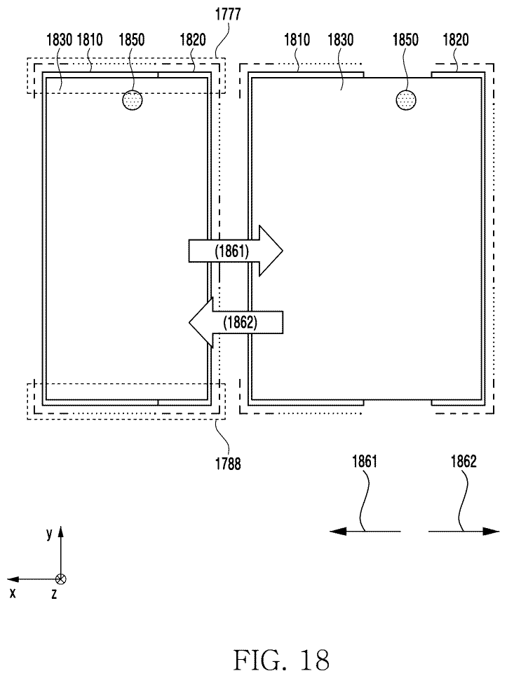

FIG. 18 illustrates another example of the electronic device 101 including a movable housing according to an embodiment of the disclosure. The same reference number may be referred to for the same description between drawings. In FIG. 18, an example of moving in a direction (e.g., (+) x-axis, (−) x-axis) different from a moving direction (e.g., (+) y-axis, (−) y-axis) of the second housing part 1720 in FIGS. 17A to 17D is described.

Referring to FIG. 18, the electronic device 101 may include a first housing part 1810, a second housing part 1820 that is movable with respect to the first housing part 1810 in a first direction 1861 parallel to the x-axis or a second direction 1862 parallel to the x-axis and opposite to the first direction 1861, and a display 1830.

The electronic device 101 may be in the first state. For example, in the first state, the second housing part 1820 may be movable with respect to the first housing part 1810 in the second direction 1862 from among the first direction 1861 and the second direction 1862. For example, in the first state, the second housing part 1820 may not be movable in the first direction 1861 with respect to the first housing part 1810. For example, in the first state, the display 1830 may provide a display area having the smallest size. For example, the first state may be referred to as a slide-in state or a closed state in terms of at least a portion of the second housing part 1820 being located within the first housing part 1810. For example, the first state may be referred to as a reduced state in terms of providing the display area having the smallest size. However, it is not limited thereto. For example, although not illustrated in FIG. 18, the first housing part 1810 may include an image sensor (not shown). For example, the second housing part 1820 may include one or more image sensors 1850 within the camera module 180, which are exposed through a portion of the second housing part 1820.

The second housing part 1820 may be extracted from the first housing part 1810. Based on the second housing part 1820 being extracted from the first housing part 1810, the state of the electronic device 101 may be changed from the first state to the second state. In addition, the second housing part 1820 may be inserted into the first housing part 1810. Based on the second housing part 1820 being inserted into the first housing part 1810, the state of the electronic device 101 may be changed from the second state to the first state.

The electronic device 101 may be in the second state. For example, in the second state, the second housing part 1820 may be movable with respect to the first housing part 1810 in the first direction 1861 from among the first direction 1861 and the second direction 1862. For example, in the second state, the second housing part 1820 may not be movable in the second direction 1862 with respect to the first housing part 1810. For example, in the second state, the display 1830 may provide a display area having the largest size. For example, the second state may be referred to as a slide-out state or an open state in terms of at least a portion of the second housing part 1820 being located outside the first housing part 1810. For example, the second state may be referred to as an extended state in terms of providing the display area having the largest size. However, it is not limited thereto.

Hereinafter, operations of the electronic device 101 including the second housing part 1720, moving in directions (e.g., (+) y-axis, (−) y-axis) in FIGS. 17A to 17D, are described, but the embodiments of the disclosure are not limited thereto. The embodiments of the disclosure may also be applied to the electronic devices 101 including the second housing part 1820, moving in directions (e.g., (+) x-axis, (−) x-axis) of FIG. 18. According to embodiments to be described later, conductive portions and non-conductive portions of a metal frame of the electronic device 101 may be disposed in a first area 1777 or a second area 1788 of the electronic device 101. Furthermore, according to the embodiments to be described later, a support member, a bridge portion, and a slot area formed over the bridge portion and the conductive portion of the electronic device 101 may be disposed in the first area 1777 of the electronic device 101.

Also, for the embodiments of the disclosure, there is no limitation on structural changes according to expansion or contraction in a horizontal direction or a vertical direction, and a radiator structure including the bridge portion and the slot area according to the embodiments to be described later may also be applied to electronic devices of a bar-type or a foldable type.

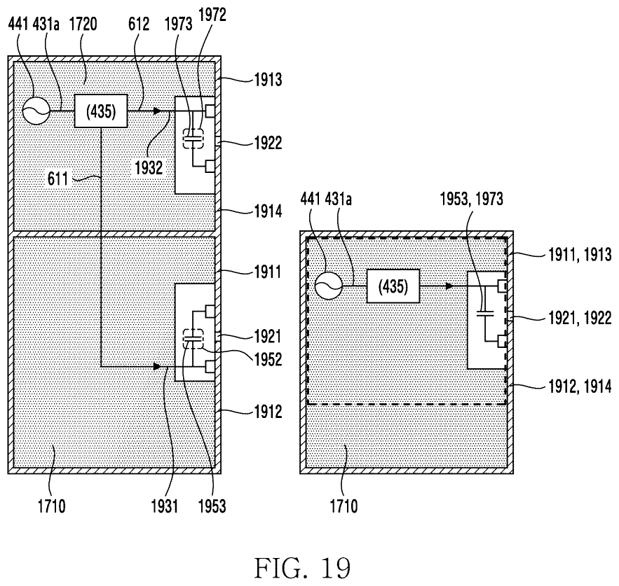

FIG. 19 illustrates an example of a rollable-type electronic device (e.g., the electronic device 101) including a switching circuit for a dual IFA according to an embodiment of the disclosure. The same reference numeral may be used for the same or similar descriptions.

Referring to FIG. 19, the electronic device 101 may include a first housing part 1710 and a second housing part 1720. For example, the first housing part 1710 may include a first conductive portion 1911, a second conductive portion 1912, and a first non-conductive portion 1921 disposed between the first conductive portion 1911 and the second conductive portion 1912. For example, the second housing part 1720 may include a third conductive portion 1913, a fourth conductive portion 1914, and a second non-conductive portion 1922 disposed between the third conductive portion 1913 and the fourth conductive portion 1914. The first conductive portion 1911 and the second conductive portion 1912 may be used as a radiator for the dual IFA disposed on a side of the first housing part 1710. As an example, a path 1931 of the first conductive portion 1911 may be connected to the second conductive portion 1912 through a first switching circuit 1952 (e.g., a circuit including a capacitor 1953). For the first switching circuit 1952, the descriptions of FIG. 7D may be referenced. In order to use the first conductive portion 1911 and the second conductive portion 1912 as a radiator for the dual IFA, the first switching circuit 1952 may connect the path 1931 and the second conductive portion 1912 through the capacitor 1953. The third conductive portion 1913 and the fourth conductive portion 1914 may be used as a radiator for the dual IFA disposed on a side of the second housing part 1720. As an example, a path 1932 of the third conductive portion 1913 may be connected to the fourth conductive portion 1914 through a second switching circuit 1972 (e.g., a circuit including a capacitor 1973). For the second switching circuit 1972, the descriptions of FIG. 7D may be referenced. In order to use the third conductive portion 1913 and the fourth conductive portion 1914 as a radiator for the dual IFA, the second switching circuit 1972 may connect the path 1932 and the fourth conductive portion 1914 through the capacitor 1973.

The effects that can be obtained from the disclosure are not limited to those described above, and any other effects not mentioned herein will be clearly understood by those having ordinary knowledge in the art to which the disclosure belongs, from the following description.

In embodiments of the disclosure, an electronic device 101 is provided. The electronic device 101 may comprise a hinge assembly, a first housing part 210, 1010, 1210, 1510, or 1710 rotatably connected to the hinge assembly, the first housing part 210, 1010, 1210, 1510, or 1710 including a first conductive portion, a second conductive portion, and a first non-conductive portion disposed between the first conductive portion and the second conductive portion, a second housing part 220, 1020, 1220, 1520, or 1720 rotatably connected to the hinge assembly, the second housing part 220, 1020, 1220, 1520, or 1720 including a third conductive portion, a fourth conductive portion, and a second non-conductive portion disposed between the third conductive portion and the fourth conductive portion, wireless communication circuitry 441 configured to transmit or receive signals through at least one of the first conductive portion, the second conductive portion, the third conductive portion, or the fourth conductive portion, a first switching circuit 744 configured to connect a first capacitor between the second conductive portion and a first transmission path 611 connected to the first conductive portion, and a second switching circuit 741 configured to connect a second capacitor between the fourth conductive portion and a second transmission path 612 connected to the third conductive portion.

For example, the first switching circuit 744 may be controlled to connect the second conductive portion and the first transmission path 611 connected to the first conductive portion through the first capacitor. The second switching circuit 741 may be controlled to connect the fourth conductive portion and the second transmission path 612 connected to the third conductive portion through the second capacitor in a folded state of the first housing part 210, 1010, 1210, 1510, or 1710 and the second housing part 220, 1020, 1220, 1520, or 1720. The second switching circuit 741 may be controlled to short the fourth conductive portion to the second transmission path 612 connected to the third conductive portion in an unfolded state of the first housing part 210, 1010, 1210, 1510, or 1710 and the second housing part 220, 1020, 1220, 1520, or 1720. In the folded state, the first non-conductive portion and the second non-conductive portion may be aligned.

For example, the electronic device 101 may comprise a third switching circuit 742 configured to connect or disconnect (not connect) the third conductive portion to a first ground, and a fourth switching circuit 743 configured to connect or disconnect (not connect) the fourth conductive portion to a second ground. The third switching circuit 742 may be controlled to connect the third conductive portion to the first ground in a folded state of the first housing part 210, 1010, 1210, 1510, or 1710 and the second housing part 220, 1020, 1220, 1520, or 1720. The fourth switching circuit 743 may be controlled to connect the fourth conductive portion to the second ground in a folded state of the first housing part 210, 1010, 1210, 1510, or 1710 and the second housing part 220, 1020, 1220, 1520, or 1720.

For example, the third conductive portion may include a first end portion close to the second non-conductive portion and a second end portion opposite to the first end portion. The fourth conductive portion may include a third end portion close to the second non-conductive portion and a fourth end portion opposite to the third end portion. A grounding point of the third conductive portion connected to the third switching circuit 742 may be connected close to the second end portion among the first end portion and the second end portion. A grounding point of the fourth switching circuit 743 may be connected close to the fourth end portion among the third end portion and the fourth end portion. For example, the first conductive portion may include a fifth end portion close to the first non-conductive portion and a sixth end portion opposite to the fifth end portion. The second conductive portion may include a seventh end portion close to the first non-conductive portion and an eight end portion opposite to the seventh end portion. A grounding point of the first conductive portion may be adjacent to the sixth end portion among the fifth end portion and the sixth end portion. A grounding point of the second conductive portion may be adjacent to the eighth end portion among the seventh end portion and the eighth end portion.

For example, in the unfolded state of the first housing part 210, 1010, 1210, 1510, or 1710 and the second housing part 220, 1020, 1220, 1520, or 1720, the third switching circuit 742 may be controlled to connect the third conductive portion to the first ground and the fourth switching circuit 743 may be controlled to disconnect the fourth conductive portion to the second ground.

For example, in the unfolded state of the first housing part 210, 1010, 1210, 1510, or 1710 and the second housing part 220, 1020, 1220, 1520, or 1720, the third switching circuit 742 may be controlled to disconnect the third conductive portion to the first ground and the fourth switching circuit 743 may be controlled to disconnect the fourth conductive portion to the second ground.

For example, the electronic device 101 may comprise a first printed circuit board (PCB) included in the first housing part 210, 1010, 1210, 1510, or 1710, and a second PCB included in the second housing part 220, 1020, 1220, 1520, or 1720. The first switching circuit 744 may be disposed on the first PCB. The second switching circuit 741 may be disposed on the second PCB.

For example, the wireless communication circuitry 441 may be disposed on the first PCB. The wireless communication circuitry 441 may be connected to the first conductive portion through a first transmission path 611 and is connected to the third conductive portion through a second transmission path 612. The wireless communication circuitry 441 may be configured to transmit signals through the first conductive portion and the second conductive portion based on the first transmission path 611 or the signals through the third conductive portion and the fourth conductive portion based on the second transmission path 612, in the folded state. The wireless communication circuitry 441 may be configured to transmit first signals through the first conductive portion and the second conductive portion based on the first transmission path 611 and second signals through the third conductive portion and the fourth conductive portion based on the second transmission path 612, in the unfolded state.

For example, the electronic device 101 may comprise phase control circuitry disposed on the first PCB within the first housing part 210, 1010, 1210, 1510, or 1710, configured to change a phase of signals on the first transmission path 611.

For example, the electronic device 101 may comprise a first connection member disposed on the first PCB and in contact with the first conductive portion, a second connection member disposed on the first PCB and in contact with the second conductive portion, a third connection member disposed on the second PCB and in contact with the third conductive portion, and a fourth connection member disposed on the second PCB and in contact with the fourth conductive portion. The first switching circuit 744 may be connected between the first connection member and the second connection member. The second switching circuit 741 may be connected between the third connection member and the fourth connection member.

For example, the first non-conductive portion of the first housing part 210, 1010, 1210, 1510, or 1710 may be disposed on a top side among sides of the electronic device 101. The second non-conductive portion may be disposed on a bottom side among the sides of the electronic device 101. In the folded state, the first non-conductive portion and the second non-conductive portion may be aligned.

For example, the first housing part 210, 1010, 1210, 1510, or 1710 may include a third non-conductive portion and a fourth non-conductive portion. The first conductive portion may be disposed between the first non-conductive portion and the third non-conductive portion. The second conductive portion may be disposed between the first non-conductive portion and the fourth non-conductive portion. The second housing part 220, 1020, 1220, 1520, or 1720 may include a fifth non-conductive portion and a sixth non-conductive portion. The third conductive portion may be disposed between the second non-conductive portion and the fifth non-conductive portion. The fourth conductive portion may be disposed between the second non-conductive portion and the sixth non-conductive portion. The first non-conductive portion and the second non-conductive portion may be aligned in the folded state. The third non-conductive portion and the fifth non-conductive portion may be aligned in the folded state. The fourth non-conductive portion and the sixth non-conductive portion may be aligned in the folded state.

For example, the first conductive portion may be formed by extending from a first area of the metal frame of the first housing part 210, 1010, 1210, 1510, or 1710. The second conductive portion may be formed by extending from a second area of the metal frame of the first housing part 210, 1010, 1210, 1510, or 1710. The third conductive portion may be formed by extending from a third area of a metal frame of the second housing part 220, 1020, 1220, 1520, or 1720. The fourth conductive portion may be formed by extending from a fourth area of the metal frame of the second housing part 220, 1020, 1220, 1520, or 1720. The first non-conductive portion may be disposed on a left side or a right side among the sides of the electronic device 101. The second non-conductive portion may be disposed on the left side or the right side among the side of the electronic device 101 where the first non-conductive portion is disposed.

For example, the first switching circuit 744 may be controlled to connect the first transmission path 611 connected to the first conductive portion and the second conductive portion through the first capacitor. The second switching circuit 741 may be controlled to connect the second transmission path 612 connected to the third conductive portion and the fourth conductive portion through the second capacitor in each of the folded state and the unfolded state of the first housing part 210, 1010, 1210, 1510, or 1710 and the second housing part 220, 1020, 1220, 1520, or 1720. In the folded state, the first non-conductive portion and the second non-conductive portion may be aligned.

In embodiments of the disclosure, an electronic device 101 is provided. The electronic device 101 may comprise a first housing part 210, 1010, 1210, 1510, or 1710, a second housing part 220, 1020, 1220, 1520, or 1720 rotatably connected to the first housing part 210, 1010, 1210, 1510, or 1710, the second housing part 220, 1020, 1220, 1520, or 1720 including a first conductive portion, a second conductive portion, and a first non-conductive portion disposed between the first conductive portion and the second conductive portion, a third housing part rotatably connected to the second housing part 220, 1020, 1220, 1520, or 1720, the third housing part including a third conductive portion, a fourth conductive portion, and a second non-conductive portion disposed between the third conductive portion and the fourth conductive portion, wireless communication circuitry 441 configured to transmit or receive signals through at least one of the first conductive portion, the second conductive portion, the third conductive portion, or the fourth conductive portion, a first switching circuit 744 configured to connect a first capacitor between the second conductive portion and a first transmission path 611 connected to the first conductive portion disposed in the second housing part 220, 1020, 1220, 1520, or 1720, and a second switching circuit 741 configured to connect a second capacitor between the fourth conductive portion and a second transmission path 612 connected to the third conductive portion disposed in the third housing part.

For example, the first switching circuit 744 may be controlled to connect the first transmission path 611 connected to the first conductive portion and the second conductive portion through the first capacitor. The second switching circuit 741 may be controlled to connect the second transmission path 612 connected to the third conductive portion and the fourth conductive portion through the second capacitor. In a folded state of the second housing part 220, 1020, 1220, 1520, or 1720 and the third housing part, the first non-conductive portion and the second non-conductive portion may be aligned.

For example, the electronic device 101 may comprise a path switching circuit connected to a primary signal path and a secondary signal path, and signal distribution circuitry connected to at least one of the first conductive portion, the second conductive portion, the third conductive portion, or the fourth conductive portion. The first housing part 210, 1010, 1210, 1510, or 1710 may include at least one conductive portion. In a state where the first housing part 210, 1010, 1210, 1510, or 1710 and the second housing part 220, 1020, 1220, 1520, or 1720 are folded and the second housing part 220, 1020, 1220, 1520, or 1720 and the third housing part are folded, the third housing part may be disposed between the first housing part 210, 1010, 1210, 1510, or 1710 and the second housing part 220, 1020, 1220, 1520, or 1720. The path switching circuit may be controlled to connect the primary signal path to the at least one conductive portion and connect the secondary signal path to the signal distribution circuitry in a folded state of the first housing part 210, 1010, 1210, 1510, or 1710 and the second housing part 220, 1020, 1220, 1520, or 1720. The path switching circuit may be controlled to connect the primary signal path to the signal distribution circuitry and connect the secondary signal path to the at least one conductive portion in a folded state of the first housing part 210, 1010, 1210, 1510, or 1710 and the second housing part 220, 1020, 1220, 1520, or 1720. The signal distribution circuitry may be configured to transmit signals to both the first conductive portion and the third conductive portion, or to transmit signals to one of the first conductive portion and the third conductive portion.

For example, the electronic device 101 may comprise a path switching circuit connected to a primary signal path and a secondary signal path, and signal distribution circuitry connected to at least one of the first conductive portion, the second conductive portion, the third conductive portion, or the fourth conductive portion. The third housing part may include at least one conductive portion. In a state where the first housing part 210, 1010, 1210, 1510, or 1710 and the second housing part 220, 1020, 1220, 1520, or 1720 are folded and the second housing part 220, 1020, 1220, 1520, or 1720 and the third housing part are folded, the second housing part 220, 1020, 1220, 1520, or 1720 may be disposed between the first housing part 210, 1010, 1210, 1510, or 1710 and the third housing part. The path switching circuit may be controlled to connect the primary signal path to the at least one conductive portion and connect the secondary signal path to the signal distribution circuitry in a folded state of the first housing part 210, 1010, 1210, 1510, or 1710 and the second housing part 220, 1020, 1220, 1520, or 1720. The path switching circuit may be controlled to connect the primary signal path to the signal distribution circuitry and connect the secondary signal path to the at least one conductive portion in a folded state of the first housing part 210, 1010, 1210, 1510, or 1710 and the second housing part 220, 1020, 1220, 1520, or 1720. The signal distribution circuitry may be configured to transmit signals to both the first conductive portion and the third conductive portion, or to transmit signals to one of the first conductive portion and the third conductive portion.

For example, the signal distribution circuitry may comprise power distribution circuitry connected to a first signal path connectable to the first conductive portion and a second signal path connectable to the third conductive portion, and at least one phase control circuitry disposed in at least one of the first signal path or the second signal path.

For example, the electronic device comprises a first dual inverted-F antenna (IFA) disposed in the first housing part; and a second dual IFA disposed in the second housing part. In a case that radiation characteristics of the first dual IFA and the second dual IFA are the same, the electronic device may set a phase so that a signal of the same phase may be transmitted to the first dual IFA and the second dual IFA.

For example, the electronic device comprises a first dual inverted-F antenna (IFA) disposed in the first housing part; and a second dual IFA disposed in the second housing part. In a case that radiation efficiency characteristics of the first dual IFA and the second dual IFA are different due to the antenna being adjacent, the electronic device may compensate a phase for a difference in the characteristics.

In one or more embodiments, at least one of the components described in one or more of the preceding drawings may be configured to perform one or more operations, techniques, processes, and/or methods as described in the disclosure. For example, a processor (e.g., a baseband processor) described in the disclosure in connection with one or more of the preceding drawings may be configured to operate according to one or more examples described herein. For another example, circuits associated with a user equipment (UE), a base station, or a network element, as described above in connection with one or more of the previous drawings, may be configured to operate according to one or more examples described herein.

Any of the above-described embodiments may be combined with any other embodiment (or combination of embodiments), unless explicitly stated otherwise. The foregoing description of one or more implementations is intended to provide examples and explanations, but is not intended to limit or restrict the scope of the embodiments to the precise forms disclosed. Modifications and variations may be made in light of the above teachings, or may be derived from the implementation of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a hinge assembly;
a first housing part rotatably connected to the hinge assembly, the first housing part including a first conductive portion, a second conductive portion, and a first non-conductive portion disposed between the first conductive portion and the second conductive portion;
a second housing part rotatably connected to the hinge assembly, the second housing part including a third conductive portion, a fourth conductive portion, and a second non-conductive portion disposed between the third conductive portion and the fourth conductive portion;
wireless communication circuitry configured to transmit or receive signals through at least one of the first conductive portion, the second conductive portion, the third conductive portion, or the fourth conductive portion;
a first switching circuit configured to connect a first capacitor between the second conductive portion and a first transmission path connected to the first conductive portion; and
a second switching circuit configured to connect a second capacitor between the fourth conductive portion and a second transmission path connected to the third conductive portion.

2. The electronic device of claim 1,
wherein the first switching circuit is controlled to connect the second conductive portion and the first transmission path connected to the first conductive portion through the first capacitor,
wherein the second switching circuit is controlled to:
connect the fourth conductive portion and the second transmission path connected to the third conductive portion through the second capacitor in a folded state of the first housing part and the second housing part, and
short the fourth conductive portion to the second transmission path connected to the third conductive portion in an unfolded state of the first housing part and the second housing part, and
wherein, in the folded state, the first non-conductive portion and the second non-conductive portion are aligned.

3. The electronic device of claim 1, comprising
a third switching circuit configured to connect or disconnect the third conductive portion to a first ground; and
a fourth switching circuit configured to connect or disconnect the fourth conductive portion to a second ground,
wherein the third switching circuit is controlled to connect the third conductive portion to the first ground in a folded state of the first housing part and the second housing part, and
wherein the fourth switching circuit is controlled to connect the fourth conductive portion to the second ground in a folded state of the first housing part and the second housing part.

4. The electronic device of claim 3,
wherein the third conductive portion includes a first end portion close to the second non-conductive portion and a second end portion opposite to the first end portion,
wherein the fourth conductive portion includes a third end portion close to the second non-conductive portion and a fourth end portion opposite to the third end portion,
wherein a grounding point of the third conductive portion connected to the third switching circuit is connected close to the second end portion among the first end portion and the second end portion, and
wherein a grounding point of the fourth switching circuit is connected close to the fourth end portion among the third end portion and the fourth end portion.

5. The electronic device of claim 4,
wherein the first conductive portion includes a fifth end portion close to the first non-conductive portion and a sixth end portion opposite to the fifth end portion,
wherein the second conductive portion includes a seventh end portion close to the first non-conductive portion and an eighth end portion opposite to the seventh end portion,
wherein a grounding point of the first conductive portion is adjacent to the sixth end portion among the fifth end portion and the sixth end portion, and
wherein a grounding point of the second conductive portion is adjacent to the eighth end portion among the seventh end portion and the eighth end portion.

6. The electronic device of claim 3, wherein, in an unfolded state of the first housing part and the second housing part, the third switching circuit is controlled to connect the third conductive portion to the first ground and the fourth switching circuit is controlled to disconnect the fourth conductive portion to the second ground.

7. The electronic device of claim 3, wherein, in an unfolded state of the first housing part and the second housing part, the third switching circuit is controlled to disconnect the third conductive portion to the first ground and the fourth switching circuit is controlled to disconnect the fourth conductive portion to the second ground.

8. The electronic device of claim 1, further comprising:
a first printed circuit board (PCB) included in the first housing part; and
a second PCB included in the second housing part,
wherein the first switching circuit is disposed on the first PCB, and
wherein the second switching circuit is disposed on the second PCB.

9. The electronic device of claim 8,
wherein the wireless communication circuitry is disposed on the first PCB,
wherein the wireless communication circuitry is connected to the first conductive portion through a first transmission path and is connected to the third conductive portion through a second transmission path, and
wherein the wireless communication circuitry is configured to:
transmit signals through the first conductive portion and the second conductive portion based on the first transmission path or the signals through the third conductive portion and the fourth conductive portion based on the second transmission path, in a folded state, and
transmit first signals through the first conductive portion and the second conductive portion based on the first transmission path and second signals through the third conductive portion and the fourth conductive portion based on the second transmission path, in an unfolded state.

10. The electronic device of claim 8, further comprising:
phase control circuitry disposed on the first PCB within the first housing part, configured to change a phase of signals on the first transmission path.

11. The electronic device of claim 8, further comprising:
a first connection member disposed on the first PCB and in contact with the first conductive portion;
a second connection member disposed on the first PCB and in contact with the second conductive portion;
a third connection member disposed on the second PCB and in contact with the third conductive portion; and
a fourth connection member disposed on the second PCB and in contact with the fourth conductive portion,
wherein the first switching circuit is connected between the first connection member and the second connection member, and
wherein the second switching circuit is connected between the third connection member and the fourth connection member.

12. The electronic device of claim 1,
wherein the first non-conductive portion of the first housing part is disposed on a top side among sides of the electronic device,
wherein the second non-conductive portion is disposed on a bottom side among the sides of the electronic device, and
wherein, in a folded state, the first non-conductive portion and the second non-conductive portion are aligned.

13. The electronic device of claim 1,
wherein the first housing part further includes a third non-conductive portion and a fourth non-conductive portion,
wherein the first conductive portion is disposed between the first non-conductive portion and the third non-conductive portion,
wherein the second conductive portion is disposed between the first non-conductive portion and the fourth non-conductive portion,
wherein the second housing part further includes a fifth non-conductive portion and a sixth non-conductive portion,
wherein the third conductive portion is disposed between the second non-conductive portion and the fifth non-conductive portion,
wherein the fourth conductive portion is disposed between the second non-conductive portion and the sixth non-conductive portion,
wherein the first non-conductive portion and the second non-conductive portion are aligned in a folded state,
wherein the third non-conductive portion and the fifth non-conductive portion are aligned in the folded state, and
wherein the fourth non-conductive portion and the sixth non-conductive portion are aligned in the folded state.

14. The electronic device of claim 1,
wherein the first conductive portion is formed by extending from a first area of a metal frame of the first housing part,
wherein the second conductive portion is formed by extending from a second area of the metal frame of the first housing part,
wherein the third conductive portion is formed by extending from a third area of a metal frame of the second housing part,
wherein the fourth conductive portion is formed by extending from a fourth area of the metal frame of the second housing part,
wherein the first non-conductive portion is disposed on a left side or a right side among the sides of the electronic device, and
wherein the second non-conductive portion is disposed on the left side or the right side among the side of the electronic device where the first non-conductive portion is disposed.

15. The electronic device of claim 14,
wherein the first switching circuit is controlled to connect the first transmission path connected to the first conductive portion and the second conductive portion through the first capacitor,
wherein the second switching circuit is controlled to connect the second transmission path connected to the third conductive portion and the fourth conductive portion through the second capacitor in each of a folded state and an unfolded state of the first housing part and the second housing part, and
wherein, in the folded state, the first non-conductive portion and the second non-conductive portion are aligned.

16. An electronic device comprising:
a first housing part;
a second housing part rotatably connected to the first housing part, the second housing part including a first conductive portion, a second conductive portion, and a first non-conductive portion disposed between the first conductive portion and the second conductive portion;
a third housing part rotatably connected to the second housing part, the third housing part including a third conductive portion, a fourth conductive portion, and a second non-conductive portion disposed between the third conductive portion and the fourth conductive portion;
wireless communication circuitry configured to transmit or receive signals through at least one of the first conductive portion, the second conductive portion, the third conductive portion, or the fourth conductive portion;
a first switching circuit configured to connect a first capacitor between the second conductive portion and a first transmission path connected to the first conductive portion disposed in the second housing part; and
a second switching circuit configured to connect a second capacitor between the fourth conductive portion and a second transmission path connected to the third conductive portion disposed in the third housing part.

17. The electronic device of claim 16,
wherein the first switching circuit is controlled to connect the first transmission path connected to the first conductive portion and the second conductive portion through the first capacitor,
wherein the second switching circuit is controlled to connect the second transmission path connected to the third conductive portion and the fourth conductive portion through the second capacitor, and
wherein, in a folded state of the second housing part and the third housing part, the first non-conductive portion and the second non-conductive portion are aligned.

18. The electronic device of claim 16, further comprising:
a path switching circuit connected to a primary signal path and a secondary signal path; and
signal distribution circuitry connected to at least one of the first conductive portion, the second conductive portion, the third conductive portion, or the fourth conductive portion,
wherein the first housing part includes at least one conductive portion,
wherein, in a state where the first housing part and the second housing part are folded and the second housing part and the third housing part are folded, the third housing part is disposed between the first housing part and the second housing part,
wherein the path switching circuit is controlled to:
connect the primary signal path to the at least one conductive portion and connect the secondary signal path to the signal distribution circuitry in a folded state of the first housing part and the second housing part, and
connect the primary signal path to the signal distribution circuitry and connect the secondary signal path to the at least one conductive portion in a folded state of the first housing part and the second housing part, and
wherein the signal distribution circuitry is configured to transmit signals to both the first conductive portion and the third conductive portion, or to transmit signals to one of the first conductive portion and the third conductive portion.

19. The electronic device of claim 16, further comprising:
a path switching circuit connected to a primary signal path and a secondary signal path; and
signal distribution circuitry connected to at least one of the first conductive portion, the second conductive portion, the third conductive portion, or the fourth conductive portion,
wherein the third housing part includes at least one conductive portion,
wherein, in a state where the first housing part and the second housing part are folded and the second housing part and the third housing part are folded, the second housing part is disposed between the first housing part and the third housing part,
wherein the path switching circuit is controlled to:
connect the primary signal path to the at least one conductive portion and connect the secondary signal path to the signal distribution circuitry in a folded state of the first housing part and the second housing part, and
connect the primary signal path to the signal distribution circuitry and connect the secondary signal path to the at least one conductive portion in a folded state of the first housing part and the second housing part, and
wherein the signal distribution circuitry is configured to transmit signals to both the first conductive portion and the third conductive portion, or to transmit signals to one of the first conductive portion and the third conductive portion.

20. The electronic device of claim 19, wherein the signal distribution circuitry comprises:
power distribution circuitry connected to a first signal path connectable to the first conductive portion and a second signal path connectable to the third conductive portion; and
at least one phase control circuitry disposed in at least one of the first signal path or the second signal path.
